(19) United States
(12) Patent Application Publication
(10) Pub. No.: US 2021/0298298 A1
(43) Pub. Date: Sep. 30, 2021

(54) METHODS AND COMPOSITIONS FOR IMPROVING THE PROPERTIES AND PRODUCTIVITY OF PLANTS

(71) Applicant: Apeel Technology, Inc., Goleta, CA (US)

(72) Inventors: Taylor Person, Goleta, CA (US); Eli Boesch, Goleta, CA (US); Gabriel Rodriguez, Santa Barbara, CA (US); Daniel Ross, Santa Barbara, CA (US); Elaine Kirschke, Goleta, CA (US); Heather Omerigic, Goleta, CA (US)

(21) Appl. No.: 17/191,582

(22) Filed: Mar. 3, 2021

Related U.S. Application Data
(60) Provisional application No. 62/984,529, filed on Mar. 3, 2020.

(51) Int. Cl. A01N 37/02; A01N 37/36; A23L 3/3517; A23B 7/154

(52) U.S. Cl. CPC A01N 37/02; A01N 37/36; A23V 2002/00; A23B 7/154; A23L 3/3517

(57) ABSTRACT

Methods for improving the properties and productivity of plants are described. The methods include contacting the above-ground biomass of a plant with a composition that includes a monoglyceride. Applying the composition to the above-ground biomass can improve properties of the plant, including improved resistance to abiotic and biotic stresses, and can provide post-harvest benefits (e.g., extended shelf-life) to plant products (e.g., fruits or vegetables) that have not been harvested from the plant.

### CROSS-REFERENCE TO RELATED APPLICATIONS

This application claims priority to U.S. Provisional Application Ser. No. 62/984,529, filed on Mar. 3, 2020, the disclosure of which is incorporated by reference in its entirety.

### TECHNICAL FIELD

This document relates to methods for improving the properties and productivity of plants and more particularly, improving the properties and productivity of plants by contacting the above-ground biomass of a plant with a composition that includes a monoglyceride.

Applying the composition to the above-ground biomass can improve properties of the plant, including reducing water requirements or improving resistance to abiotic and biotic stresses, and can provide post-harvest benefits to plant products (e.g., fruits or vegetables).

### BACKGROUND OF THE DISCLOSURE

Agriculture faces high demands due to the growing global population. However, there are a variety of environmental factors that present challenges to agricultural production. For example, abiotic environmental stressors, such as drought, water salinity or extreme temperature conditions can significantly limit the growth and productivity of a plant. Additionally, biotic stressors, such as insects, pests, and pathogens can lead to infection and/or infestation, thereby reducing the overall fruit, flower and/or vegetable yield of a plant. Therefore, there is a need to provide methods and compositions useful in the protection of plants from environmental factors that are a detriment to the growth and productivity of plants.

Additionally, irrigation is widely used in order to meet the demands of the agricultural industry. However, not all of the water used in irrigation efficiently contributes to the production of agricultural products (i.e., fruits, vegetables and grain). For example, overwatering plants can lead to water runoff, thereby wasting a portion of the water used in irrigation. This waste in water is problematic due to the limited availability of fresh water as a resource. Therefore, there is a need for methods and compositions to aid in plant water use efficiency without diminishing the overall growth and productivity of the plants.

### SUMMARY OF THU DISCLOSURE

In one embodiment, the disclosure is directed to a method of reducing the water requirements of plants comprising contacting the above-ground biomass of a plant with a composition comprising one or more monoglycerides.

In another embodiment, the disclosure is directed to a method of reducing the damage to plants due to environmental factors comprising contacting the above-ground biomass of a plant with a composition comprising one or more fatty acid derivatives (e.g., one or more monoglycerides).

In one embodiment, the disclosure is directed to a method of increasing the productivity of plants comprising contacting the above-ground biomass of a plant with a composition comprising one or more fatty acid derivatives (e.g., one or more monoglycerides).

In a further embodiment, the disclosure is directed to a method of extending the production term of plants comprising contacting the above-ground biomass of a plant with a composition comprising one or more fatty acid derivatives (e.g., one or more monoglycerides).

In one embodiment, the disclosure is directed to a method of extending the shelf-life of plant products post-harvest comprising contacting the above-ground biomass of a pre-harvested plant with a composition comprising one or more fatty acid derivatives, for example, one or more monoglycerides.

In yet another embodiment, the disclosure is directed to a method of mitigating drought stress of plants, comprising contacting the above-ground biomass of a plant with a composition comprising one or more fatty acid derivatives, for example, one or more monoglycerides.

Provided herein are methods of reducing the water requirements of a plant comprising contacting the above-ground biomass of the plant with a composition comprising one or more fatty acid derivatives.

In some embodiments of any of the methods described herein, the one or more fatty acid derivatives comprise one or more fatty acids, fatty acid esters, or a combination thereof and one or more fatty acid salts. In some embodiments of any of the methods described herein, the one or more fatty acid esters comprise one or more monoglycerides.

In some embodiments of any of the methods described herein, the composition comprises from about 70% to about 99% by weight of the one or more fatty acids, fatty acid esters, or a combination thereof. In some embodiments of any of the methods described herein, the composition comprises from about 1% to about 30% by weight of the one or more fatty acid salts. In some embodiments of any of the methods described herein, the composition comprises from about 70% to about 99% by weight of one fatty acid or fatty acid ester; and from about 1% to about 30% by weight of one fatty acid salt. In some embodiments of any of the methods described herein, the composition comprises from about 70% to about 99% by weight of two fatty acids, fatty acid esters, or a combination thereof; and from about 1% to about 30% by weight of one fatty acid salt. In some embodiments of any of the methods described herein, the composition comprises from about 70% to about 99% by weight of one fatty acid or fatty acid ester; and from about 1% to about 30% by weight of two fatty acid salts. In some embodiments of any of the methods described herein, the composition comprises from about 70% to about 99% by weight of two fatty acids, fatty acid esters, or a combination thereof; and from about 1% to about 30% by weight of two fatty acid salts.

In some embodiments of any of the methods described herein, each of the one or more fatty acids, fatty acid esters, or a combination thereof is an independently selected compound of Formula IA:

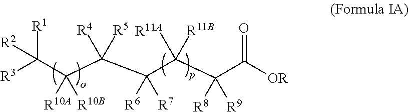

wherein:
R is selected from the group consisting of H and C₁-C₆ alkyl optionally substituted with one or more of OH and C₁-C₆ alkoxy;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and
o is an integer from 0 to 17;
p is an integer from 0 to 17;
wherein the sum of o and p is from 0 to 17;
or a salt thereof when R is C₁-C₆ alkyl optionally substituted with one or more of OH and C₁-C₆ alkoxy.

In some embodiments of any of the methods described herein, each compound of Formula I is an independently selected compound of Formula IA-A:

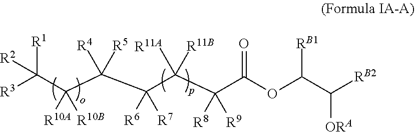

or a salt thereof,
wherein:
one of R^{B1} and R^{B2} is H, and the other of R^{B1} and R^{B2} is —CH₂OR^{A};
each occurrence of R^{A} is independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each compound of Formula IA-A is an independently selected compound of Formula IA-A-i:

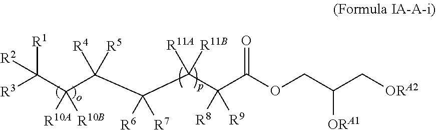

or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each fatty acid salt is an independently selected compound of Formula IIA:

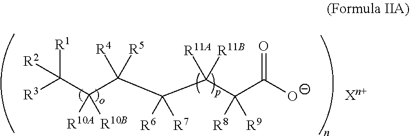

wherein:
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17;
wherein the sum of o and p is from 0 to 17;
Xⁿ⁺ is a cationic moiety having formal charge n; and
each occurrence of R′ is selected from H and C₁-C₆ alkyl.

In some embodiments of any of the methods described herein, the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate, and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca. In some embodiments of any of the methods described herein, the composition comprises 1-glyceryl palmitate, 1-glyceryl stearate and SA-Na.

In some embodiments of any of the methods described herein, the water requirements of the plant are reduced by between about 5% to about 50% as compared to a control group of untreated plants.

Also provided herein are methods of reducing damage to a plant due to an environmental factor comprising contacting the above-ground biomass of the plant with a composition comprising one or more fatty acid derivatives (e.g., one or more monoglycerides).

In some embodiments of any of the methods described herein, the one or more fatty acid derivatives comprise one or more fatty acids, fatty acid esters, or a combination thereof and one or more fatty acid salts. In some embodiments of any of the methods described herein, the one or more fatty acid esters comprise one or more monoglycerides.

In some embodiments of any of the methods described herein, the composition comprises from about 70% to about 99% by weight of the one or more fatty acids, fatty acid esters, or a combination thereof. In some embodiments of any of the methods described herein, the composition comprises from about 1% to about 30% by weight of the one or more fatty acid salts. In some embodiments of any of the methods described herein, the composition comprises from about 70% to about 99% by weight of one fatty acid or fatty acid ester; and from about 1% to about 30% by weight of one fatty acid salt. In some embodiments of any of the methods described herein, the composition comprises from about 70% to about 99% by weight of two fatty acids, fatty acid esters, or a combination thereof; and from about 1% to about 30% by weight of one fatty acid salt. In some embodiments of any of the methods described herein, the composition comprises from about 70% to about 99% by weight of one fatty acid or fatty acid ester; and from about 1% to about 30% by weight of two fatty acid salts. In some embodiments of any of the methods described herein, the composition comprises from about 70% to about 99% by weight of two fatty acids, fatty acid esters, or a combination thereof; and from about 1% to about 30% by weight of two fatty acid salts.

In some embodiments of any of the methods described herein, each of the one or more fatty acids, fatty acid esters, or a combination thereof is an independently selected compound of Formula IA:

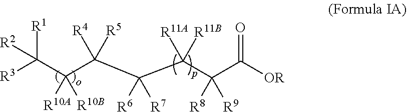

wherein:
R is selected from the group consisting of H and C₁-C₆ alkyl optionally substituted with one or more of OH and C₁-C₆ alkoxy;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and
o is an integer from 0 to 17;
p is an integer from 0 to 17;
wherein the sum of o and p is from 0 to 17;
or a salt thereof when R is C₁-C₆ alkyl optionally substituted with one or more of OH and C₁-C₆ alkoxy.

In some embodiments of any of the methods described herein, each compound of Formula I is an independently selected compound of Formula IA-A:

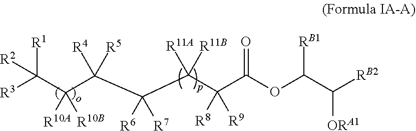

or a salt thereof,
wherein:
one of R^{B1} and R^{B2} is H, and the other of R^{B1} and R^{B2} is —CH₂OR^{A};
each occurrence of R^{A} is independently selected from H and C₁-C₆ alkyl; R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each compound of Formula IA-A is an independently selected compound of Formula IA-A-i:

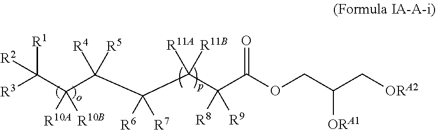

or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each fatty acid salt is an independently selected compound of Formula IIA:

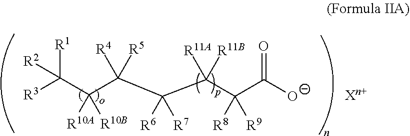

wherein:
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17;
wherein the sum of o and p is from 0 to 17;
Xⁿ⁺ is a cationic moiety having formal charge n; and
each occurrence of R′ is selected from H and C₁-C₆ alkyl.

In some embodiments of any of the methods described herein, the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate, and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca. In some embodiments of any of the methods described herein, the composition comprises 1-glyceryl palmitate, 1-glyceryl stearate and SA-Na.

In some embodiments of any of the methods described herein, the damage to the treated plant due to the environmental factor is reduced by about 5% to about 50% as compared to a control group of untreated plants.

In some embodiments of any of the methods described herein, the environmental factor is an abiotic factor, a biotic factor, or a combination thereof. In some embodiments of any of the methods described herein, the abiotic factor is one or more of frost, excess heat, amount of sunlight, amount of water, or amount of nutrients; and the biotic factor is one or more of bacteria, insects, fungi, viruses, pests, pathogens or parasites.

Also provided herein are methods of extending the shelf-life of a plant product post-harvest, the method comprising contacting the above-ground biomass of a plant pre-harvest with a composition comprising one or more fatty acid derivatives (e.g., one or more monoglycerides).

In some embodiments of any of the methods described herein, the one or more fatty acid derivatives comprise one or more fatty acids, fatty acid esters, or a combination thereof and one or more fatty acid salts. In some embodiments of any of the methods described herein, the one or more fatty acid esters comprise one or more monoglycerides.

In some embodiments of any of the methods described herein, the composition comprises from about 70% to about 99% by weight of the one or more fatty acids, fatty acid esters, or a combination thereof. In some embodiments of any of the methods described herein, the composition comprises from about 1% to about 30% by weight of the one or more fatty acid salts. In some embodiments of any of the methods described herein, the composition comprises from about 70% to about 99% by weight of one fatty acid or fatty acid ester; and from about 1% to about 30% by weight of one fatty acid salt. In some embodiments of any of the methods described herein, the composition comprises from about 70% to about 99% by weight of two fatty acids, fatty acid esters, or a combination thereof; and from about 1% to about 30% by weight of one fatty acid salt. In some embodiments of any of the methods described herein, the composition comprises from about 70% to about 99% by weight of one fatty acid or fatty acid ester; and from about 1% to about 30% by weight of two fatty acid salts. In some embodiments of any of the methods described herein, the composition comprises from about 70% to about 99% by weight of two fatty acids, fatty acid esters, or a combination thereof; and from about 1% to about 30% by weight of two fatty acid salts.

In some embodiments of any of the methods described herein, each of the one or more fatty acids, fatty acid esters, or a combination thereof is an independently selected compound of Formula IA:

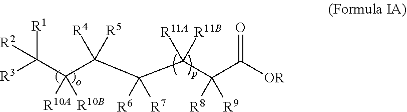

wherein:
R is selected from the group consisting of H and C₁-C₆ alkyl optionally substituted with one or more of OH and C₁-C₆ alkoxy;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and
o is an integer from 0 to 17;
p is an integer from 0 to 17;
wherein the sum of o and p is from 0 to 17;
or a salt thereof when R is C₁-C₆ alkyl optionally substituted with one or more of OH and C₁-C₆ alkoxy.

In some embodiments of any of the methods described herein, each compound of Formula I is an independently selected compound of Formula IA-A:

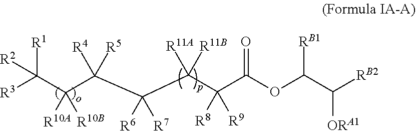

or a salt thereof,
wherein:
one of R^{B1} and R^{B2} is H, and the other of R^{B1} and R^{B2} is —CH₂OR^{A};
each occurrence of R^{A} is independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each compound of Formula IA-A is an independently selected compound of Formula IA-A-i:

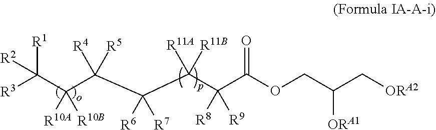

or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each fatty acid salt is an independently selected compound of Formula IIA:

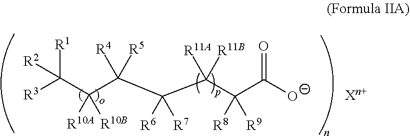

wherein:
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17;
wherein the sum of o and p is from 0 to 17;
Xⁿ⁺ is a cationic moiety having formal charge n; and
each occurrence of R′ is selected from H and C₁-C₆ alkyl.

In some embodiments of any of the methods described herein, the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate, and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca. In some embodiments of any of the methods described herein, the composition comprises 1-glyceryl palmitate, 1-glyceryl stearate and SA-Na.

In some embodiments of any of the methods described herein, the plant product is harvested from the pre-harvested plant on the same day that the pre-harvested plant is contacted with the composition. In some embodiments of any of the methods described herein, the shelf life of the plant product is extended by 1 day, 2 days, 3 days, 4 days, 5 days, 6 days, 7 days, 8 days, 9 days, 10 days, 11 days, 12 days, 13 days, 14 days 3 weeks, 4 weeks, 5 weeks, 6 weeks, 7 weeks, 2 months, 3 months, 4 months, 5 months or 6 months as compared to a similar plant product that has been harvested from a plant whose above-ground biomass has not been contacted with a composition pre-harvest.

Also provided herein are methods of mitigating drought stress of a plant, comprising contacting the above-ground biomass of the plant with a composition comprising one or more fatty acid derivatives (e.g., one or more monoglycerides).

In some embodiments of any of the methods described herein, the one or more fatty acid derivatives comprise one or more fatty acids, fatty acid esters, or a combination thereof and one or more fatty acid salts. In some embodiments of any of the methods described herein, the one or more fatty acid esters comprise one or more monoglycerides.

In some embodiments of any of the methods described herein, the composition comprises from about 70% to about 99% by weight of the one or more fatty acids, fatty acid esters, or a combination thereof. In some embodiments of any of the methods described herein, the composition comprises from about 1% to about 30% by weight of the one or more fatty acid salts. In some embodiments of any of the methods described herein, the composition comprises from about 70% to about 99% by weight of one fatty acid or fatty acid ester; and from about 1% to about 30% by weight of one fatty acid salt. In some embodiments of any of the methods described herein, the composition comprises from about 70% to about 99% by weight of two fatty acids, fatty acid esters, or a combination thereof; and from about 1% to about 30% by weight of one fatty acid salt. In some embodiments of any of the methods described herein, the composition comprises from about 70% to about 99% by weight of one fatty acid or fatty acid ester; and from about 1% to about 30% by weight of two fatty acid salts. In some embodiments of any of the methods described herein, the composition comprises from about 70% to about 99% by weight of two fatty acids, fatty acid esters, or a combination thereof; and from about 1% to about 30% by weight of two fatty acid salts.

In some embodiments of any of the methods described herein, each of the one or more fatty acids, fatty acid esters, or a combination thereof is an independently selected compound of Formula IA:

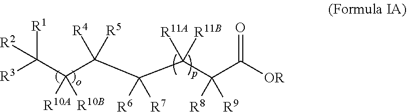

wherein:
R is selected from the group consisting of H and C₁-C₆ alkyl optionally substituted with one or more of OH and C₁-C₆ alkoxy;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and
o is an integer from 0 to 17;
p is an integer from 0 to 17;
wherein the sum of o and p is from 0 to 17;
or a salt thereof when R is C₁-C₆ alkyl optionally substituted with one or more of OH and C₁-C₆ alkoxy.

In some embodiments of any of the methods described herein, each compound of Formula I is an independently selected compound of Formula IA-A:

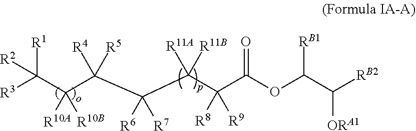

or a salt thereof,
wherein:
one of R^{B1} and R^{B2} is H, and the other of R^{B1} and R^{B2} is —CH₂OR^{A};
each occurrence of R^{A} is independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each compound of Formula IA-A is an independently selected compound of Formula IA-A-i:

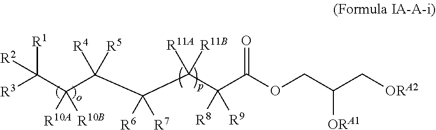

or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

In some embodiments of any of the methods described herein, each fatty acid salt is an independently selected compound of Formula IIA:

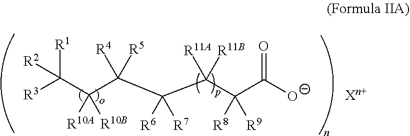

wherein:
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17;
wherein the sum of o and p is from 0 to 17;
Xⁿ⁺ is a cationic moiety having formal charge n; and
each occurrence of R′ is selected from H and C₁-C₆ alkyl.

In some embodiments of any of the methods described herein, the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate, and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca. In some embodiments of any of the methods described herein, the composition comprises 1-glyceryl palmitate, 1-glyceryl stearate and SA-Na.

In some embodiments of any of the methods described herein, the method further comprising suspending the composition in a solvent. In some embodiments of any of the methods described herein, the solvent is water, an alcohol, or a mixture thereof.

In some embodiments of any of the methods described herein, the concentration of the composition is between 0.5 to 200 mg/mL.

In some embodiments of any of the methods described herein, the above-ground biomass of the plant is contacted with the composition at least once a month. In some embodiments of any of the methods described herein, the above-ground biomass is contacted with the composition once a day. In some embodiments of any of the methods described herein, the above-ground biomass is contacted with the composition before or after the plant begins producing flowers, fruit, vegetables or a combination thereof.

In some embodiments of any of the methods described herein, the composition is contacted with the above-ground biomass by spraying, misting, pouring, dipping, dunking, brushing, electrospraying, or fogging.

### BRIEF DESCRIPTION OF THE DRAWINGS

FIG. 1 depicts the number of harvested tomatoes weekly from tomato plants, whose above-ground biomass has been treated with a 94:6 mixture of monoglycerides (94:6 MG Treatment) (1:1 ratio of PA-1G to SA-1G) to SA-Na (solid line), as compared to a control group of untreated plants (dashed line) maintained under the same conditions.

FIG. 2 depicts the mass of harvested tomatoes weekly from tomato plants, whose above-ground biomass has been treated with a 94:6 mixture of monoglycerides (94:6 MG Treatment) (1:1 ratio of PA-1G to SA-1G) to SA-Na (solid line), as compared to a control group of untreated plants (dashed line) maintained under the same conditions.

FIG. 3 depicts the total number of harvested tomatoes from tomato plants, whose above-ground biomass has been treated with a 94:6 mixture of monoglycerides (04:6 MG Treated) (1:1 ratio of PA-1G to SA-1G) to SA-Na (black) after 9 weeks of treatment once weekly, as compared to a control group of untreated plants (grey) maintained under the same conditions.

FIG. 4 depicts the total mass of harvested tomatoes from tomato plants, whose above-ground biomass has been treated with a 94:6 mixture of monoglycerides (94:6 MG Treated) (1:1 ratio of PA-1G to SA-1G) to SA-Na (black) after 9 weeks of treatment once weekly, as compared to a control group of untreated plants (grey) maintained under the same conditions.

FIG. 5 depicts the growth of tomato plants, whose above-ground biomass has been treated with a 94:6 mixture of monoglycerides (1:1 ratio of PA-1G to SA-1G) to SA-Na, and subjected to drought conditions, as compared to a control group of untreated plants maintained under the same conditions.

FIG. 6 depicts the number of green fruit on tomato plants weekly, whose above-ground biomass has been treated with a 94:6 mixture of monoglycerides (1:1 ratio of PA-1G to SA-1G) to SA-Na once a week, and subjected to drought conditions, as compared to a control group of untreated plants maintained under the same conditions.

FIG. 7A depicts the total number of tomatoes harvested from tomato plants after 20 weeks, whose above-ground biomass has been treated with a 94:6 mixture of monoglycerides (94:6 MG Treated) (1:1 ratio of PA-1G to SA-1G) to SA-Na once a week, and subjected to drought conditions, as compared to a control group of untreated plants maintained under the same conditions. FIG. 7B depicts the ratio of total tomatoes harvested from the treated plants to the total number of tomatoes harvested from the control group of untreated plants maintained under the same conditions. FIG. 7C depicts the total mass of tomatoes harvested from the treated tomato plants after 20 weeks as compared to a control group of untreated plants maintained under the same conditions. FIG. 7D depicts the ratio of the total mass of tomatoes harvested from the treated plants to the total number of tomatoes harvested from the control group of untreated plants maintained under the same conditions.

FIG. 8. Depicts the mass loss rate of fescue sod, whose above-ground biomass has been treated with a 94:6 mixture of monoglycerides (94:6 MG Treated) (1:1 ratio of PA-1G to SA-1G) to SA-Na daily over the course of 6 days, as compared to a control group of untreated fescue sod.

FIG. 9A depicts the mass loss rate of strawberries stored at 20° C., that have been harvested from a plant, whose above-ground biomass has been treated with a 94:6 mixture of monoglycerides (94:6 MG Treated) (1:1 ratio of PA-1G to SA-1G) to SA-Na pre harvest, as compared to a control group of strawberries harvested from untreated plants. FIG. 9B depicts the mass loss rate of strawberries stored at 12° C. and 2° C., that have been harvested from a plant, whose above-ground biomass has been treated with a 94:6 mixture of monoglycerides (94:6 MG Treated) (1:1 ratio of PA-1G to SA-1G) to SA-Na pre harvest, as compared to a control group of strawberries harvested from untreated plants.

FIG. 10 depicts the time lapse of strawberries stored at 2° C. that were harvested from a pre-harvest plant whose above-ground biomass has been treated with a 94:6 mixture of monoglycerides (94:6 MG Treated) (1:1 ratio of PA-1G to SA-1G) to SA-Na as compared to strawberries that were harvested from an untreated pre-harvest plant.

FIG. 11 depicts the percent incidence of mold of strawberries stored at 22° C., 12° C. and 1° C., respectively, that have been harvested from a plant, whose above-ground biomass has been treated with a 94:6 mixture of monoglycerides (1:1 ratio of PA-1G to SA-1G) to SA-Na pre harvest, as compared to a control group of strawberries harvested from untreated plants.

FIG. 12A depicts the mass loss factor of strawberries that were harvested one day after the above-ground biomass of the corresponding pre-harvest plant was treated with a 10 g/L solution of a 94:6 mixture of monoglycerides (1:1 ratio of PA-1G to SA-1G) to SA-Na, and a 30 g/L solution of a 94:6 mixture of monoglycerides (1:1 ratio of PA-1G to SA-1G) to SA-Na as compared to strawberries that were harvested from an untreated pre-harvest plant. FIG. 12B depicts the mass loss factor of strawberries that were harvested one week after the above-ground biomass of the corresponding pre-harvest plant was treated with a 10 g/L solution of a 94:6 mixture of monoglycerides (1:1 ratio of PA-1G to SA-1G) to SA-Na, and a 30 g/L solution of a 94:6 mixture of monoglycerides (1:1 ratio of PA-1G to SA-1G) to SA-Na as compared to strawberries that were harvested from an untreated pre-harvest plant.

FIG. 13A depicts the incidence of severe wilt and percent soil moisture of yellow squash treated with a 94:6 mixture of monoglycerides over time (days). Circled time points indicate days at which RNA extraction of plant leaves was performed. Significance was determined by Tukey post hoc analysis. FIG. 13B depicts a principle component analysis (PCA) of genome wide transcriptome analysis (RNA-sequencing) profiles from squash leaves at various time points from watered control (ww), water stressed control (c), or treatment (x) conditions. FIG. 13C depicts a graph of the mass loss rate (MLR) over time. Pot weights were collected daily and calculated for percent mass loss rate by treatment. Significance was determined with Tukey post-hoc analysis. (*)=p-value<0.10 and (**)=p-value<0.05. FIG. 13D depicts the visual wilt status graded on a scale of 1-5 with 5=fully turgid (hydrated), 4=leaves soft to touch (mild wilt), 3=starting to wilt (moderate wilt), 2=severely wilted (severe wilt), 1=wilted to the point of desiccation (desiccated). FIG. 13E depicts the severity of wilt ranked within each treatment normalized by total plants per group.

FIG. 14 depicts volcano plots of genome wide transcriptome analysis where each point represents the fold-change in a single analyzed gene versus the −log₁₀ P value. Light points represent statistically significant points with a log 2 fold change greater than the change threshold.

FIG. 15A depicts a bar graph of the total differentially expressed genes (DEG) identified in the genome wide transcriptome analysis at day 3, 6, and 8 post treatment. Light bars represent the total number of DEGs from the leaves of squash plants treated with a 94:6 mixture of monoglycerides, whereas control bars represent the total number of DEGs from the leaves of untreated squash plants. FIG. 15B depicts a bar graph of the total number of up regulated and down regulated genes identified in the genome wide transcriptome analysis. Light bars indicate genome wide transcriptome analysis from squash plant leaves treated with the composition. Dark bars represent genome wide transcriptome analysis from untreated squash plant leaves.

FIGS. 16A-C depict bar graphs of the total number of differentially expressed genes of selected gene classes with differentially regulated genes identified in a genome-wide transcriptome analysis from day 3 (FIG. 16A), day 6 (FIG. 16B), and day 8 (FIG. 16C). Light bars indicate analysis from squash plant leaves treated with the 94:6 monoglyceride composition. Dark bark indicate untreated controls.

FIGS. 17A-17C depict bar graphs of the total number of differentially expressed genes (DEG) of the late embryogenesis abundant (LEA) proteins (FIG. 17A), drought response element binding transcription factor (DREB TF) (FIG. 17B), and aquaporin (FIG. 17C) gene classes from days 3, 6, and 8. Light bars indicate analysis from squash plant leaves treated with the 94:6 monoglyceride composition. Dark bark indicate untreated controls.

FIGS. 18A-D depict bar graphs of the total number of differentially expressed genes (DEG) of the oxidative-reduction process (FIG. 18 A), electron transfer (FIG. 18B), protein detoxification (FIG. 18C), and DNA damage repair (FIG. 18D) from days 3, 6, and 8. Light bars indicate analysis from squash plant leaves treated with the 94:6 monoglyceride composition. Dark bark indicate untreated controls.

FIG. 19A depicts the total number of differentially expressed genes (DEG) related to photosynthesis from days 3, 6, and 8. Light bars indicate analysis from squash plant leaves treated with the 94:6 monoglyceride composition. Dark bark indicate untreated controls. FIG. 19B depicts a bar graph of the log 2 fold-change of the individual differentially expressed genes related to the photosynthesis gene class.

FIGS. 20A-20B depict a bar graph of the average mass loss factor of Satsuma mandarin oranges coated with the 94:6 monoglyceride composition or left uncoated. Both treatments were subsequently exposed to water. The water was either applied with a brushbed (FIG. 20A) or by dunking the whole fruit (FIG. 20B).

FIG. 21A depicts a bar graph of the disease index (incidence) of Botrytis infection of rose petal discs with 20, 200, or 2000 spores as an infectious dose at 24, 22, 72, and 92 hours post infection. FIG. 21B is an image of rose petal discs infected with 20, 200, or 2000 Botrytis spores or uninfected rose petal discs 92 hours post infection.

FIG. 22A depicts a bar graph of the percent area infected of rose petal discs normalized to the uninfected control petal of the corresponding time point after 40, 53, 64, and 77 hours post infection. Rose petal discs were in one of four treatment groups: uninfected, infected, infected and treated with 50 g/L of the 94:6 monoglyceride composition mixed with 2 g/L CIO monoglyceride, or infected and treated with 2 g/L of CIO monoglyceride. Rose petals were infected with 20 spores of Botrytis. FIG. 22B is an image of rose petal discs infected or infected and treated with 50 g/L of the 94:6 monoglyceride composition mixed with 2 g/L of a CIO monoglyceride. Infectious doses were 20 spores and images were taken at 53 and 64 hours post infection.

FIG. 23 A depicts a time line of an experiment to determine the effect of treatment of Arabidopsis with the composition of 30 g/L of a 94:6 monoglyceride composition mixed with 1 g/L of a CIO monoglyceride. Two treatments were performed on the plants on days 19 and 25 post planting and wilting was monitored on days 38, 52, and 60. Plants underwent drought stress between days 38 and 52. FIG. 23B-F are images of the squash plants at the time of treatment 1 on day 19 (FIG. 23B), at the time of treatment 2 on day 25 (FIG. 23C), before drought stress on day 38 (FIG. 23D), after drought stress on day 52 (FIG. 23E), and at the conclusion of the experiment on day 60 (FIG. 23F).

FIG. 24 depicts a bar graph of the number of tomato fruit and weight of tomato fruit yields from tomato plants treated preharvest with a 94:6 monoglyceride composition.

FIG. 25 depicts a bar graph of the number of tomato fruit and weight of tomato fruit yields from tomato plants treated preharvest with a 94:6 monoglyceride composition.

FIG. 26 depicts a bar graph of the number of tomato fruit and weight of tomato fruit yields from tomato plants treated preharvest with a 94:6 monoglyceride composition.

FIG. 27 depicts a bar graph of the number of tomato fruit and weight of tomato fruit yields from tomato plants untreated or treated preharvest with a composition of 94% 1-glyceryl monostearate and 6% potassium stearate and shaken (‘Shake’) or not shaken (‘No Shake’). Plants were grown in a grow room in 3 gallon pots.

FIG. 28A depicts a graph of changes in the tomato leaf mass normalized to the weight at time 0 over a ˜2 hour timeframe. Treated tomato plant leaves (black) were treated with 30 g/L of a composition 94% 1-glyceryl monostearate and 6% potassium stearate. The rate of change in normalized leaf mass was calculated for an initial rate (FIG. 28B) and a final rate (FIG. 28C) for treated and untreated leaves. FIG. 28D depicts the mass loss rate factor (MLF) or ratio of the untreated to the treated rate of both the initial rate (rate 1) and final rate (rate 2).

FIG. 29A depicts a graph of changes in the tomato leaf mass normalized to the weight at time 0 over a ˜4 hour timeframe. Tomato plant leaves were treated daily with 30-50 g/L of the composition 94% 1-glyceryl monostearate and 6% potassium stearate for one week before transpiration measurements were made (Treated daily—TD), 2) treated once with 50 g/L of the composition one day before transpiration measurements were made (Treated once—TO), or 3) untreated (U). The rate of change in normalized leaf mass was calculated for an initial rate (FIG. 29B) and a final rate (FIG. 29C) for treated daily, treated once, and untreated leaves. The mass loss rate factor (MLF) or ratio of the untreated to the treated daily, treated once, or untreated leaves of the initial rate (rate 1) (FIG. 29D) and the final rate (rate 2) were calculated (FIG. 29E). The length of time to transition from open to closed stomata was measured (FIG. 29F).

### DETAILED DESCRIPTION OF THE DISCLOSURE

### Definitions

Unless otherwise defined herein, scientific and technical terms used in this application shall have the meanings that are commonly understood by those of ordinary skill in the art. In case of conflict, the present specification, including definitions, will control.

Throughout this specification and embodiments, the word “comprise,” or variations such as “comprises” or “comprising,” will be understood to imply the inclusion of a stated integer or group of integers but not the exclusion of any other integer or group of integers.

The term “including” or “includes” is used to mean “including but not limited to.” “Including” and “including but not limited to” are used interchangeably.

Any example(s) following the term “e.g.” or “for example” is not meant to be exhaustive or limiting.

Unless otherwise required by context, singular terms shall include pluralities and plural terms shall include the singular.

The articles “a”, “an” and “the” are used herein to refer to one or to more than one (i.e., to at least one) of the grammatical object of the article.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

The term “about” when referring to a measurable value such as an amount, a temporal duration, and the like, refers to variations of ±5%, or in some instances ±2%, or in some instances ±1% from the specified value, as such variations are appropriate to perform the present disclosures.

Each embodiment of this disclosure may be taken alone or in combination with one or more other embodiments of this disclosure.

Exemplary methods and materials are described herein. Methods and materials similar or equivalent to those described herein can also be used in the practice or testing of the various aspects and embodiments. The materials, methods, and examples are illustrative only and not intended to be limiting.

In order for the disclosure to be more readily understood, certain terms are first defined. These definitions should be read in light of the remainder of the disclosure as understood by a person of ordinary skill in the art. Additional definitions are set forth throughout the detailed description.

As used herein, the term “water requirements” refers to the minimum amount of water a plant needs to grow, and to produce flowers, fruit, vegetables or a combination thereof, without showing significant signs of stress. The amount of water a plant needs depends on a variety of factors including the type of plant, the time of year, and environmental factors such as the amount humidity and the amount of sunlight or UV-exposure that the plant receives.

As used herein, the term “drought stress” refers to any decline in the growth and/or development of a plant that is caused by a reduction in the amount of water available to the plant due to drought conditions or level of watering. Symptoms of drought stress include, but are not limited to, yellowing, wilting, burning, scorching or discoloration of the leaves, stunted plant growth, reduced or diminished flowering and/or fruit and/or vegetable production, and fruit, flower and/or leaf drop from the plant. Drought conditions can be environmental, or man-made, i.e., the reduction in water provided to the plant is due to climate or reductions in its watering schedule.

As used herein, the term “minimum leaf water content” refers to the minimum amount of measurable water in a plant's leaves that does not result in the plant showing significant signs of stress due to a reduced water intake.

As used herein, the term “above-ground biomass” refers to any portion of a plant (including the leaves, stems, flowers, fruits, or seeds) that is above the surface of the soil in which it is planted.

As used herein, the term “environmental factors” refers to any factor, abiotic or biotic, that influences the growth and development of a plant and/or its production. Examples of abiotic factors include, but are not limited to, ambient temperature, including frost, and amount of sunlight, including UV-rays, amount of water and nutrients. Examples of biotic factors include, but are not limited to, bacteria, insects, fungi, viruses, pests, pathogens, and parasites.

As used herein, the term “productivity” refers to the efficiency of a plants production of fruit, vegetables and/or flowers, and may refer to the number, mass and/or quality of the fruit, vegetables and/or flowers produced by a plant.

As used herein, the phrase “production term” refers to the period of time over which a plant produces fruit, vegetables and/or flowers.

As used herein, the term “pre-harvest plant” refers to a plant that has not had any plant products harvested from it, or to a plant that has had plant products harvested from it, but is also still producing new plant products that may be harvested subsequently to the initial harvest.

As used herein, the “mass loss rate” refers to the rate at which a plant product loses mass (e.g. by releasing water and other volatile compounds). The mass loss rate is typically expressed as a percentage of the original mass per unit time (e.g. percent per day).

As used herein, the term “mass loss factor” is defined as the ratio of the average mass loss rate of a plant product that has been harvested from a plant whose above-ground biomass has not been contacted with a composition as described herein (measured for a control group) to the average mass loss rate of the corresponding plant product that has been harvested from a plant whose above-ground biomass has been contacted with a composition as described herein at a given time. Hence a larger mass loss factor corresponds to a greater reduction in average mass loss rate for the coated produce.

As used herein, the “respiration rate” refers to the rate at which a harvested plant product releases CO₂, and more specifically is the volume of CO₂ (at standard temperature and pressure) released per unit time per unit mass of the product. The respiration rate is typically expressed as ml CO₂/kg·hour. The respiration rate of the product can be measured by placing the product in a closed container of known volume that is equipped with a CO₂ sensor, recording the CO₂ concentration within the container as a function of time, and then calculating the rate of CO₂ release required to obtain the measured concentration values.

As used herein, the term “respiration factor” is defined as the ratio of the cumulative respiration of a plant product that has been harvested from a plant whose-above ground biomass has not been contacted with a composition as described herein (measured for a control group) to the cumulative respiration of the corresponding plant product that has been harvested from a plant whose above-ground biomass has been contacted with a composition as described herein. Hence a larger respiration factor corresponds to a greater reduction in cumulative respiration for the plant product harvested from a treated plant.

As used herein, the terms “reduce”, “reduction”, “reduced”, “extend”, “extending”, “extended”, “increased”, “increasing”, “decreased”, “decreasing”, and equivalents thereof are used to denote the response a plant, or group of plants has to being treated (e.g., contacted) with a composition as described herein as compared to a control plant, or a control group of plants. For example, a group of plants whose above-ground biomass has been treated can be described as having an increased fruit yield as compared to a control group of untreated plants. The control group of untreated plants and the group of treated plants correspond to the same type of plant and are grown and/or maintained under the same conditions, e.g., watering schedule, sunlight, temperature, etc.

As used herein, the term “treated plant” or “treated plants” refers to a plant whose above-ground biomass has been contacted with a composition as described herein.

As used herein, the terms “untreated plant”, “untreated plants”, “control plant” or “control plants” are used interchangeably, and refer to a plant, or group of plants whose above-ground biomass has not been contacted with a composition as described herein. Typically, these plants are used as a comparison with treated plants.

As used herein, the term “contacting” refers to any means that may be used to put a composition as described herein on the above-ground biomass of a plant.

As used herein, the term “shelf life” refers to the length of time during which a plant product is fit for consumption.

As used herein, the term “mitigating” refers to lessening, reducing, slowing or stopping adverse effects to the growth and/or development of a plant and/or its production that may result from harsh conditions, e.g., biotic and abiotic stressors.

As used herein, the “carbon chain length” of a fatty acid or salt or ester thereof refers to the number of carbon atoms in the chain including the carbonyl carbon.

As used herein, a “long chain fatty acid”, a “long chain fatty acid ester”, or a “long chain fatty acid salt” refers to a fatty acid or ester or salt thereof, respectively, for which the carbon chain length is greater than 13 (i.e., is at least 14).

As used herein, a “medium chain fatty acid”, a “medium chain fatty acid ester”, or a “medium chain fatty acid salt” refers to a fatty acid or ester or salt thereof, respectively, for which the carbon chain length is in a range of 7 to 13 (inclusive of 7 and 13).

As used herein, a “cationic counter ion” is any organic or inorganic positively charged ion associated with a negatively charged ion. Examples of a cationic counter ion include, for example, sodium, potassium, calcium, magnesium and ammonium.

As used herein, a “cationic moiety” is any organic or inorganic positively charged ion.

As used herein, the term “alkyl” refers to saturated linear or branched-chain monovalent hydrocarbon radicals, containing the indicated number of carbon atoms. For example, “C₁₋₆ alkyl” refers to saturated linear or branched-chain monovalent hydrocarbon radicals of one to six carbon atoms. Non-limiting examples of alkyl include methyl, ethyl, 1-propyl, isopropyl, 1-butyl, isobutyl, sec-butyl, tert-butyl, 2-methyl-2-propyl, pentyl, neopentyl, and hexyl.

As used herein, the term “alkenyl” refers to a linear or branched mono-unsaturated hydrocarbon chain, containing the indicated number of carbon atoms. For example, “C₂₋₆ alkenyl” refers a linear or branched mono unsaturated hydrocarbon chain of two to six carbon atoms. Non-limiting examples of alkenyl include ethenyl, propenyl, butenyl, or pentenyl.

As used herein, the term “alkoxy” refers to an —O-alkyl radical, wherein the radical is on the oxygen atom. For example, “C₁₋₆ alkoxy” refers to an —O—(C₁₋₆ alkyl) radical, wherein the radical is on the oxygen atom. Examples of alkoxy include methoxy, ethoxy, propoxy, isopropoxy, butoxy and tert-butoxy.

As used herein, the term “cycloalkyl” refers to a saturated or partially saturated cyclic hydrocarbon, containing the indicated number of carbon atoms. For example, “C₃-C₆ cycloalkyl” refers to a saturated or partially saturated cyclic hydrocarbon having three to six ring carbon atoms.

Non-limiting examples of cycloalkyl include cyclopropyl, cyclobutyl, cyclopentyl, and cyclohexyl.

As used herein, the term “heterocycle” refers to a monocyclic nonaromatic ring system containing indicated number of ring atoms (e.g., 3-6 membered heterocycle) having 1-3 heteroatoms, said heteroatoms selected from O, N, or S. Examples of heterocyclyl groups include oxiranyl, piperazinyl, pyrrolidinyl, dioxanyl, morpholinyl, and tetrahydrofuranyl.

As used herein, “fatty acid derivative” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acid derivatives include fatty acids, fatty acid esters (e.g., monoglycerides), and fatty acid salts. Fatty acid derivatives include compounds of Formula IA, Formula IA-A, Formula IA-A-i, Formula IA-A-ii, Formula IA-B, and Formula IIA.

At various places in this disclosure, substituents of compounds of the disclosure are disclosed in groups or in ranges. It is specifically intended that the disclosure include each and every individual sub-combination of the members of such groups and ranges. For example, the term “(C₁-C₆)alkyl” is specifically intended to include C₁ alkyl (methyl), C₂ alkyl (ethyl), C₃ alkyl, C₄ alkyl, C₅ alkyl, and C₆ alkyl.

The term “—C₁-C₆ alkyl” as used herein, refers to a saturated, branched- or straight-chain alkyl group containing from 1 to 6 carbon atoms, such as, but not limited to, methyl, ethyl, n-propyl, isopropyl, n-butyl, sec-butyl, isobutyl, tert-butyl, n-pentyl, isopentyl, neopentyl, and n-hexyl.

The term “—C₂-C₆ alkenyl” refers to an aliphatic hydrocarbon having from 2 to 6 carbon atoms, including straight chain or branched chain groups having at least one carbon-carbon double bond. Representative examples include, but are not limited to, ethenyl, 1-propenyl, 2-propenyl (allyl), isopropenyl, 2-methyl-1-propenyl, 1-butenyl, 2-butenyl, and the like. When the compounds of the disclosure contain a C₂-C₆alkenyl group, the compound may exist as the pure E (entgegen) form, the pure Z (zusammen) form, or any mixture thereof.

The term “—C₂-C₆ alkynyl” refers to an aliphatic hydrocarbon having two to six carbon atoms and at least one carbon-carbon triple bond, including straight chains and branched chains having at least one carbon-carbon triple bond. Representative examples include, but are not limited to, ethynyl, propynyl, butynyl, pentynyl, and hexynyl.

As used herein, the term “—C₃-C₁ cycloalkyl” refers to a carbocyclic substituent wherein the cyclic framework has 3 to 7 carbons. A “C₃-C₆ cycloalkyl” refers to a saturated carbocyclic substituent wherein the cyclic framework has 3 to 6 carbons. A “cycloalkyl’ may be a monocyclic ring, examples of which include cyclopropyl, cyclobutyl, cyclopentyl, cyclohexyl, cycloheptyl, and cyclooctyl. Also included in the definition of cycloalkyl are unsaturated nonaromatic cycloalkyls such as, but not limited to, cyclohexenyl, cyclohexadienyl, cyclopentenyl, cycloheptenyl, and cyclooctenyl. Alternatively, a cycloalkyl may contain more than one ring such as a “—C₄-C₅ bicycloalkyl”. The term “—C₄-C₅ bicycloalkyl” refers to a bicyclic ring system containing from 4 to 8 carbon atoms. The bicycloalkyl may be fused, such as bicyclo[1.1.0]butanyl, bicyclo[2.1.0]pentanyl, bicyclo[2.2.0]hexanyl, bicyclo[3.1.0]hexanyl, bicyclo[3.2.0]heptanyl, and bicyclo[3.3.0]-octanyl. The term “bicycloalkyl” also includes bridged bicycloalkyl systems such as, but not limited to, bicyclo[2.2.1]heptanyl and bicyclo[1.1.1]pentanyl.

A “heterocycle,” as used herein, refers to a cycloalkyl as defined above, wherein at least one of the ring carbon atoms is replaced with a heteroatom selected from nitrogen, oxygen or sulfur. The term “3- to 6-membered ring heterocycle” means the heterocycle substituent contains a total of 3 to 6 ring atoms, at least one of which is a heteroatom. A heterocycle may be a single ring with up to 10 total members. Alternatively, a heterocycloalkyl as defined above may comprise 2 or 3 rings fused together, wherein at least one such ring contains a heteroatom as a ring atom (i.e., nitrogen, oxygen, or sulfur). The heterocycle substituent may be attached to the core of the compounds of the present disclosure via a nitrogen atom having the appropriate valence, or via any ring carbon atom. Examples of heterocycloalkyl rings include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1]heptanonyl, 3-azabicyclo[3.1.0]hexanyl, 3-azabicyclo[4.1.0]heptanyl and the like. Further examples of heterocycloalkyl rings include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

As used herein, the term “aryl” refers to an all-carbon monocyclic or fused-ring polycyclic aromatic group having a conjugated pi-electron system containing from 6 to 10 carbon atoms, such as phenyl, or naphthyl.

As used herein, the term “heteroaryl” refers to monocyclic or fused-ring polycyclic aromatic heterocyclic groups with one or more heteroatom ring members (ring-forming atoms) each independently selected from oxygen (O), sulfur (S) and nitrogen (N) in at least one ring. A “(5- to 14-membered)heteroaryl” ring refers to a heteroaryl ring having from 5 to 14 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A “(5- to 10-membered)heteroaryl” ring refers to a heteroaryl ring having from 5 to 10 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A “(5- to 8-membered)heteroaryl” ring refers to a heteroaryl ring having from 5 to 8 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A “(5- to 8-membered)nitrogen-containing heteroaryl” ring refers to a heteroaryl ring having from 5 to 8 ring atoms in which at least one of the ring atoms is nitrogen, with the remaining ring atoms being independently selected from the group consisting of carbon, oxygen, sulfur and nitrogen. A “(5- to 6-membered)heteroaryl” refers to a heteroaryl ring having from 5 to 6 ring atoms in which at least one of the ring atoms is a heteroatom (i.e., oxygen, nitrogen, or sulfur), with the remaining ring atoms being independently selected from the group consisting of carbon, oxygen, nitrogen, and sulfur. A heteroaryl may be a single ring or 2 or 3 fused rings. Examples of heteroaryls include, but are not limited to, 6-membered ring substituents such as pyridinyl, pyrazinyl, pyrimidinyl and pyridazinyl; 5-membered heteroaryls such as triazolyl, imidazolyl, furanyl, isoxazolyl, isothiazolyl, 1,2,3-, 1,2,4, 1,2,5-, or 1,3,4-oxadiazolyl, oxazolyl, thiophenyl, thiazolyl, isothiazolyl, and pyrazolyl; 6/5-membered fused ring substituents such as indolyl, indazolyl, benzofuranyl, benzimidazolyl, benzothienyl, benzoxadiazolyl, benzothiazolyl, isobenzothiofuranyl, benzothiofuranyl, benzisoxazolyl, benzoxazolyl, benzodioxolyl, furanopyridinyl, purinyl, imidazopyridinyl, imidazopyrimidinyl, pyrrolopyridinyl, pyrazolopyridinyl, pyrazolopyrimidinyl, thienopyridinyl, triazolopyrimidinyl, triazolopyridinyl (e.g., 5,6,7,8-tetrahydro[1,2,4]triazolo[1,5-a]pyridin-2-yl), and anthranilyl; and 6/6-membered fused ring substituents such as quinolinyl, isoquinolinyl, cinnolinyl, quinazolinyl, oxochromanyl, and 1,4-benzoxazinyl.

The following abbreviations are used throughout. Hexadecanoic acid (i.e., palmitic acid) is abbreviated to “PA”. Octadecanoic acid (i.e., stearic acid) is abbreviated to “SA”. Tetradecanoic acid (i.e., myristic acid) is abbreviated to “MA”. (9Z)-Octadecenoic acid (i.e., oleic acid) is abbreviated to “OA”. Dodecanoic acid (e.g., lauric acid) is abbreviated to “LA”. Undecanoic acid (e.g., undecylic acid) is abbreviated to “UA”. Decanoic acid (e.g., capric acid) is abbreviated to “CA”. 1,3-dihydroxypropan-2-yl palmitate (i.e., 2-glyceryl palmitate) is abbreviated to “PA-2G”. 1,3-dihydroxypropan-2-yl octadecanoate (i.e., 2-glyceryl stearate) is abbreviated to “SA-2G”. 1,3-dihydroxypropan-2-yl tetradecanoic acid (i.e., 2-glyceryl myristate) is abbreviated to “MA-2G”. 1,3-dihydroxypropan-2-yl (9Z)-octadecenoate (i.e., 2-glyceryl oleate) is abbreviated to “OA-2G”. 2,3-dihydroxypropan-1-yl palmitate (i.e., 1-glyceryl palmitate) is abbreviated to “PA-1G”. 2,3-dihydroxypropan-1-yl octadecanoate (i.e., 1-glyceryl stearate) is abbreviated to “SA-1G”. 2,3-dihydroxypropan-1-yl tetradecanoate (i.e., 1-glyceryl myristate) is abbreviated to “MA-1G”. 2,3-dihydroxypropan-1-yl (9Z)-octadecenoate (i.e., 1-glyceryl oleate) is abbreviated to “OA-1G”. 2,3-dihydroxypropan-1-yl dodecanoate (i.e., 1-glyceryl laurate) is abbreviated to “LA-1G”. 2,3-dihydroxypropan-1-yl undecanoate (i.e., 1-glyceryl undecanoate) is abbreviated to “UA-1G”. 2,3-dihydroxypropan-1-yl decanoate (i.e., 1-glyceryl caprate) is abbreviated to “CA-1G”. Sodium salt of stearic acid is abbreviated to “SA-Na”. Sodium salt of myristic acid is abbreviated to “MA-Na”. Sodium salt of palmitic acid is abbreviated to “PA-Na”. Potassium salt of stearic acid is abbreviated to “SA-K”. Potassium salt of myristic acid is abbreviated to “MA-K”. Potassium salt of palmitic acid is abbreviated to “PA-K”. Calcium salt of stearic acid is abbreviated to “(SA)2-Ca”. Calcium salt of myristic acid is abbreviated to “(MA)2-Ca”. Calcium salt of palmitic acid is abbreviated to “(PA)2-Ca”. Magnesium salt of stearic acid is abbreviated to “(SA)2-Mg”. Magnesium salt of myristic acid is abbreviated to “(MA)2-Mg”. Magnesium salt of palmitic acid is abbreviated to “(PA)2-Mg”.

As used herein, the terms “substituted” or “substituent”, means an atom or group of atoms is replaced with another atom or group of atoms. Exemplary substituents include, but are not limited to, halogen, hydroxyl, alkoxyl, nitro, cyano, alkyl, alkenyl, alkynyl, cycloalkyl, cycloalkenyl, formyl, acyl, ether, ester, keto, aryl, heteroaryl, etc.

Compositions that are Useful in the Methods of the Disclosure

The compositions that are used in the methods of the disclosure are useful for the formation of a coating or film on the surface of the above-ground biomass of plants treated with the composition. Any of the compositions described herein can be applied to the biomass of any type of plant, including a monocotyledonous or dicotyledonous plant. The plants can be of any cultivar or variety, and can produce a plant product (e.g., an agricultural product such as a fruit or a vegetable) or can be ornamental (e.g., grasses or flowers). Surprisingly, these treatments result in improved properties of the plants and can provide post-harvest benefits to the plant products. For example, the compositions can make the plants more damage resistant, drought tolerant, and also result in reduced water requirements, improved flower, fruit and/or vegetable production, and extended periods of time over which the plants produce flowers, fruits, and/or vegetables. Furthermore, when the compositions that are useful in the methods according to this disclosure are applied to the above-ground biomass of plants prior to harvest (i.e., pre-harvest plants), the plant products harvested from those plants (e.g., berries such as strawberries, blueberries, raspberries, or blackberries, tomatoes, cherries or other stone fruits, grapes, squash including winter squash such as butternut, acorn, buttercup, Hubbard, or Kabocha squash, or summer type squash such as yellow squash, zucchini, pattypan, or crookneck squash, avocados, pears, or apples,) have improved shelf-life and are more resistant to spoilage than control, untreated plants. Harvested plant products can include any variety or cultivar of any type of plant that produces a plant product or ornamental product.

In one embodiment, the compositions that are useful in the methods of the disclosure may comprise one or more of a fatty acid, a fatty acid salt, or a fatty acid ester. In some embodiments, the one or more fatty acids in the compositions that are useful in the methods of the disclosure is a long chain fatty acid (i.e., having a carbon chain length greater than 13) or a medium chain fatty acid (i.e., having a carbon chain length from 7 to 13). In some embodiments, the fatty acid from which the one or more fatty acid salts or fatty acid esters is derived is a long chain fatty acid (i.e., having a carbon chain length greater than 13) or a medium chain fatty acid (i.e., having a carbon chain length from 7 to 13).

In a preferred embodiment, the compositions that are useful in the methods of the disclosure comprise one or more fatty acid derivatives, for example one or more fatty acid esters resulting from esterification of a fatty acid with glycerol. In another embodiment, the compositions that are useful in the methods of the disclosure comprise one or more fatty acid derivatives, for example, one or more monoglycerides and one or more fatty acids or salts thereof. In another preferred embodiment, the compositions that are useful in the methods of the disclosure comprise one or more fatty acid derivatives, for example, one or more monoglycerides and one or more fatty acid salts.

In some embodiments, the compositions useful in the methods of the disclosure comprise:

(i) from 50% to 99% by mass of a first group of compounds, wherein each compound of the first group is a compound of Formula I; and

(ii) from 1% to 50% by mass of a second group of compounds, wherein each compound of the second group is a compound of Formula III, wherein Formula I and Formula III are:

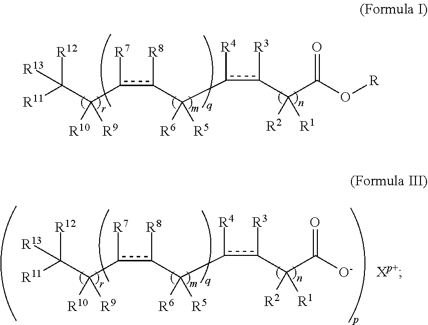

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the symbol [symbol] represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
   r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
   X^{p+} is a cationic counter ion having a charge state p, and p is 1, 2, or 3.

In a preferred embodiment, in the first group of compounds of Formula I, R is -glyceryl. In another preferred embodiment, the first group of compounds of Formula I is one or more monoglycerides.

In some embodiments, the first group of compounds of Formula I, are derived from a long chain fatty acid or a medium chain fatty acid. In a preferred embodiment, the first group of compounds of Formula I are derived from a long chain fatty acid. In some embodiments, the one or more fatty acid derivatives, for example, one or more monoglycerides having a structure according to Formula I are derived from a long chain fatty acid or a medium chain fatty acid. In a preferred embodiment, the one or more fatty acid derivatives, for example, one or more monoglycerides having a structure according to Formula I are derived from a long chain fatty acid.

In some embodiments, the one or more fatty acid derivatives, for example, one or more monoglycerides having a structure according to Formula I are selected from the group consisting of:

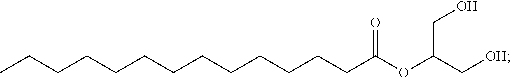 [SMILES: CCCCCCCCCCCCCC(=O)OC(CO)CO]

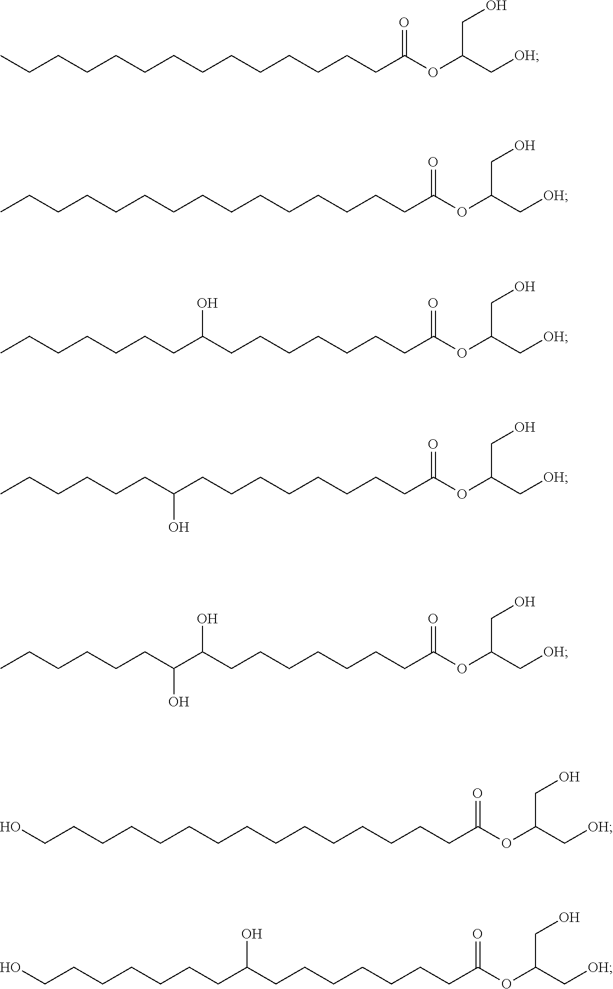

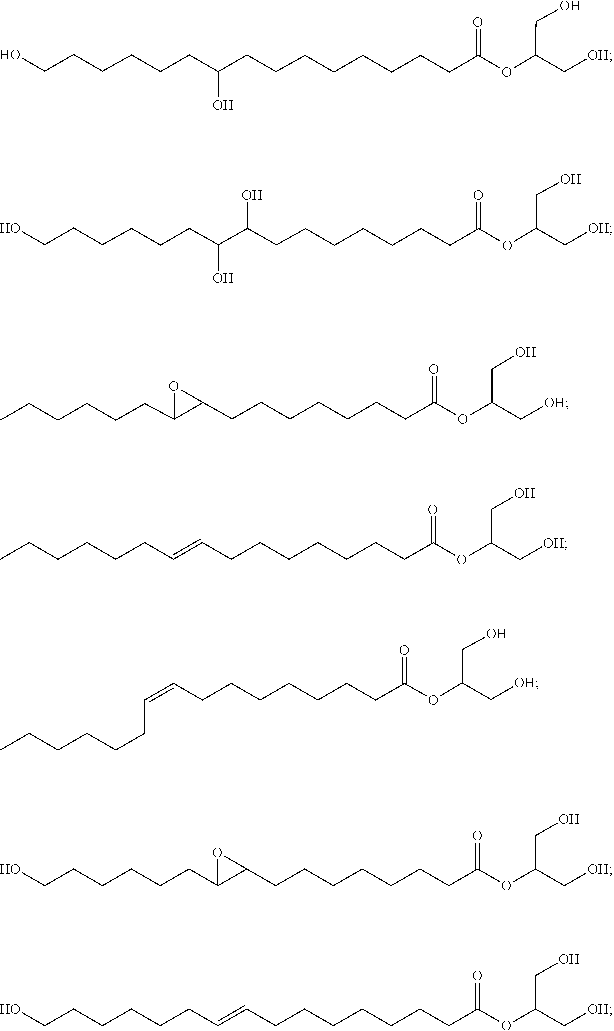

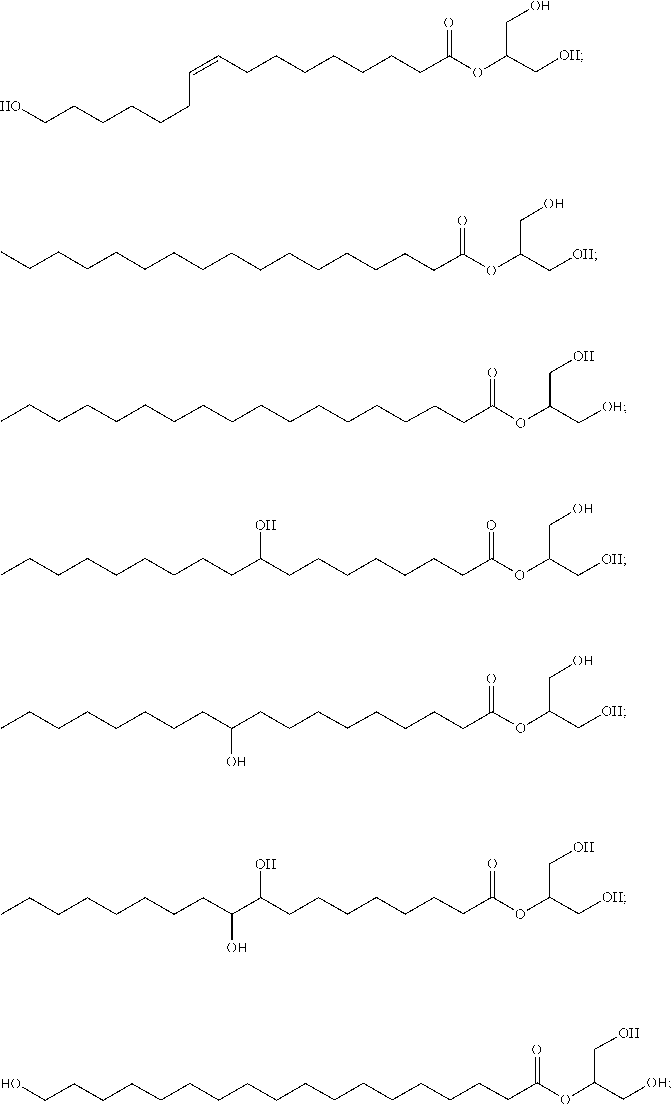

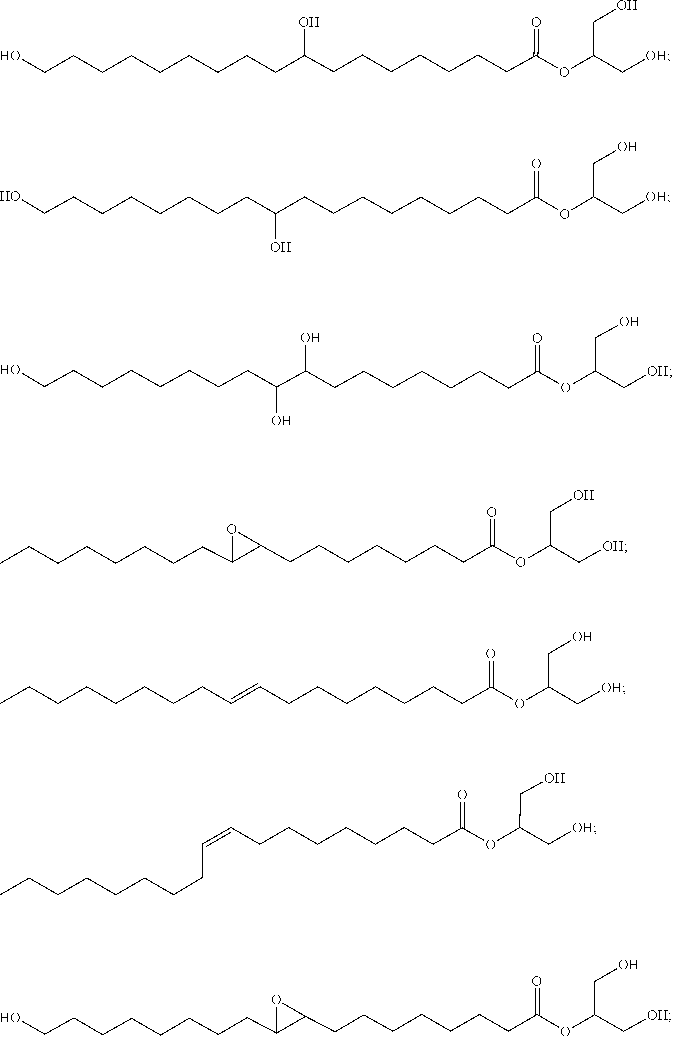

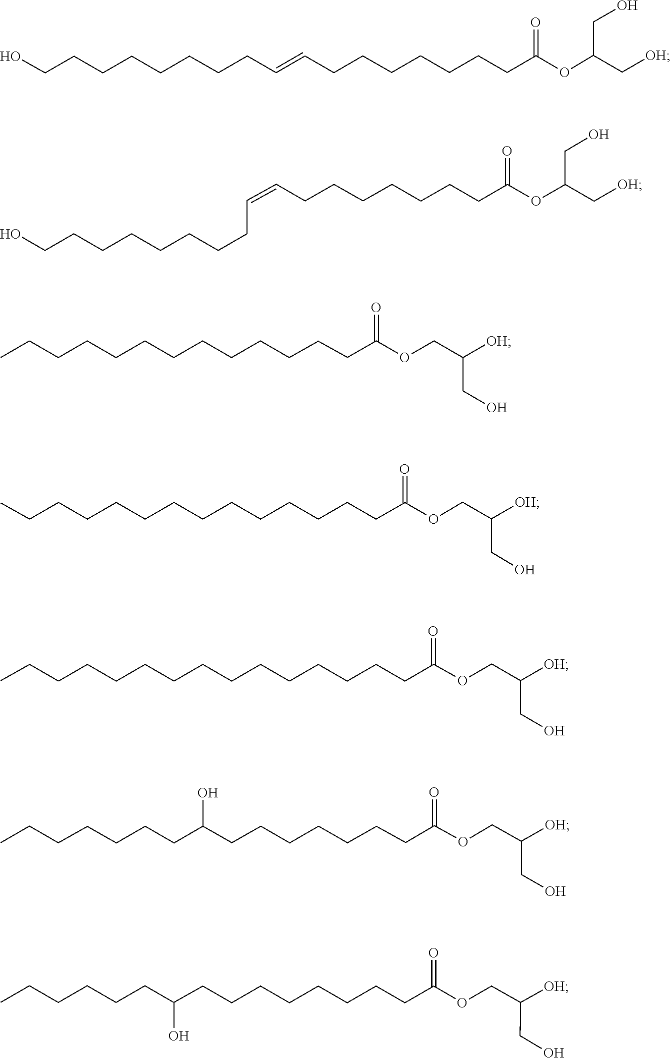

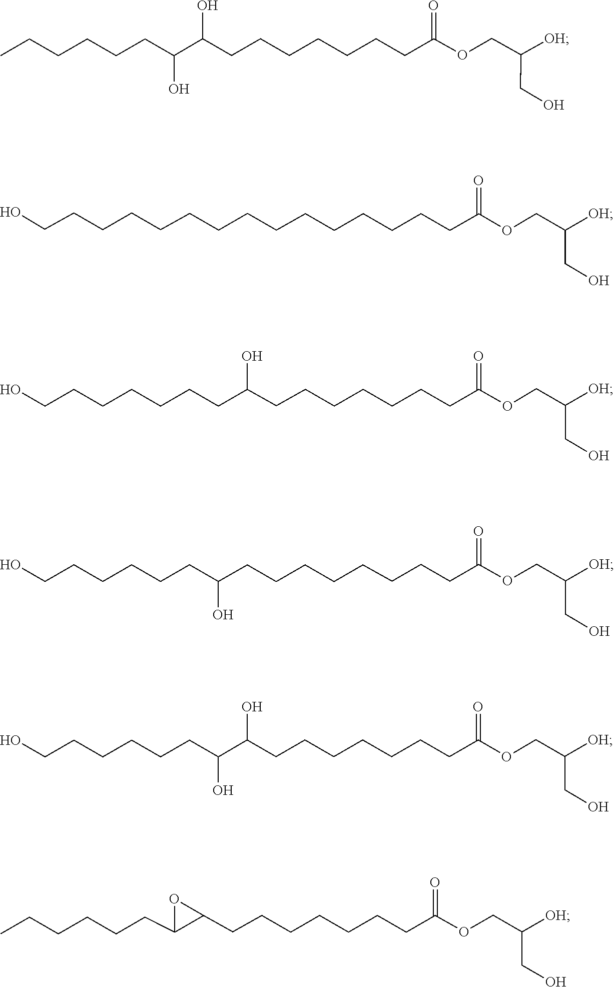 [SMILES: CCCCCCC(O)C(O)CCCCCCCC(=O)OCC(O)CO ; O=C(CCCCCCCCCCCCCCCO)OCC(O)CO ; O=C(CCCCCCCC(O)CCCCCCCO)OCC(O)CO ; O=C(CCCCCCCCC(O)CCCCCCO)OCC(O)CO ; O=C(CCCCCCCC(O)C(O)CCCCCCO)OCC(O)CO ; CCCCCCC1OC1CCCCCCCC(=O)OCC(O)CO]

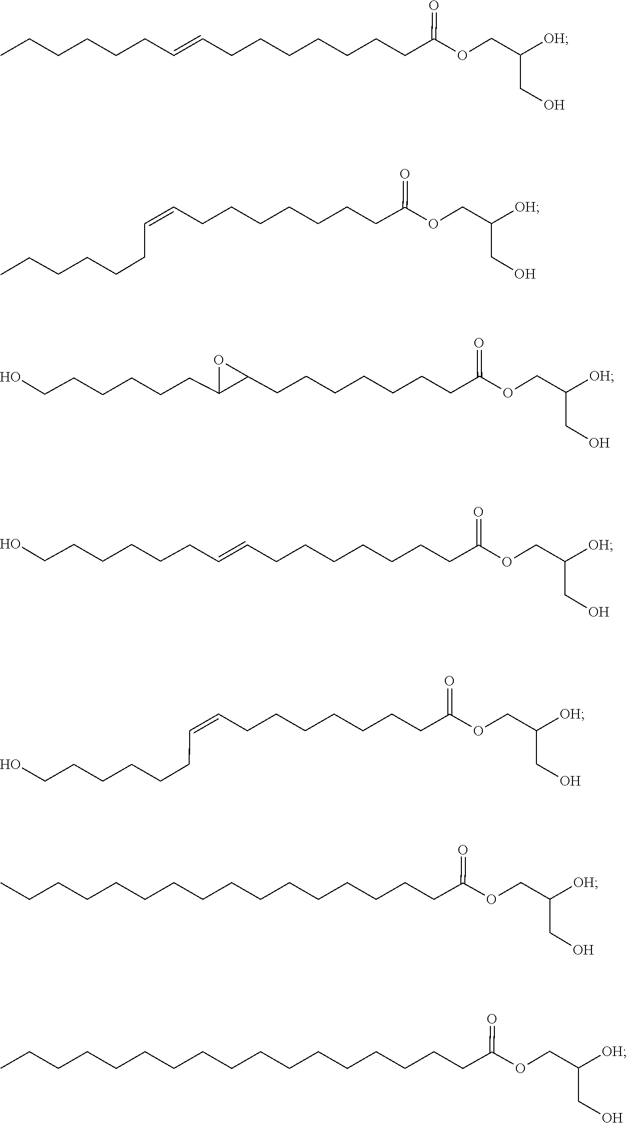

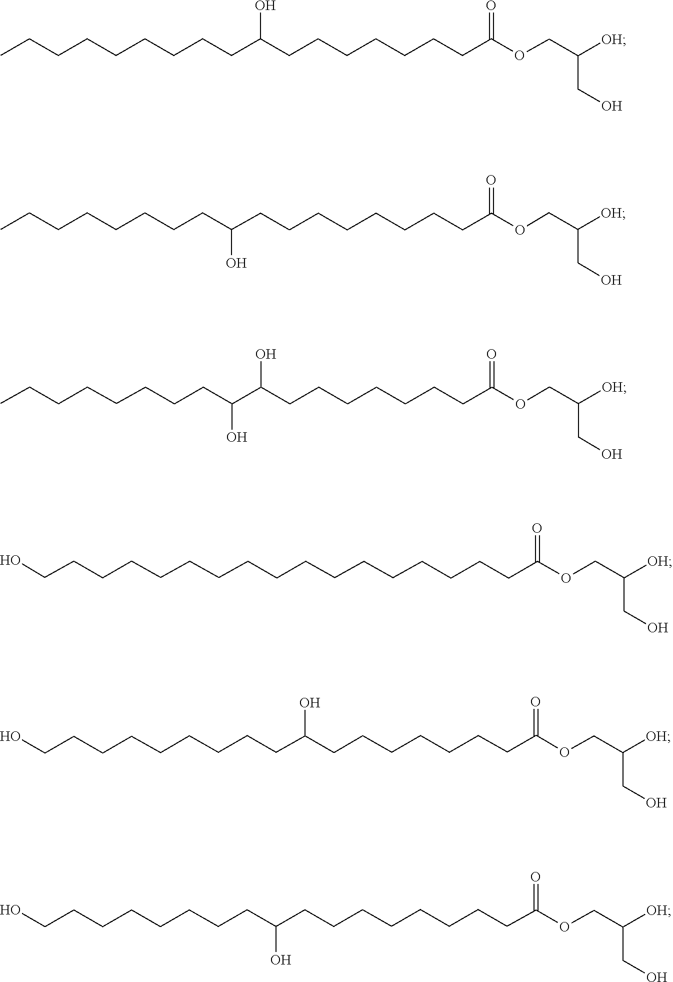 [SMILES: CCCCCCCCCC(O)CCCCCCCC(=O)OCC(O)CO ; CCCCCCCCC(O)CCCCCCCCC(=O)OCC(O)CO ; CCCCCCCCC(O)C(O)CCCCCCCC(=O)OCC(O)CO ; O=C(CCCCCCCCCCCCCCCCCO)OCC(O)CO ; O=C(CCCCCCCC(O)CCCCCCCCCO)OCC(O)CO ; O=C(CCCCCCCCC(O)CCCCCCCCO)OCC(O)CO]

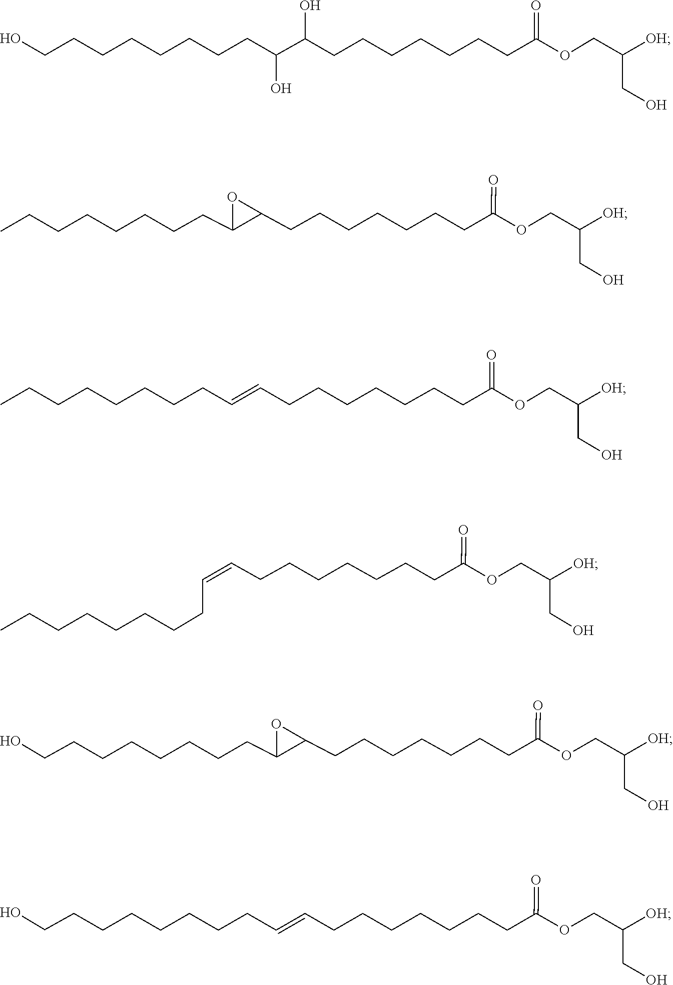 [SMILES: O=C(CCCCCCCC(O)C(O)CCCCCCCCO)OCC(O)CO ; CCCCCCCCC1OC1CCCCCCCC(=O)OCC(O)CO ; CCCCCCCC/C=C/CCCCCCCC(=O)OCC(O)CO ; CCCCCCCC/C=C\CCCCCCCC(=O)OCC(O)CO ; O=C(CCCCCCCC1OC1CCCCCCCCO)OCC(O)CO ; O=C(CCCCCCC/C=C/CCCCCCCCO)OCC(O)CO]

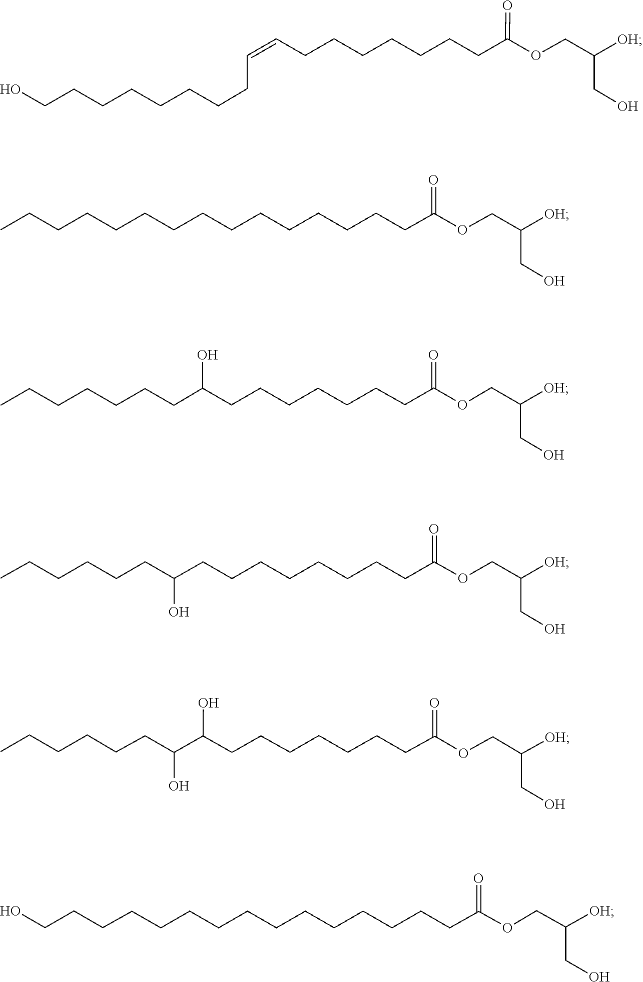 [SMILES: O=C(CCCCCCC/C=C\CCCCCCCCO)OCC(O)CO ; CCCCCCCCCCCCCCCC(=O)OCC(O)CO ; CCCCCCCC(O)CCCCCCCC(=O)OCC(O)CO ; CCCCCCC(O)CCCCCCCCC(=O)OCC(O)CO ; CCCCCCC(O)C(O)CCCCCCCC(=O)OCC(O)CO ; O=C(CCCCCCCCCCCCCCCO)OCC(O)CO]

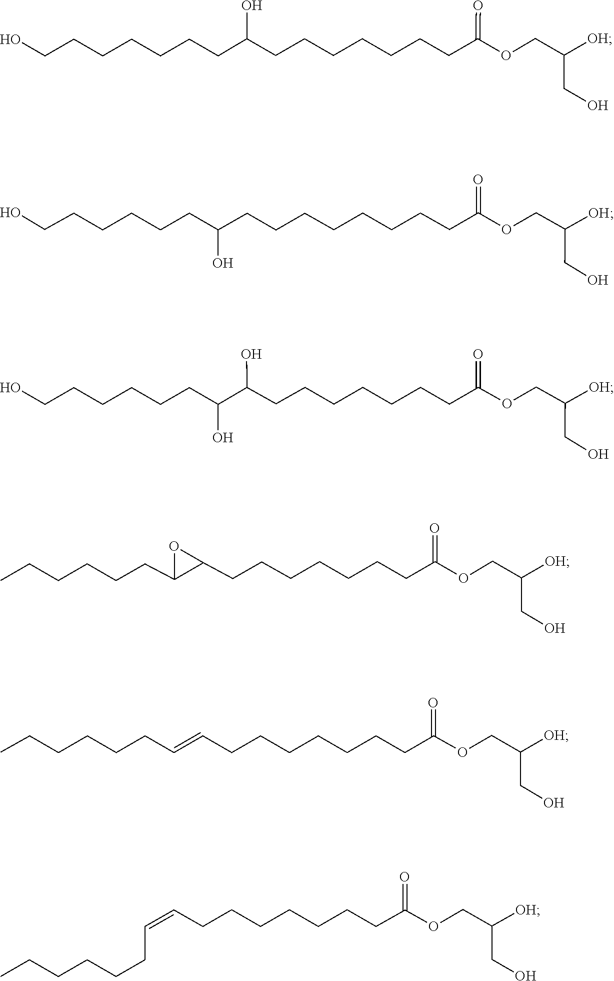 [SMILES: O=C(CCCCCCCC(O)CCCCCCCO)OCC(O)CO ; O=C(CCCCCCCCC(O)CCCCCCO)OCC(O)CO ; O=C(CCCCCCCC(O)C(O)CCCCCCO)OCC(O)CO ; CCCCCCC1OC1CCCCCCCC(=O)OCC(O)CO ; CCCCCC/C=C/CCCCCCCC(=O)OCC(O)CO ; CCCCCC/C=C\CCCCCCCC(=O)OCC(O)CO]

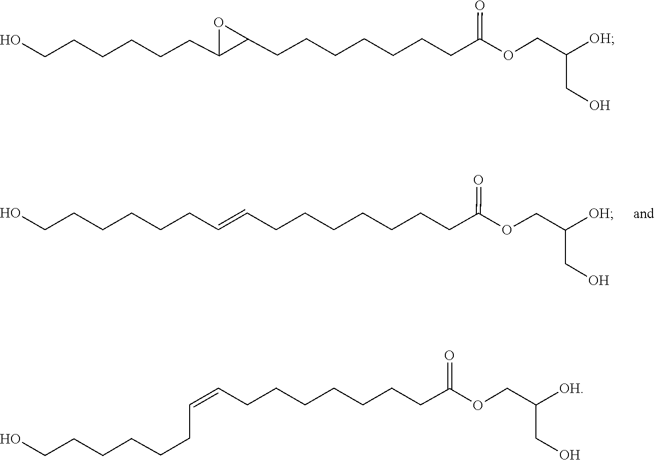 [SMILES: O=C(CCCCCCCC1OC1CCCCCCO)OCC(O)CO ; O=C(CCCCCCC/C=C/CCCCCCO)OCC(O)CO ; O=C(CCCCCCC/C=C\CCCCCCO)OCC(O)CO]

In some embodiments, the one or more fatty acid salts having a structure according to Formula III are derived from a long chain fatty acid or a medium chain fatty acid. In a preferred embodiment, the one or more fatty acid salts having a structure according to Formula III are derived from a long chain fatty acid.

In some embodiments, the one or more fatty acid salts having a structure according to Formula III are derived from a fatty acid selected from the group consisting of:

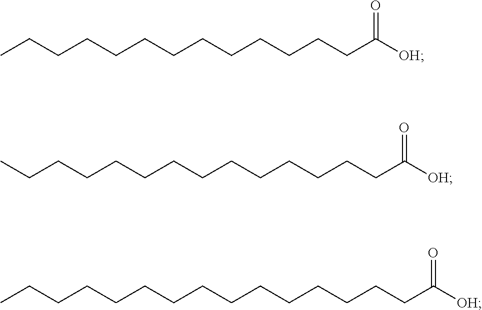 [SMILES: CCCCCCCCCCCCCC(=O)O ; CCCCCCCCCCCCCCC(=O)O ; CCCCCCCCCCCCCCCC(=O)O]

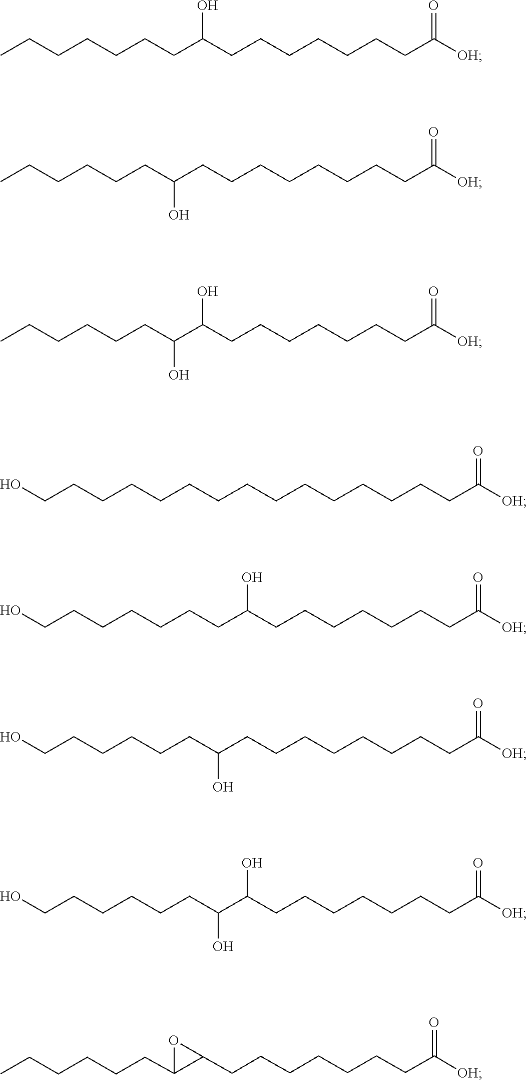

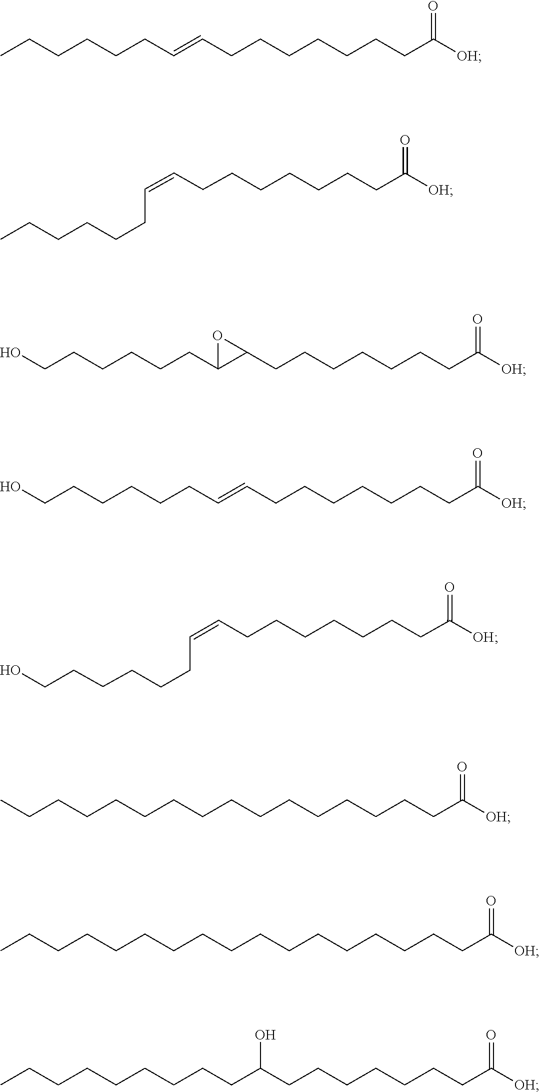

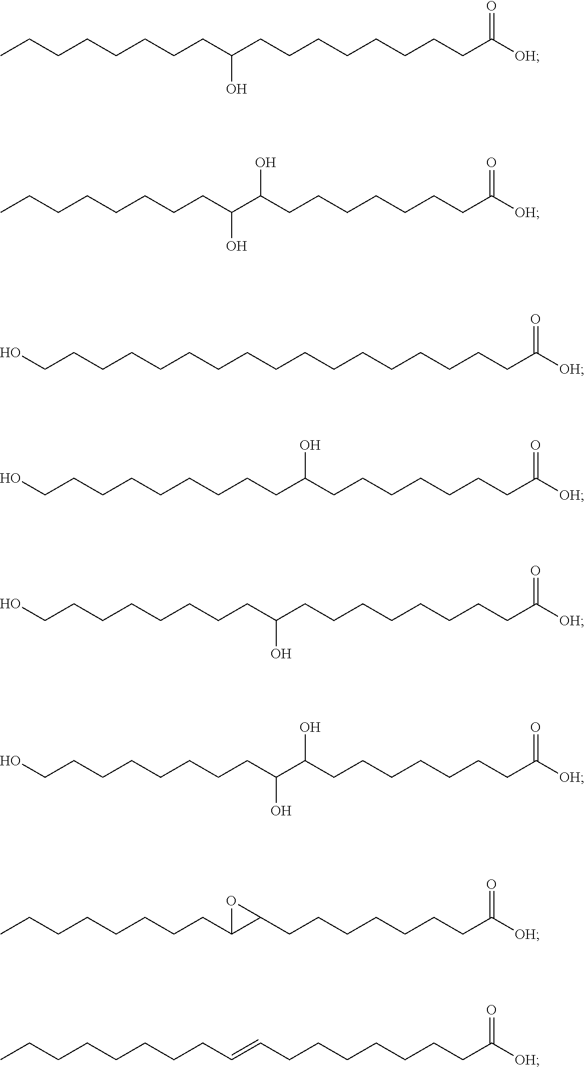

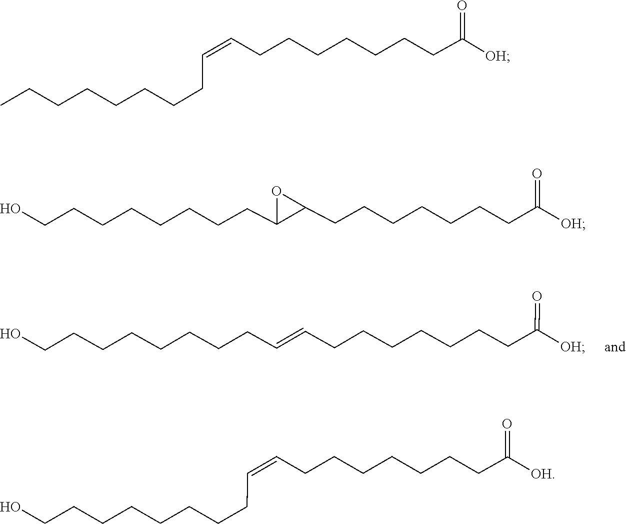 [SMILES: CCCCCCCC/C=C\CCCCCCCC(=O)O ; O=C(O)CCCCCCCC1OC1CCCCCCCCO ; O=C(O)CCCCCCC/C=C/CCCCCCCCO ; O=C(O)CCCCCCC/C=C\CCCCCCCCO]

In some embodiments, the compositions useful in the methods of the disclosure comprise from 70% to 99% by mass of a first group of compounds of Formula I and from 1% to 30% by mass of a second group of compounds of Formula III. In some embodiments, the compositions useful in the methods of the disclosure comprise from about 70% to 99% by mass of one or more monoglycerides according to Formula I, and from 1% to 30% by mass of one or more fatty acid salts of Formula III.

In some embodiments, the one or more monoglycerides of the compositions that are useful in the methods of the disclosure are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.

In some embodiments, the one or more fatty acid salts of the compositions that are useful in the methods of the disclosure are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, or (MA)₂-Ca.

The compositions that are useful in the methods of the disclosure may be provided as a solution, suspension or colloid, or as a powder that may be solubilized or suspended in a suitable solvent. Examples of suitable solvents include, but are not limited to, water, an alcohol (e.g., methanol, ethanol, isopropanol, and butanol), acetone, ethyl acetate, chloroform, acetonitrile, tetrahydrofuran, diethyl ether, methyl tert-butyl ether, or a combination thereof. The resulting solutions, suspensions, or colloids are suitable for forming coatings on the above-ground biomass of plants. For example, the solutions, suspensions, or colloids may be applied to the surface of that biomass, after which the solvent is removed via evaporation, leaving a protective coating formed from the composition on the surface of the above-ground biomass of the plant.

In some embodiments, the compositions that are useful in the methods of the disclosure are solubilized or suspended in a solvent. In some embodiments, the solvent is water, an alcohol, or a mixture thereof. In some embodiments, the solvent is at least 50% water by volume.

In some embodiments, the compositions (e.g., the coating agents or coatings) herein are derived from cutin obtained from a plant cuticle. In some embodiments, the plant that the cutin is obtained from is selected from palm, rapeseed, grapeseed, pumpkin, and coconut.

In some embodiments, the compositions (e.g., the coating agents or coatings) comprise one or more fatty acid derivatives. In some embodiments, the one or more fatty acid derivatives comprise one or more fatty acids, fatty acid esters, or a combination thereof. In some embodiments, the one or more fatty acid derivatives comprise one or more fatty acid salts. In some embodiments, the one or more fatty acid derivatives comprise two or more fatty acids, fatty acid esters, or a combination thereof. In some embodiments, the one or more fatty acid derivatives comprise two or more fatty acid salts. In some embodiments, the one or more fatty acid derivatives comprise one or more fatty acids, fatty acid esters, or a combination thereof and one or more fatty acid salts. In some embodiments, the one or more fatty acid derivatives comprise two or more fatty acids, fatty acid esters, or a combination thereof and two or more fatty acid salts. In some embodiments, the one or more fatty acid derivatives comprise one fatty acid or ester thereof and one fatty acid salt. In some embodiments, the one or more fatty acid derivatives comprise one fatty acid thereof and one fatty acid salt. In some embodiments, the one or more fatty acid derivatives comprise one fatty acid ester and one fatty acid salt. In some embodiments, the one or more fatty acid derivatives comprise two fatty acids, fatty acid esters, or a combination thereof and two fatty acid salts. In some embodiments, the one or more fatty acid derivatives comprise two fatty acid esters and two fatty acid salts. In some embodiments, the one or more fatty acid derivatives comprise two fatty acid esters and one fatty acid salt. In some embodiments, the one or more fatty acid derivatives comprise one fatty acid ester, one fatty acid, and one fatty acid salts. In some embodiments, the one or more fatty acid derivatives comprise one fatty acid ester and one fatty acid salt.

In some embodiments, the one or more fatty acids, fatty acid esters, or a combination thereof comprise one or more fatty acid esters. In some embodiments, the one or more fatty acid esters is one fatty acid ester. In some embodiments, the one or more fatty acid esters is two fatty acid esters.

In some embodiments, the one or more fatty acid salts is one fatty acid salt. In some embodiments, the one or more fatty acid salts is two fatty acid salts.

In some embodiments, the one or more fatty acids, fatty acid esters, or a combination thereof comprise one monoglyceride (e.g., a 1-monoglyceride or a 2-monoglyceride). In some embodiments, the one or more fatty acids, fatty acid esters, or a combination thereof comprise two monoglycerides (e.g., two 1-monoglycerides, two 2-monoglycerides, or one 1-monoglyceride and one 2-monoglyceride).

In some embodiments, the composition (e.g., coating or coating agent) comprises from about 40% to about 100% by weight of the one or more fatty acids, fatty acid esters, or a combination thereof. For example, the composition comprises from about 40% to about 45%, from about 45% to about 50%, from about 50% to about 55%, from about 55% to about 60%, from about 60% to about 65%, from about 65% to about 70%, from about 70% to about 75%, from about 75% to about 80%, from about 80% to about 85%, from about 85% to about 90%, from about 90% to about 95%, from about 95% to about 100%, from about 40% to about 50%, from about 50% to about 60%, from about 60% to about 70%, from about 70% to about 80%, from about 80% to about 90%, from about 65% to about 99%, from about 90% to about 100%, from about 40% to about 60%, from about 60% to about 80%, from about 80% to about 100%, from about 60% to about 100%, from about 70% to about 100%, from about 40% to about 99%, from about 60% to about 99%, from about 70% to about 99%, from about 80% to about 99%, from about 85% to about 99%, from about 90% to about 99%, from about 92% to about 98%, from about 92% to about 96%, from about 93% to about 95%, from about 62% to about 78%, from about 65% to about 75%, from about 67% to about 73%, from about 69% to about 71%, about 68%, about 69%, about 70%, about 71%, about 72%, about 92%, about 93%, about 94%, about 95%, about 96%, about 97%, about 98%, or about 99% by weight of the one or more fatty acids, fatty acid esters, or a combination thereof. For example, the composition comprises from about 60% to about 80%, about 70%, from about 85% to about 99%, about 95%, or about 96% by weight of the one or more fatty acids, fatty acid esters, or a combination thereof.

In some embodiments, the composition (e.g., coating or coating agent) comprises from about 1% to about 50% by weight of the one or more fatty acid salts. For example, the composition comprises from about 1% to about 10%, from about 10% to about 20%, from about 20% to about 30%, from about 30% to about 40%, from about 40% to about 50%, from about 1% to about 40%, from about 1% to about 35%, from about 1% to about 30%, from about 1% to about 20%, from about 10% to about 50%, from about 20% to about 40%, from about 15% to about 45%, from about 25% to about 35%, from about 28% to about 32%, from about 1% to about 10%, from about 2% to about 10%, from about 3% to about 9%, from about 4% to about 8%, from about 4% to about 6%, about 3%, about 4%, about 5%, about 6%, about 7%, about 8%, about 29%, about 30%, or about 31% by weight of the one or more fatty acid salts. In some embodiments, when the composition comprises two fatty acid salts, the molar ratio or weight ratio of the two fatty acid salts is from about 1:20 to about 20:1. For example, from about 1:10 to about 10:1, from about 1:10 to about 2:1, from about 1:4 to about 1:2, from about 1:3 to about 3:1, from about 1:2 to about 2:1, or about 1:1.

In some embodiments, the composition (e.g., coating or coating agent) comprises from about 70% to about 99% by weight of the one or more fatty acids, fatty acid esters, or a combination thereof; and from about 1% to about 30% by weight of the one or more fatty acid salts. In some embodiments, the composition (e.g., coating or coating agent) comprises from about 70% to about 99% by weight of one fatty acid ester; and from about 1% to about 30% by weight of one fatty acid salt. In some embodiments, the composition (e.g., coating or coating agent) comprises from about 70% to about 99% by weight of two fatty acid esters; and from about 1% to about 30% by weight of one fatty acid salt. In some embodiments, the composition (e.g., coating or coating agent) comprises from about 70% to about 99% by weight of one fatty acid ester; and from about 1% to about 30% by weight of two fatty acid salts. In some embodiments, the composition (e.g., coating or coating agent) comprises from about 70% to about 99% by weight of two fatty acid esters; and from about 1% to about 30% by weight of two fatty acid salts. In some embodiments, the composition (e.g., coating or coating agent) comprises one fatty acid ester and one fatty acid salt in a weight ratio of about 70:30 to about 94:6 (e.g., about 70:30 or about 94:6). In some embodiments, the composition (e.g., coating or coating agent) comprises two fatty acid esters and one fatty acid salt in a weight ratio of about 70:30 to about 94:6 (e.g., about 70:30 or about 94:6).

In some embodiments, the composition (e.g., coating or coating agent) comprises one fatty acid ester and two fatty acid salts in a weight ratio of about 70:30 to about 94:6 (e.g., about 70:30 or about 94:6). In some embodiments, the composition (e.g., coating or coating agent) comprises two fatty acid esters and two fatty acid salts in a weight ratio of about 70:30 to about 94:6 (e.g., about 70:30 or about 94:6).

In some embodiments, each fatty acid and/or ester thereof is an independently selected compound of Formula IA:

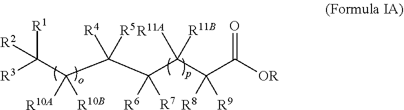

wherein:

R is selected from the group consisting of H and C₁-C₆ alkyl optionally substituted with one or more of OH and C₁-C₆ alkoxy;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl; and

o is an integer from 0 to 17;

p is an integer from 0 to 17;

wherein the sum of o and p is from 0 to 17;

or a salt thereof when R is C₁-C₆ alkyl optionally substituted with one or more of OH and C₁-C₆ alkoxy.

In some embodiments, R is H.

In some embodiments, R is C₁-C₆ alkyl optionally substituted with one or more OH or C₁-C₆ alkoxy. In some embodiments, R is C₁-C₆ alkyl optionally substituted with one or more OH. In some embodiments, R is C₁-C₆ alkyl optionally substituted with two OH. In some embodiments, R is C₁-C₃ alkyl optionally substituted with one or more OH. In some embodiments, R is C₁-C₃ alkyl optionally substituted with two OH. In some embodiments, R is propyl optionally substituted with one or more OH. In some embodiments, R is propyl optionally substituted with two OH. In some embodiments, R is 1,3-dihydroxy-2-propyl. In some embodiments, R is 1,2-dihydroxy-1-propyl.

In some embodiments, R is C₁-C₆ alkyl optionally substituted with one or more C₁-C₆, alkoxy. In some embodiments, R is C₁-C₆ alkyl optionally substituted with two C₁-C₆, alkoxy. In some embodiments, R is C₁-C₃ alkyl optionally substituted with one or more C₁-C₆ alkoxy. In some embodiments, R is C₁-C₃ alkyl optionally substituted with two C₁-C₆, alkoxy.

In some embodiments, the compound of Formula IA is a compound of Formula IA-A:

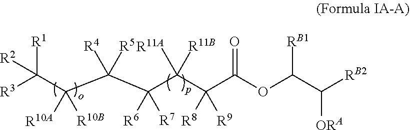

or a salt thereof,

wherein:

one of R^{B1} and R^{B2} is H, and the other of R^{B1} and R^{B2} is —CH₂OR^{A};

each occurrence of R^{A} is independently selected from H and C₁-C₆ alkyl;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, R^{B1} is H and R^{B2} is —CH₂OR^{A}.

In some embodiments, R^{B1} is —CH₂OR^{A} and R^{B2} is H.

In some embodiments, each R^{A} is H. In some embodiments, one R^{A} is H and the other R^{A} is C₁-C₆ alkyl. In some embodiments, each R^{A} is C₁-C₆ alkyl. In some embodiments, each R^{A} is C₁-C₆ alkyl.

In some embodiments, the compound of Formula IA-A is a compound of Formula IA-A-i:

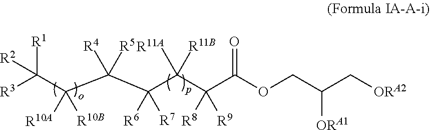

or a salt thereof,

wherein:

R^{A1} and R^{A2} are independently selected from H and C₁-C₆ alkyl;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, R^{A1} is H and R^{A2} is C₁-C₆ alkyl. In some embodiments, R^{A1} is C₁-C₆ alkyl and R^{A2} is H. In some embodiments, R^{A1} and R^{A2} are H.

In some embodiments, the compound of Formula IA-A is a compound of Formula IA-A-ii:

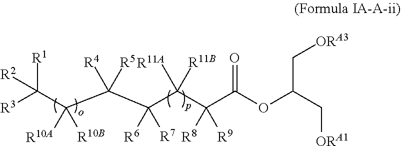

or a salt thereof,

wherein:

R^{A1} and R^{A3} are independently selected from H and C₁-C₆ alkyl;

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, R^{A1} is H and R^{A3} is C₁-C₆ alkyl. In some embodiments, R^{A1} is C₁-C₆ alkyl and R^{A3} is H. In some embodiments, R^{A1} and R^{A3} are H.

In some embodiments, the compound of Formula IA is a compound of Formula IA-B:

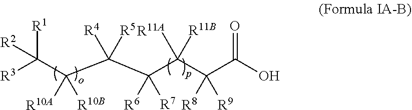

wherein:

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17; and

wherein the sum of o and p is from 0 to 17.

In some embodiments, each fatty acid salt is an independently selected compound of Formula II:

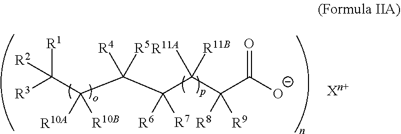

wherein:

R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;

each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;

or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;

o is an integer from 0 to 17;

p is an integer from 0 to 17;

wherein the sum of o and p is from 0 to 17;

Xⁿ⁺ is a cationic moiety having formal charge n; and

each occurrence of R′ is selected from H and C₁-C₆ alkyl.

In some embodiments, Xⁿ⁺ is selected from Na⁺, K⁺, Ag⁺, Ca²⁺, Mg²⁺, Zn²⁺, Cu²⁺, and (R′)₄N⁺.

In some embodiments, each R′ is an independently selected C₁-C₆ alkyl. In some embodiments, one R′ is H and the other three R′ are independently selected C₁-C₆ alkyl. In some embodiments, two R′ are H and the other two R′ are independently selected C₁-C₆ alkyl. In some embodiments, three R′ are H and the other R′ is C₁-C₆ alkyl. In some embodiments, each R′ is H.

In some embodiments, Xⁿ⁺ is selected from Na⁺, K⁺, Ag⁺, Ca²⁺, Mg²⁺, and Zn²⁺. In some embodiments, Xⁿ⁺ is selected from Na⁺, K⁺, Ca²⁺, Mg²⁺, and Zn²⁺. In some embodiments, Xⁿ⁺ is Na⁺. In some embodiments, Xⁿ⁺ is K⁺. In some embodiments, Xⁿ⁺ is Ca²⁺. In some embodiments, Xⁿ⁺ is Mg²⁺. In some embodiments, Xⁿ⁺ is Zn²⁺.

In some embodiments, R¹, R², R³, R⁴, R⁵, R⁶, R⁷, R⁸, and R⁹ are independently selected from the group consisting of: H, OH, C₁-C₆ alkyl, and C₁-C₆ alkoxy. In some embodiments, R¹, R², R³, R⁴, R⁵, R⁶, R⁷, R⁸, and R⁹ are independently selected from the group consisting of: H, OH, and C₁-C₆ alkyl. In some embodiments, R¹, R², R³, R⁴, R⁵, R⁶, R⁷, R⁸, and R⁹ are independently selected from the group consisting of: H and OH. In some embodiments, R¹, R², R³, R⁴, R⁵, R⁶, R⁷, R⁸, and R⁹ are each H. In some embodiments, one of R¹, R², R³, R⁴, R⁵, R⁶, R⁷, R⁸, and R⁹ is OH and the remaining R¹, R², R³, R⁴, R⁵, R⁶, R⁷, R⁸, and R⁹ are each H. In some embodiments, two of R¹, R², R³, R⁴, R⁵, R⁶, R⁷, R⁸, and R⁹ is OH and the remaining R¹, R², R³, R⁴, R⁵, R⁶, R⁷, R⁸, and R⁹ are each H.

In some embodiments, R⁴ is OH. In some embodiments, R⁵ is OH. In some embodiments, R⁶ is OH. In some embodiments, R⁷ is OH.

In some embodiments, each occurrence of R^{10A}, R^{10B}, R^{11A}, and R^{11B} is independently selected from the group consisting of: H, OH, C₁-C₆ alkyl, and C₁-C₆ alkoxy. In some embodiments, each occurrence of R^{10A}, R^{10B}, R^{11A}, and R^{11B} is independently selected from the group consisting of: H, OH, and C₁-C₆ alkyl. In some embodiments, each occurrence of R^{10A}, R^{10B}, R^{11A}, and R^{11B} is independently selected from the group consisting of: H and OH. In some embodiments, each occurrence of R^{10A}, R^{10B}, R^{11A}, and R^{11B} is each H. In some embodiments, one of each occurrence of R^{10A}, R^{10B}, R^{11A}, and R^{11B} is OH and the remaining occurrences of R^{10A}, R^{10B}, R^{11A}, and R^{11B} are each H. In some embodiments, two of each occurrence of R^{10A}, R^{10B}, R^{11A}, and R^{11B} is OH and the remaining occurrences of R^{10A}, R^{10B}, R^{11A}, and R^{11B} are each H.

In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond. In some embodiments, any two pairs of R¹, R², R³, R⁴, R⁵, R⁶, R⁷, R⁸, R⁹, R^{10A}, R^{10B}, R^{11A}, and R^{11B} on adjacent carbon atoms are each taken together with the carbon atoms to which they are attached to form two double bonds. In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a 3- to 6-membered ring heterocycle. In some embodiments, any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, and any two remaining R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a 3- to 6-membered ring heterocycle. In some embodiments, the 3- to 6-membered ring heterocycle is oxiranyl.

In some embodiments, R⁴ is taken together with R⁶ and the carbon atoms to which they are attached to form a double bond. In some embodiments, R⁴ is taken together with R⁶ and the carbon atoms to which they are attached to form a 3- to 6-membered ring heterocycle.

In some embodiments, one of R¹, R², R³, R⁴, R⁵, R⁶, R⁷, R⁸, R⁹, and each occurrence of R^{10A}, R^{10B}, R^{11A}, and R^{11B} is OH; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, one of R¹, R², R³, R⁴, R⁵, R⁶, R⁷, R⁸, R⁹, and each occurrence of R^{10A}, R^{10B}, R^{11A}, and R^{11B} is OH; any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxiranyl; and the remaining R¹, R², R³, R⁴, R⁵, R⁶, R⁷, R⁸, R⁹, and each occurrence of R^{10A}, R^{10B}, R^{11A}, and R^{11B} are each H.

In some embodiments, R¹, R², R³, R⁴, R⁵, R⁶, R⁷, R⁸, R⁹, and each occurrence of R^{10A}, R^{10B}, R^{11A}, and R^{11B} are each H; and any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxiranyl.

In some embodiments, R¹, R², R³, R⁴, R⁵, R⁶, R⁷, R⁸, R⁹, and each occurrence of R^{10A}, R^{10B}, R^{11A}, and R^{11B} are each H; and any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond.

In some embodiments, the sum of o and p is from 0 to 13. In some embodiments, the sum of o and p is from 1 to 9. In some embodiments, the sum of o and p is from 0 to 13. In some embodiments, the sum of o and p is from 5 to 7. In some embodiments, the sum of o and p is from 10 to 13. In some embodiments, the sum of o and p is from 11 to 13. In some embodiments, the sum of o and p is 1. In some embodiments, the sum of o and p is from 10 to 13. In some embodiments, the sum of o and p is 1. In some embodiments, the sum of o and p is 2. In some embodiments, the sum of o and p is 3. In some embodiments, the sum of o and p is 4. In some embodiments, the sum of o and p is 5. In some embodiments, the sum of o and p is 6. In some embodiments, the sum of o and p is 7. In some embodiments, the sum of o and p is 8. In some embodiments, the sum of o and p is 9. In some embodiments, the sum of o and p is 10. In some embodiments, the sum of o and p is 11. In some embodiments, the sum of o and p is 12. In some embodiments, the sum of o and p is 13. In some embodiments, the sum of o and p is 14. In some embodiments, the sum of o and p is 15. In some embodiments, the sum of o and p is 16. In some embodiments, the sum of o and p is 17. Without wishing to be bound by theory, it is believed that compounds of Formula IA-A wherein the sum of o and p is 0 to 9 are able to function as wetting agents when included in the compositions (e.g., mixtures, coatings, and coating agents) described herein, thus increasing the aptitude of the compositions (e.g., mixtures, coatings, and coating agents) to spread over the surface of an agricultural product or plant to form a coating of substantially uniform thickness.

In some embodiments, the compound of Formula IA is selected from the group consisting of:

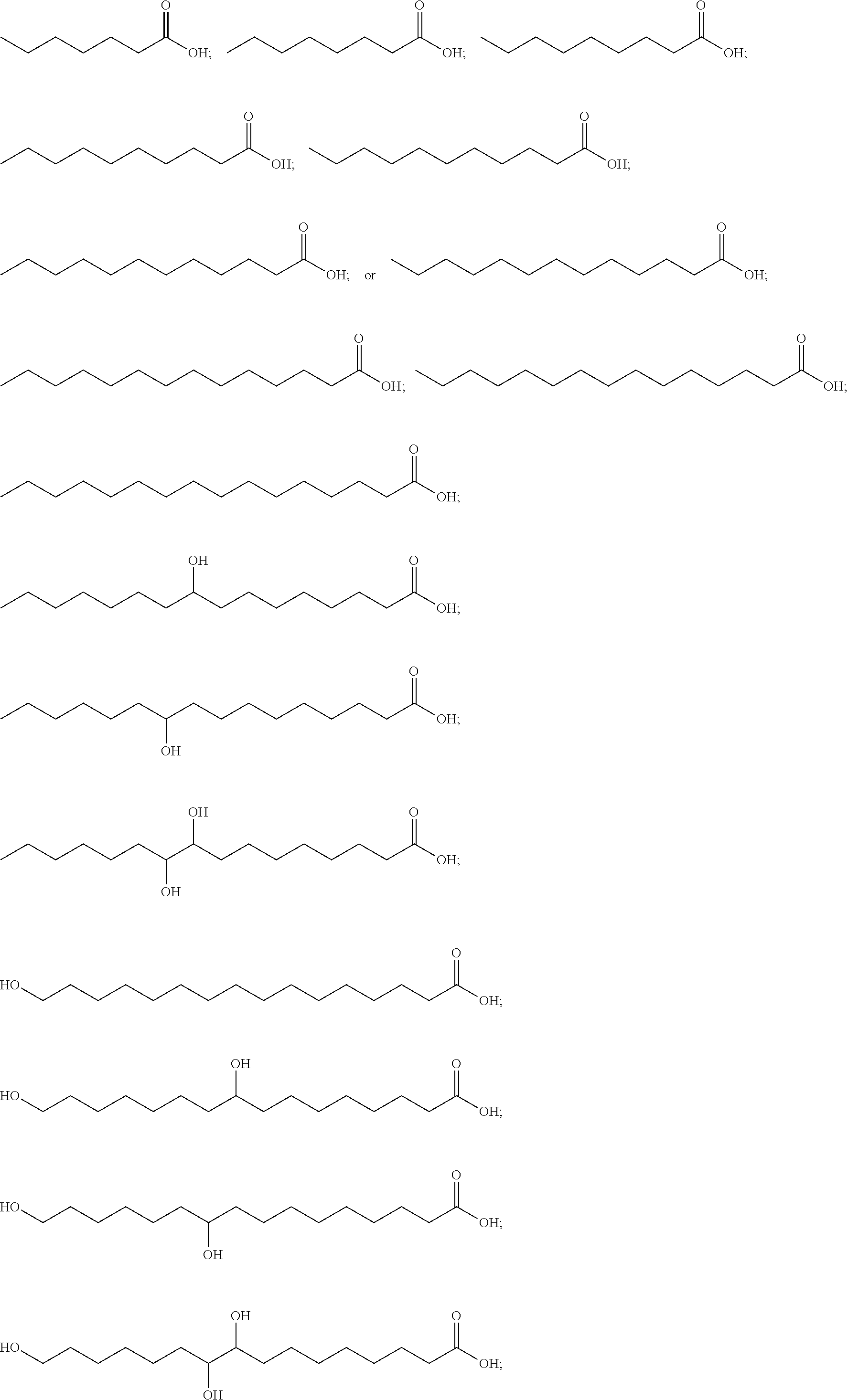

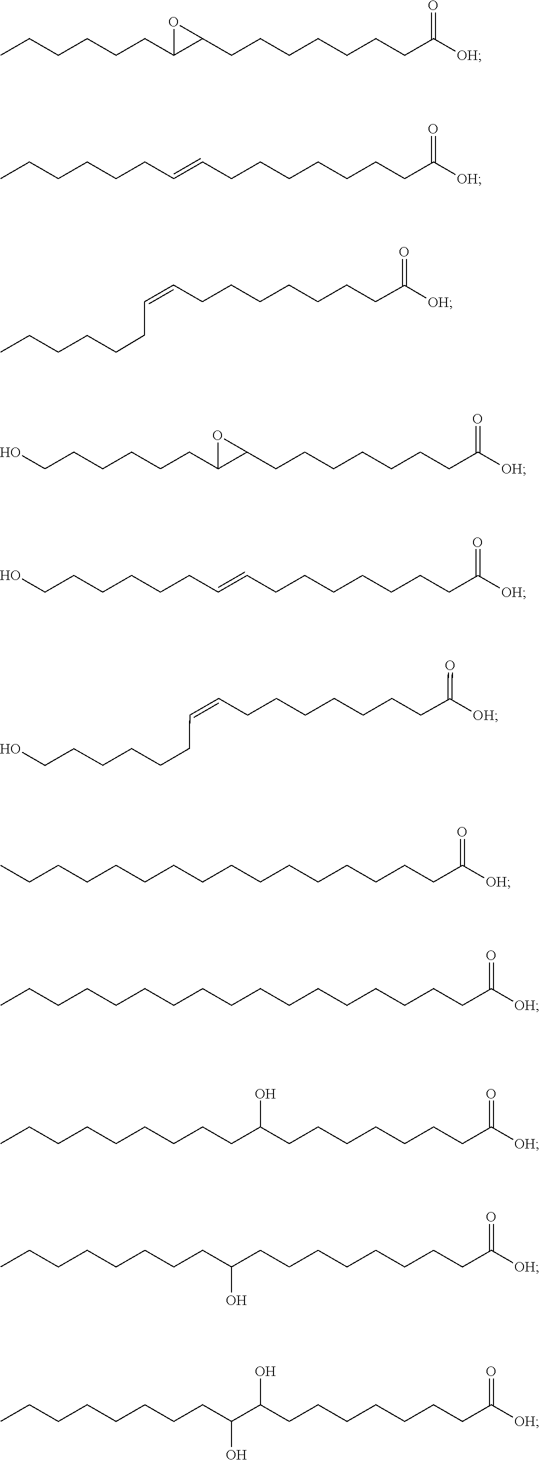

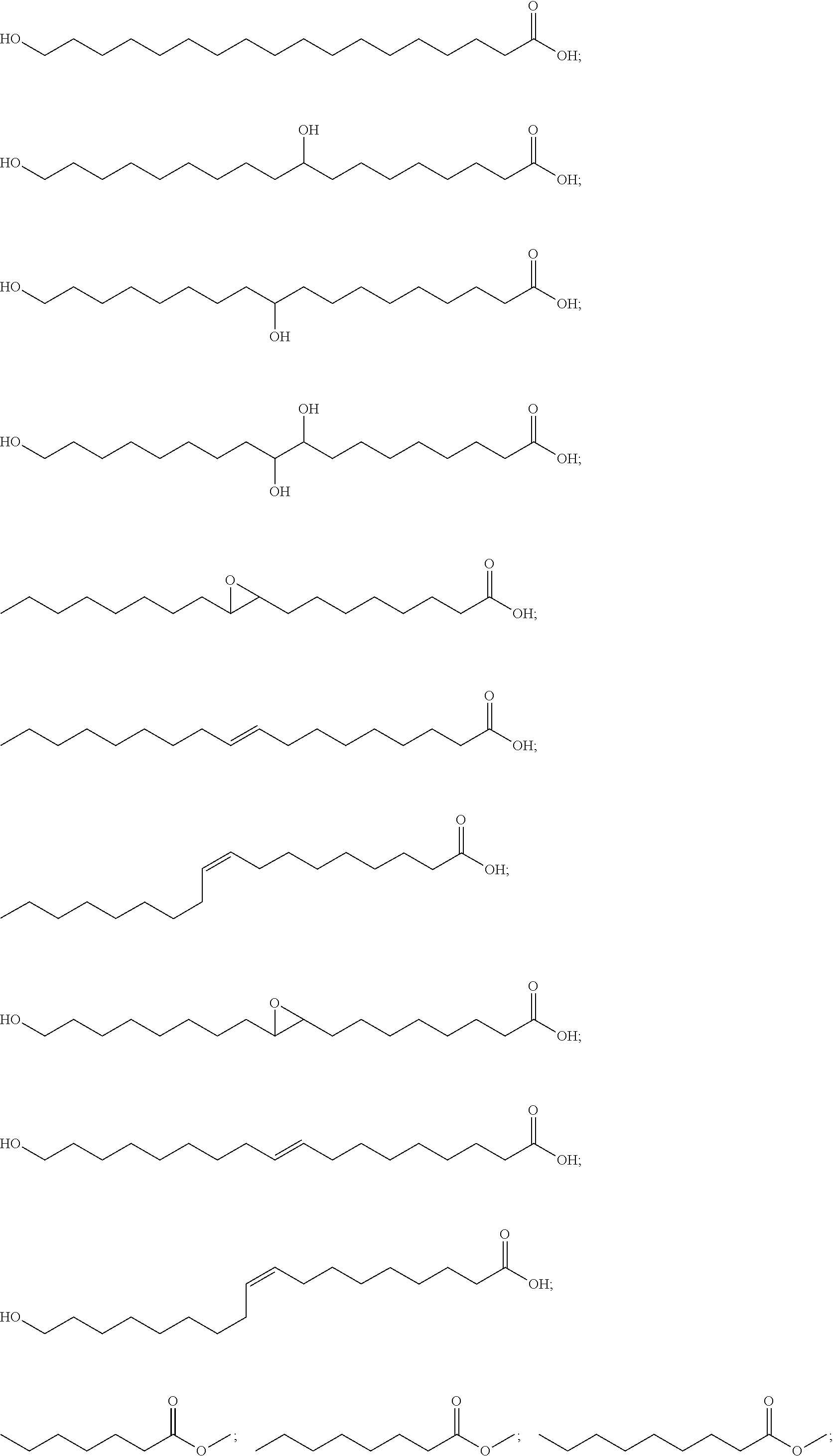

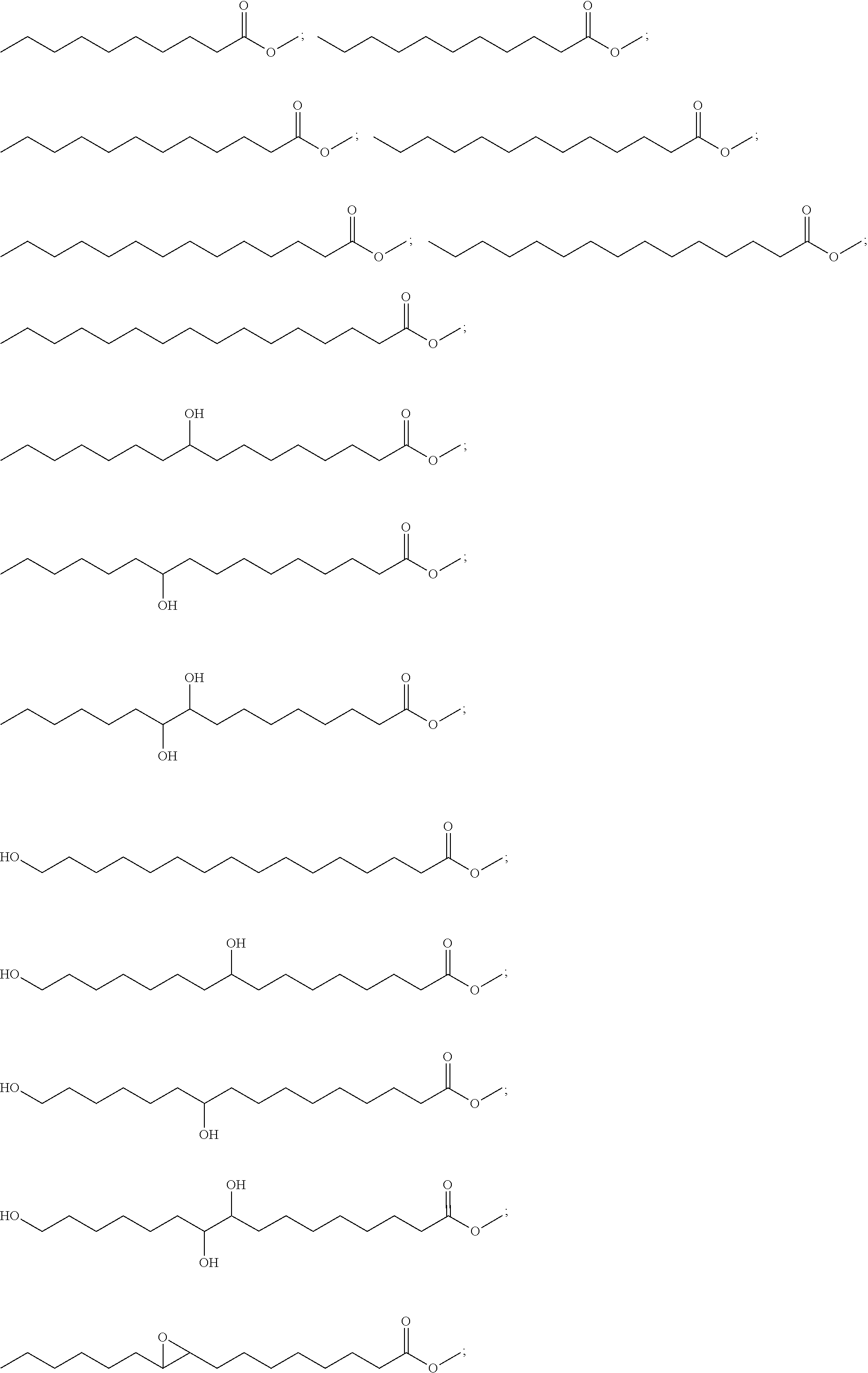

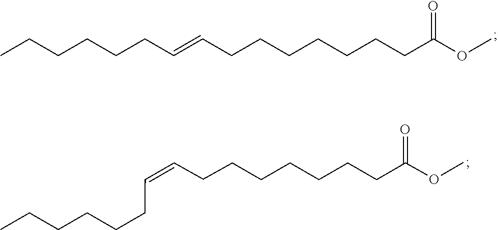

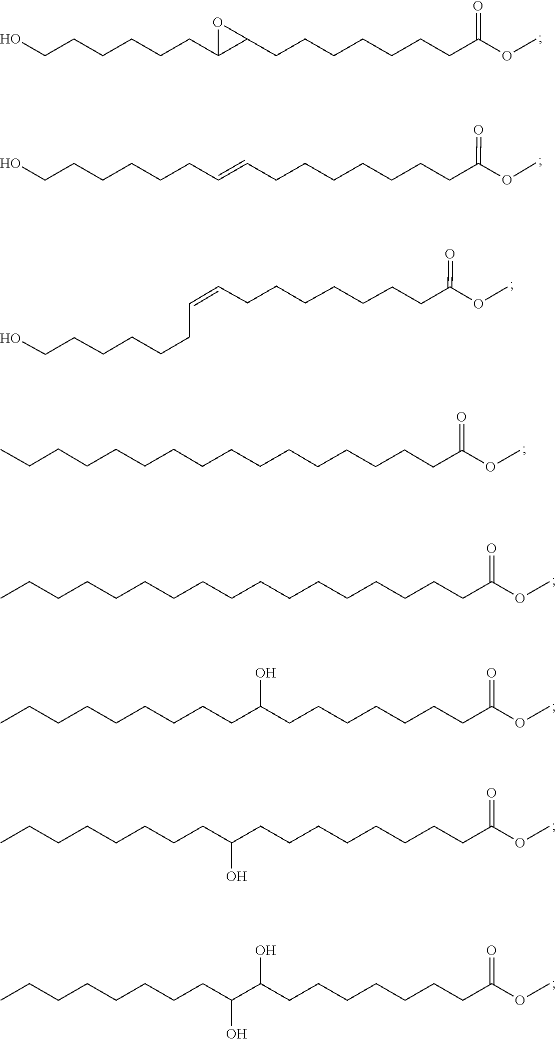

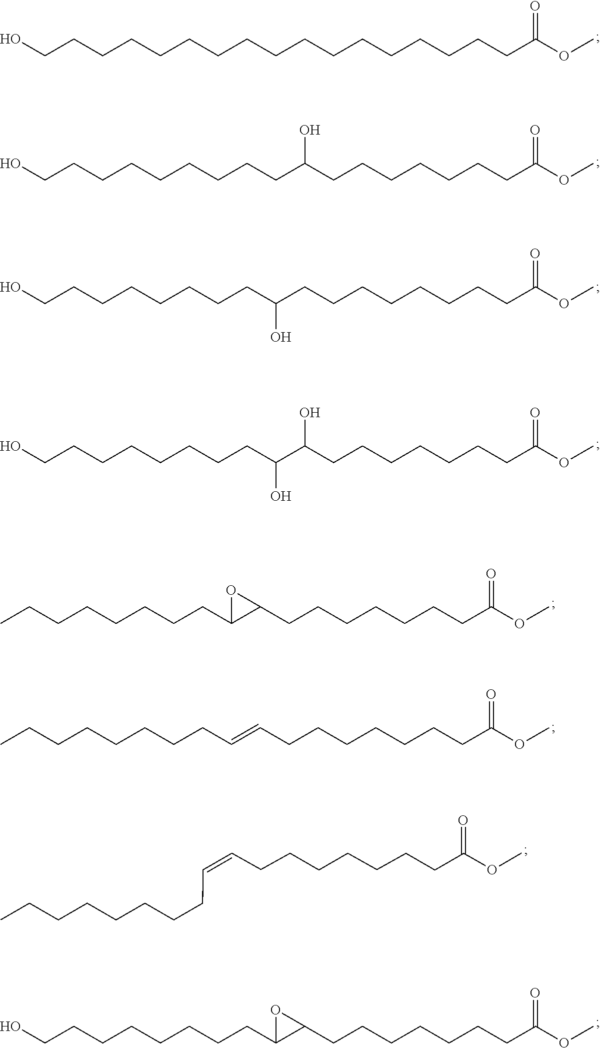

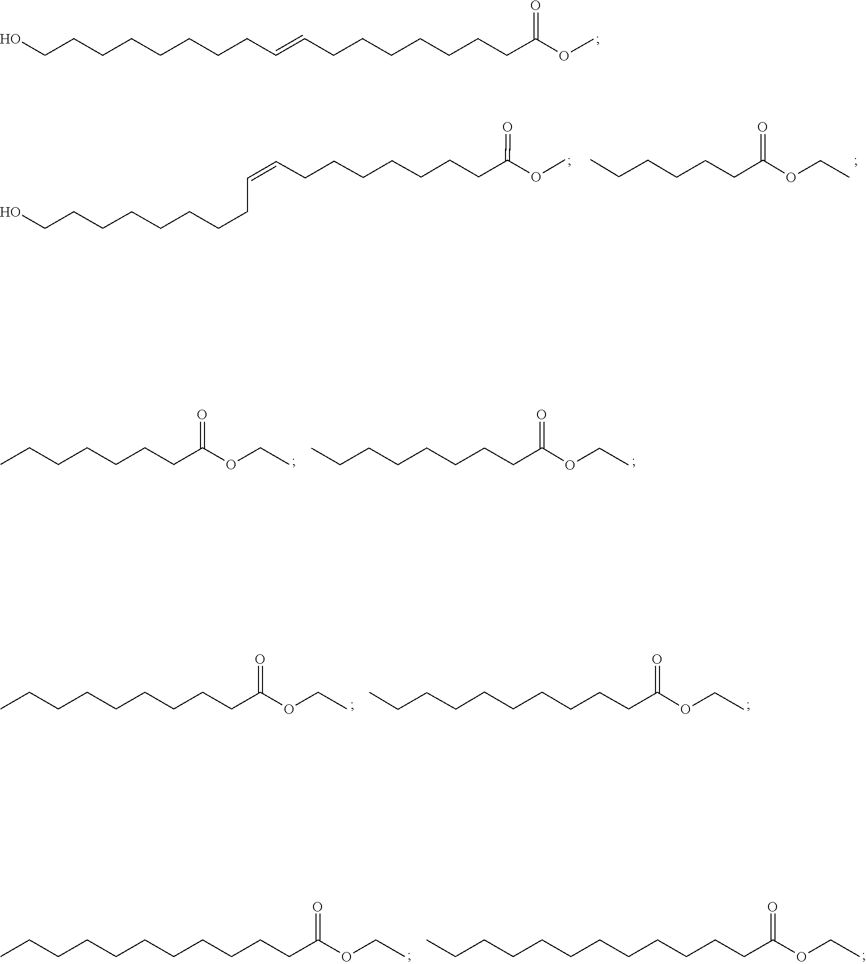

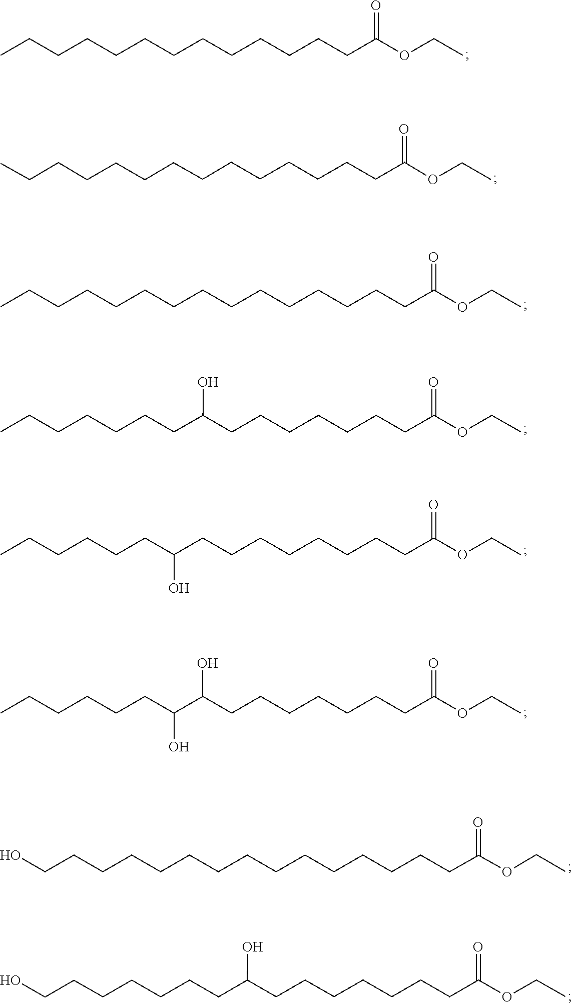

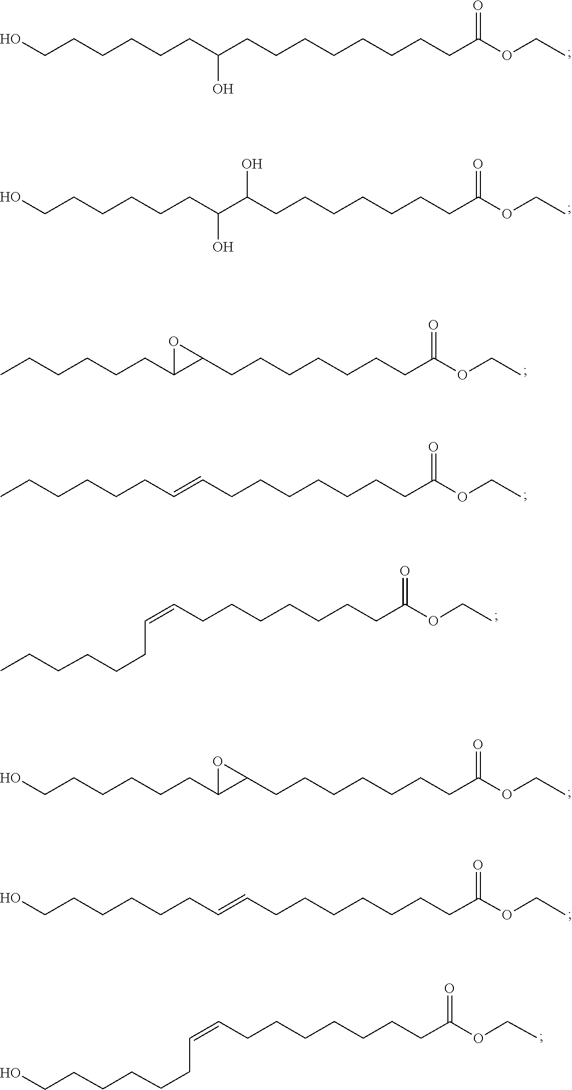

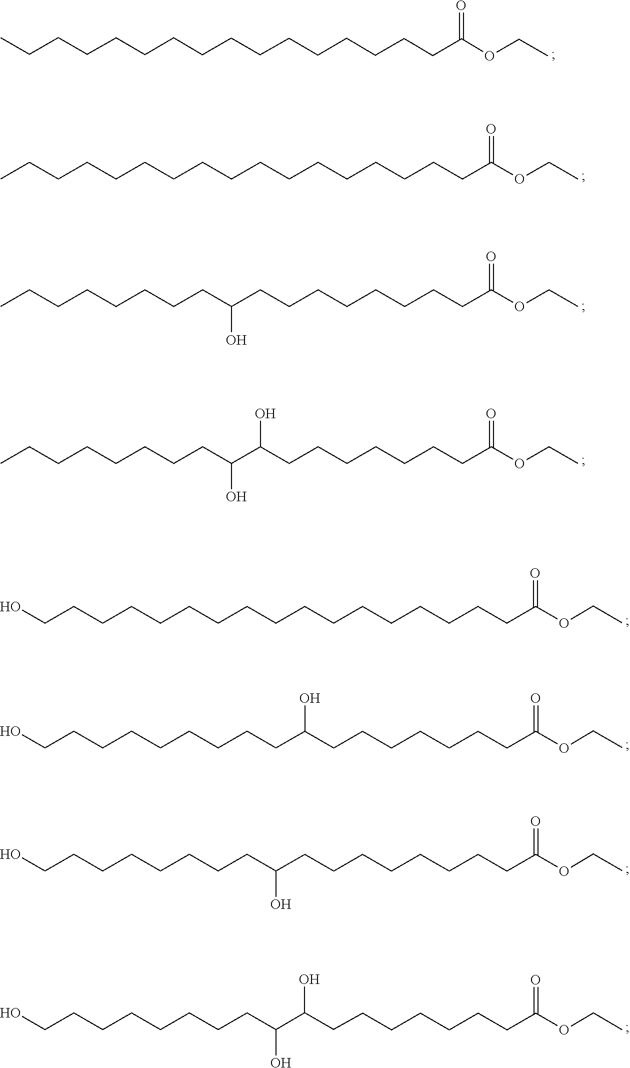

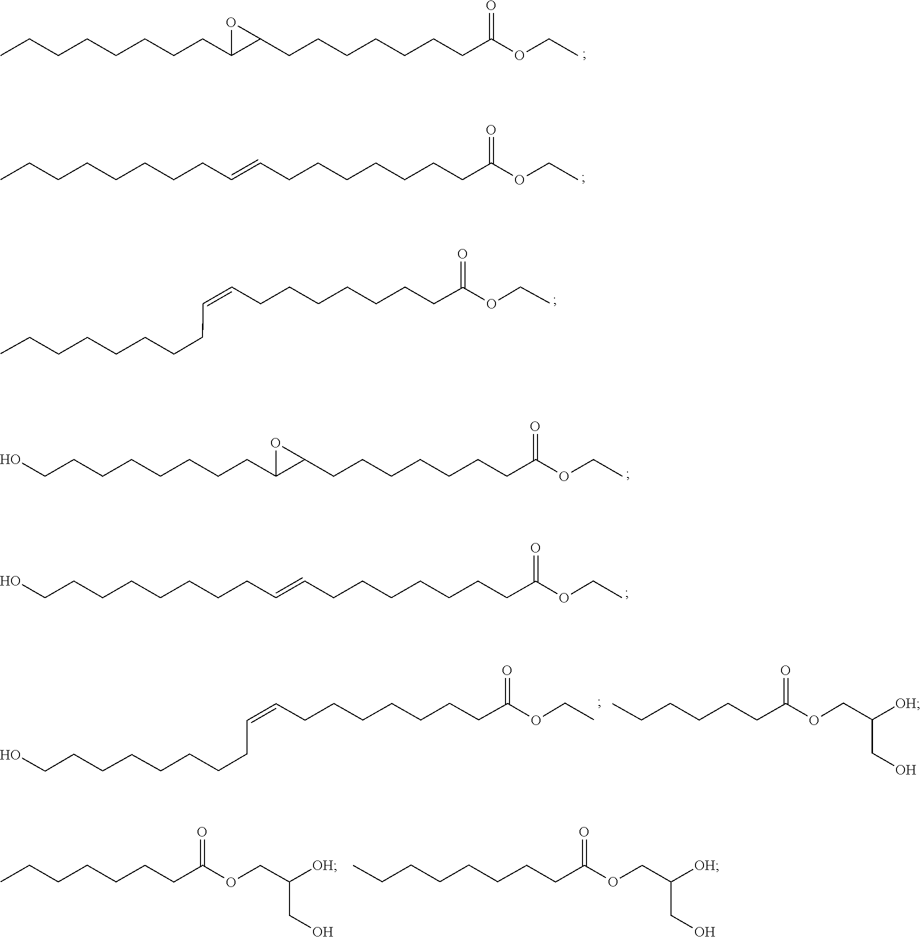

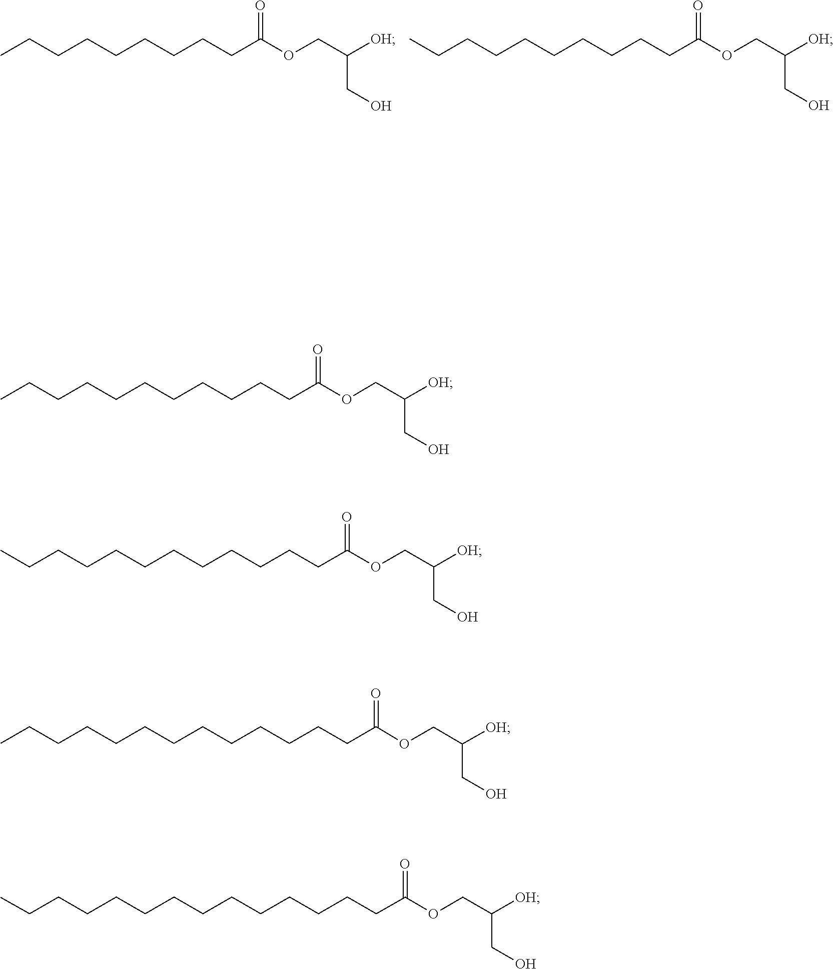

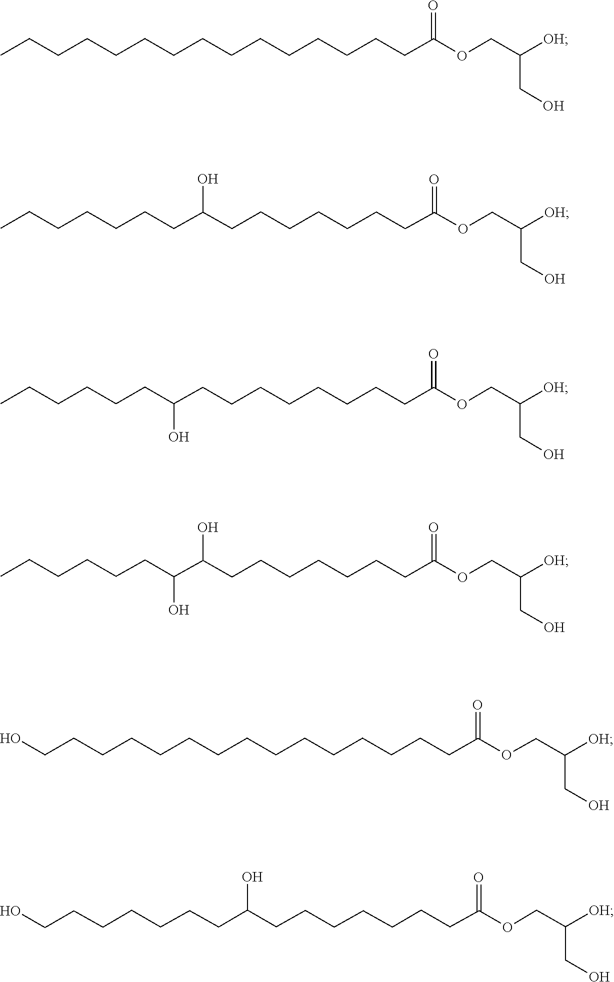 [SMILES: CCCCCCCCCCCCCCCC(=O)OCC(O)CO ; CCCCCCCC(O)CCCCCCCC(=O)OCC(O)CO ; CCCCCCC(O)CCCCCCCCC(=O)OCC(O)CO ; CCCCCCC(O)C(O)CCCCCCCC(=O)OCC(O)CO ; O=C(CCCCCCCCCCCCCCCO)OCC(O)CO ; O=C(CCCCCCCC(O)CCCCCCCO)OCC(O)CO]

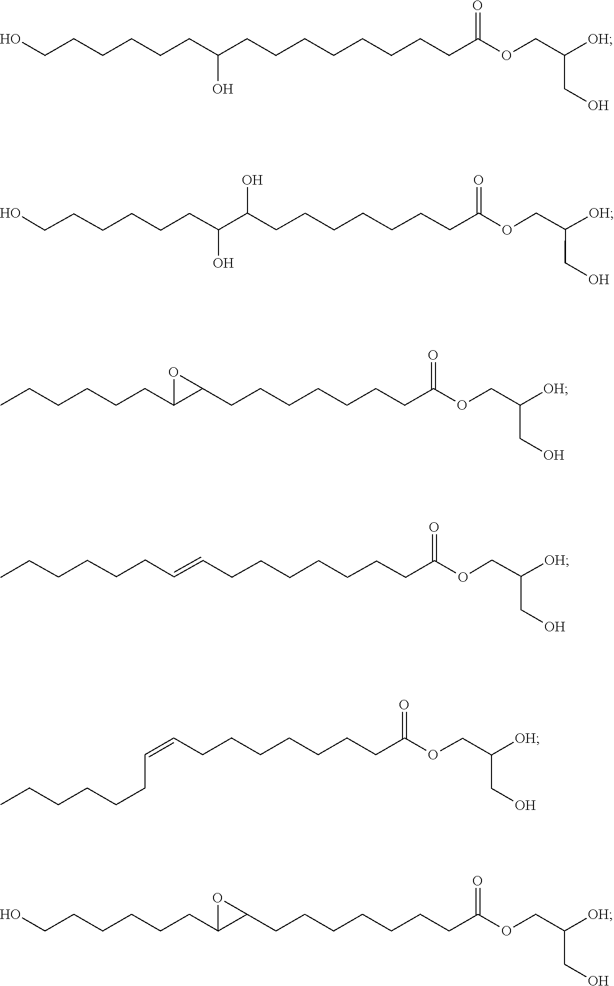 [SMILES: O=C(CCCCCCCCC(O)CCCCCCO)OCC(O)CO ; O=C(CCCCCCCC(O)C(O)CCCCCCO)OCC(O)CO ; CCCCCCC1OC1CCCCCCCC(=O)OCC(O)CO ; CCCCCC/C=C/CCCCCCCC(=O)OCC(O)CO ; CCCCCC/C=C\CCCCCCCC(=O)OCC(O)CO ; O=C(CCCCCCCC1OC1CCCCCCO)OCC(O)CO]

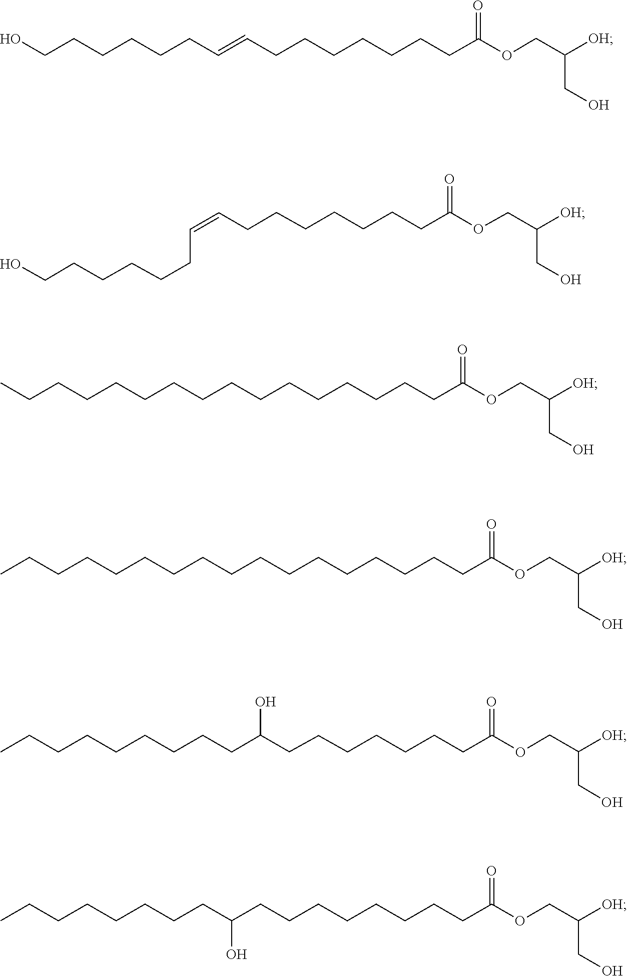 [SMILES: O=C(CCCCCCC/C=C/CCCCCCO)OCC(O)CO ; O=C(CCCCCCC/C=C\CCCCCCO)OCC(O)CO ; CCCCCCCCCCCCCCCCC(=O)OCC(O)CO ; CCCCCCCCCCCCCCCCCC(=O)OCC(O)CO ; CCCCCCCCCC(O)CCCCCCCC(=O)OCC(O)CO ; CCCCCCCCC(O)CCCCCCCCC(=O)OCC(O)CO]

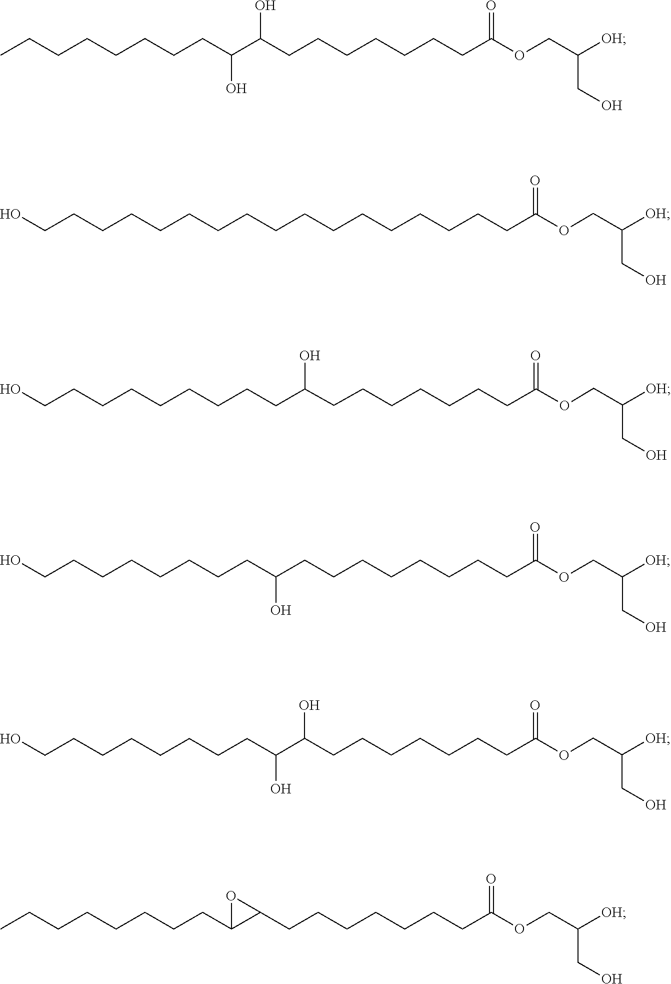 [SMILES: CCCCCCCCC(O)C(O)CCCCCCCC(=O)OCC(O)CO ; O=C(CCCCCCCCCCCCCCCCCO)OCC(O)CO ; O=C(CCCCCCCC(O)CCCCCCCCCO)OCC(O)CO ; O=C(CCCCCCCCC(O)CCCCCCCCO)OCC(O)CO ; O=C(CCCCCCCC(O)C(O)CCCCCCCCO)OCC(O)CO ; CCCCCCCCC1OC1CCCCCCCC(=O)OCC(O)CO]

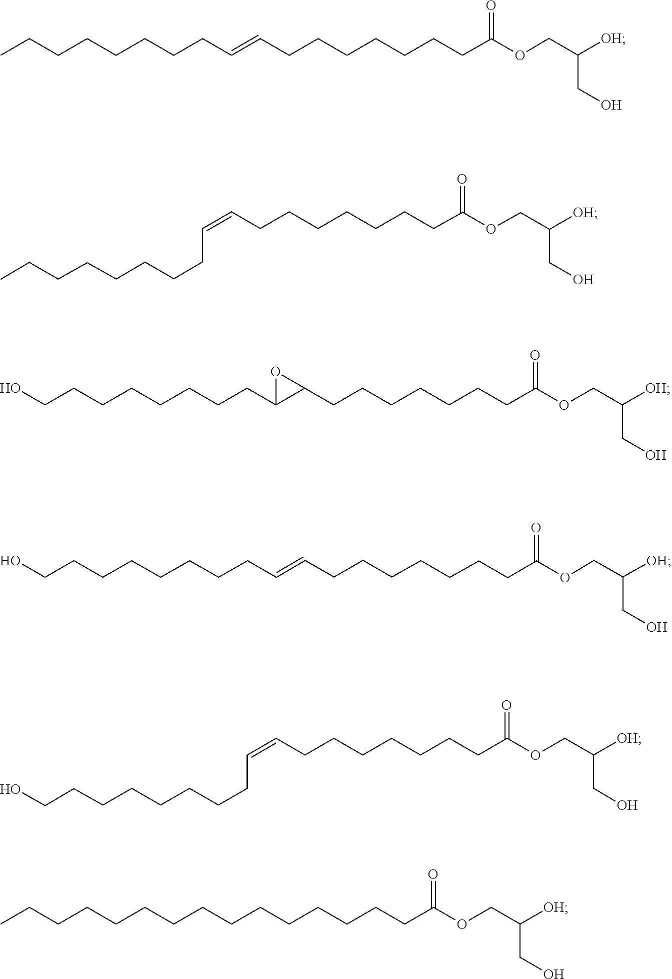 [SMILES: CCCCCCCC/C=C/CCCCCCCC(=O)OCC(O)CO ; CCCCCCCC/C=C\CCCCCCCC(=O)OCC(O)CO ; O=C(CCCCCCCC1OC1CCCCCCCCO)OCC(O)CO ; O=C(CCCCCCC/C=C/CCCCCCCCO)OCC(O)CO ; O=C(CCCCCCC/C=C\CCCCCCCCO)OCC(O)CO ; CCCCCCCCCCCCCCCC(=O)OCC(O)CO]

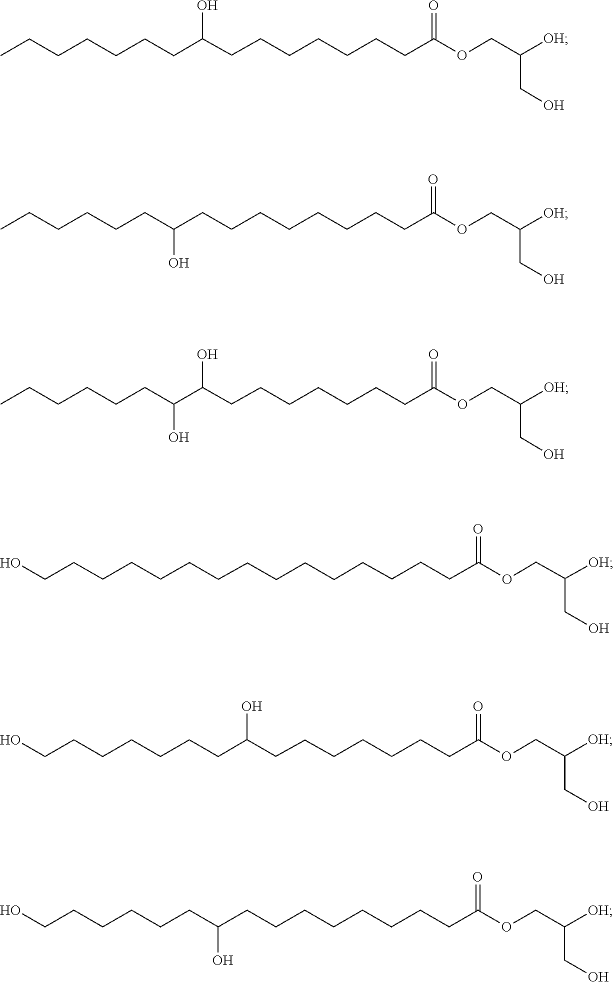 [SMILES: CCCCCCCC(O)CCCCCCCC(=O)OCC(O)CO ; CCCCCCC(O)CCCCCCCCC(=O)OCC(O)CO ; CCCCCCC(O)C(O)CCCCCCCC(=O)OCC(O)CO ; O=C(CCCCCCCCCCCCCCCO)OCC(O)CO ; O=C(CCCCCCCC(O)CCCCCCCO)OCC(O)CO ; O=C(CCCCCCCCC(O)CCCCCCO)OCC(O)CO]

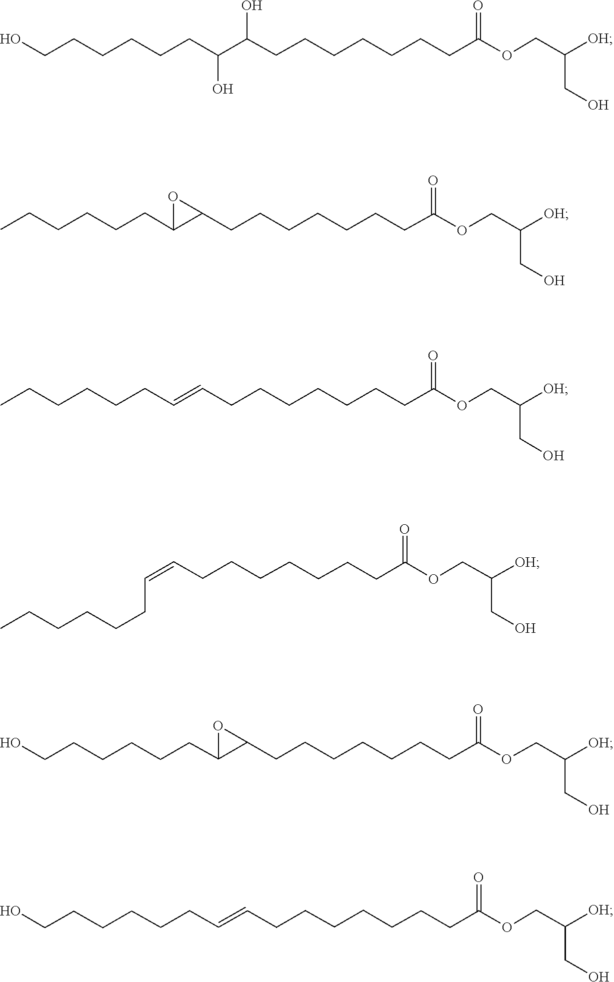 [SMILES: O=C(CCCCCCCC(O)C(O)CCCCCCO)OCC(O)CO ; CCCCCCC1OC1CCCCCCCC(=O)OCC(O)CO ; CCCCCC/C=C/CCCCCCCC(=O)OCC(O)CO ; CCCCCC/C=C\CCCCCCCC(=O)OCC(O)CO ; O=C(CCCCCCCC1OC1CCCCCCO)OCC(O)CO ; O=C(CCCCCCC/C=C/CCCCCCO)OCC(O)CO]

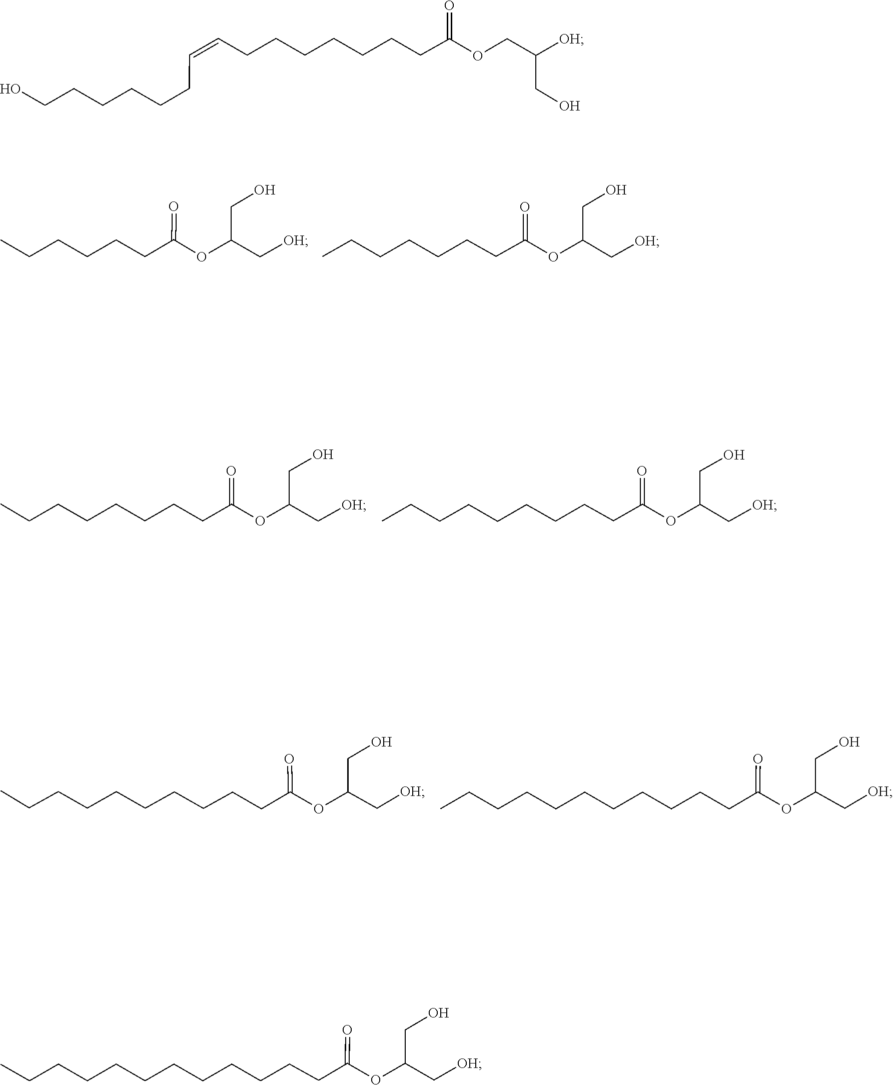

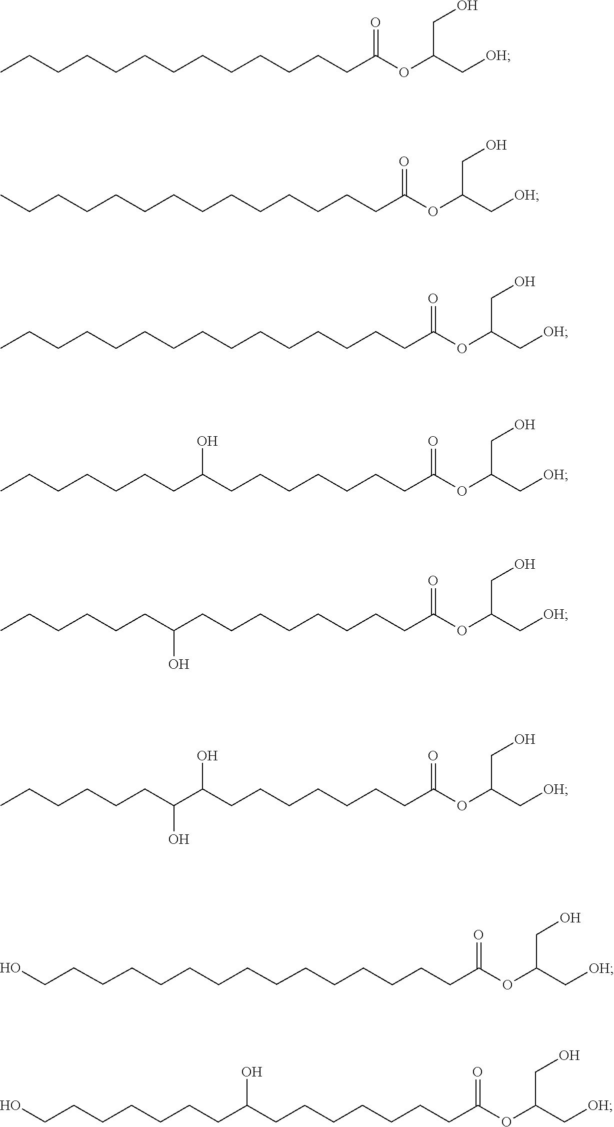

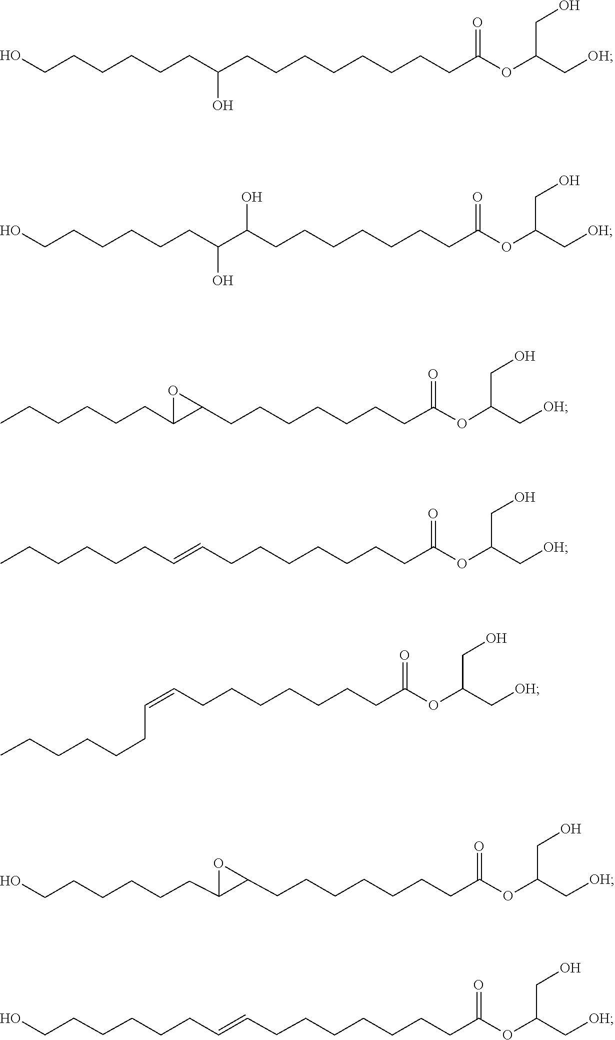

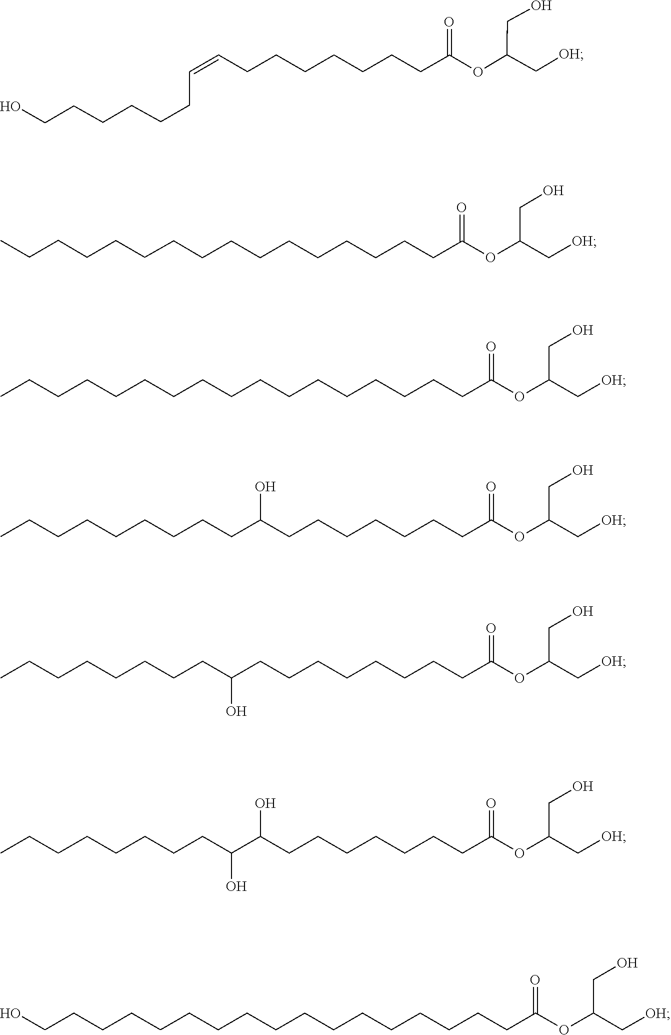

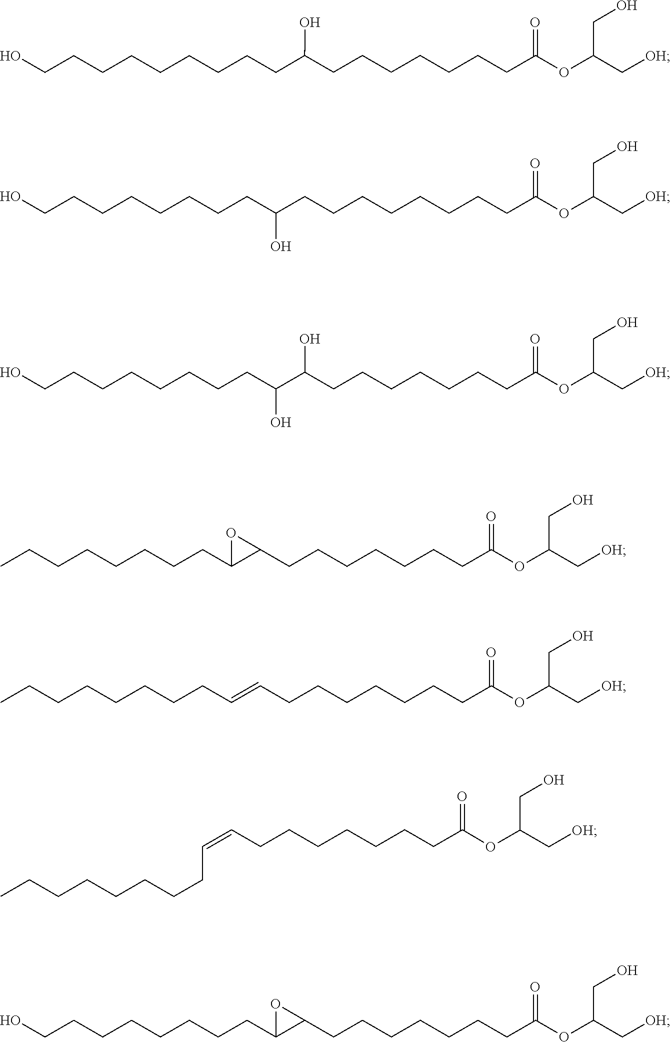

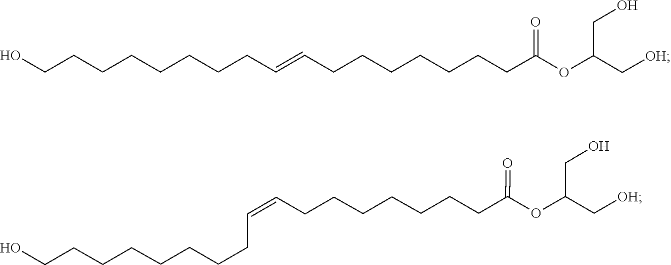 [SMILES: O=C(CCCCCCC/C=C/CCCCCCCCO)OC(CO)CO ; O=C(CCCCCCC/C=C\CCCCCCCCO)OC(CO)CO]

In some embodiments, the compound of Formula IIA is selected from the group consisting of:

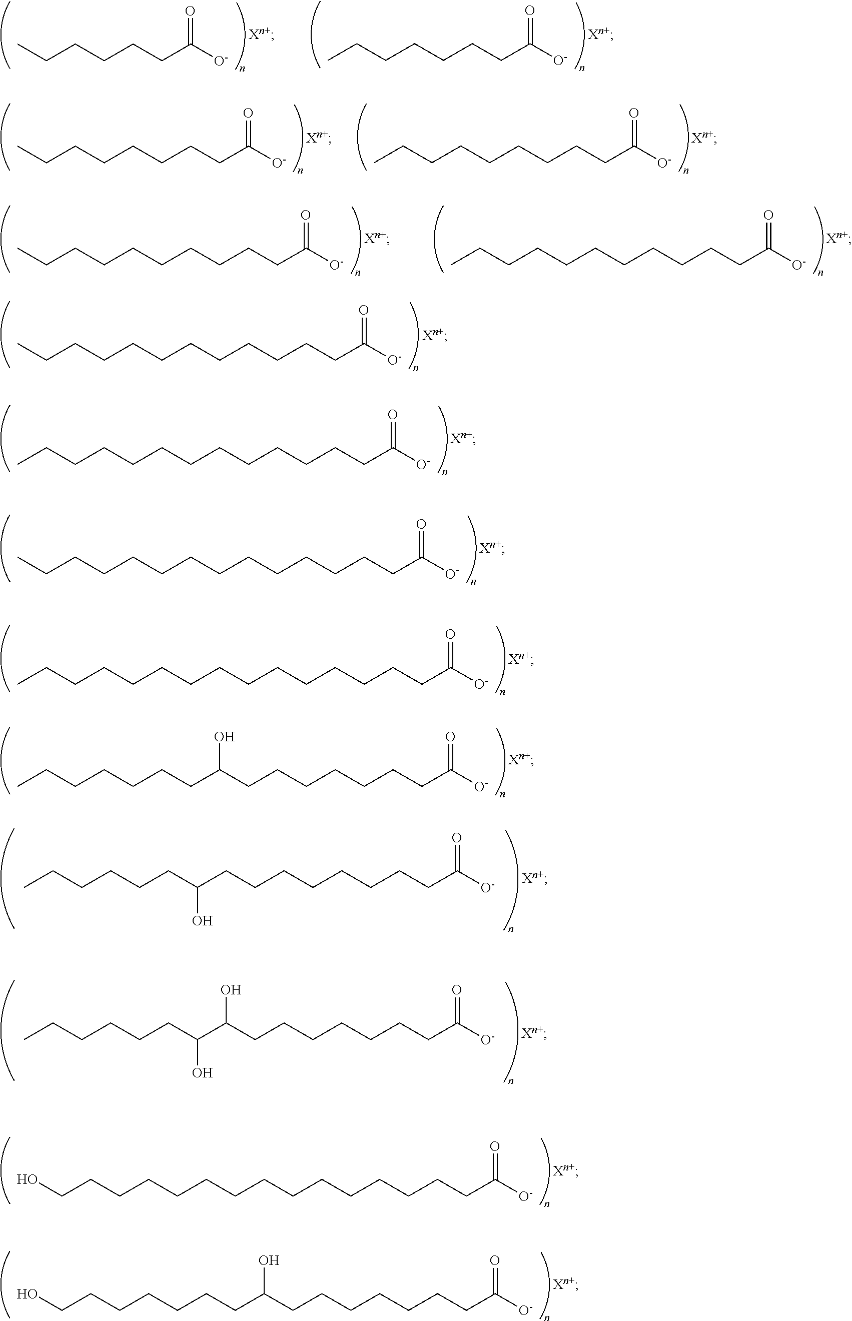

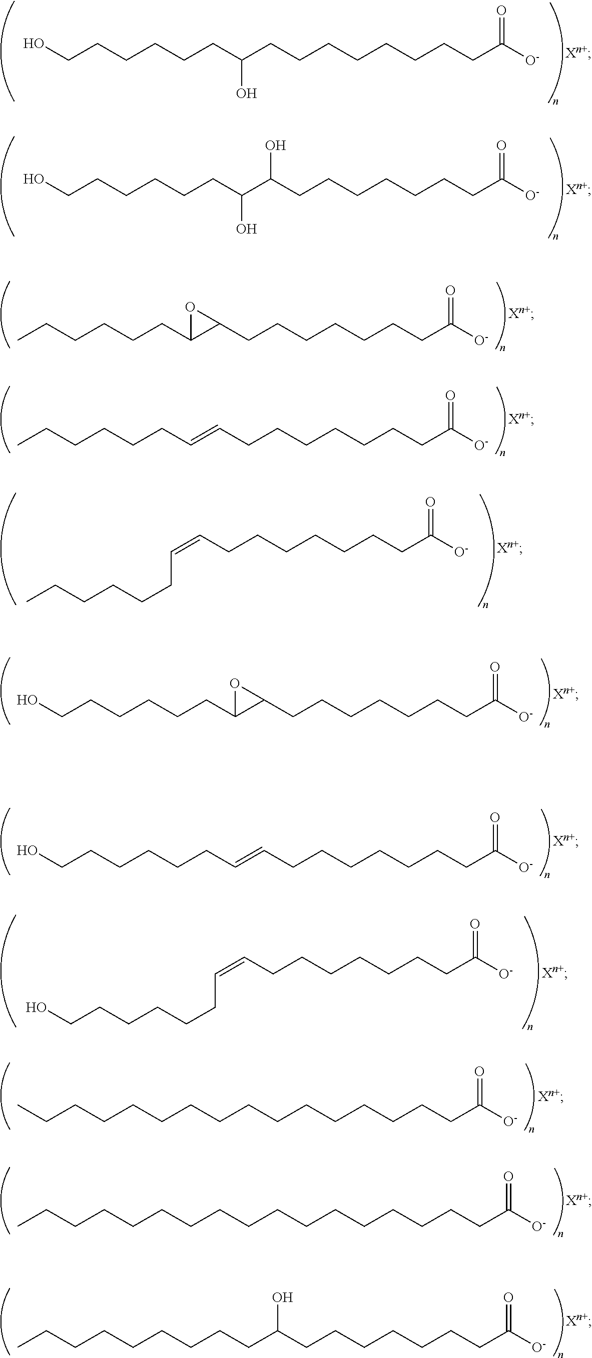

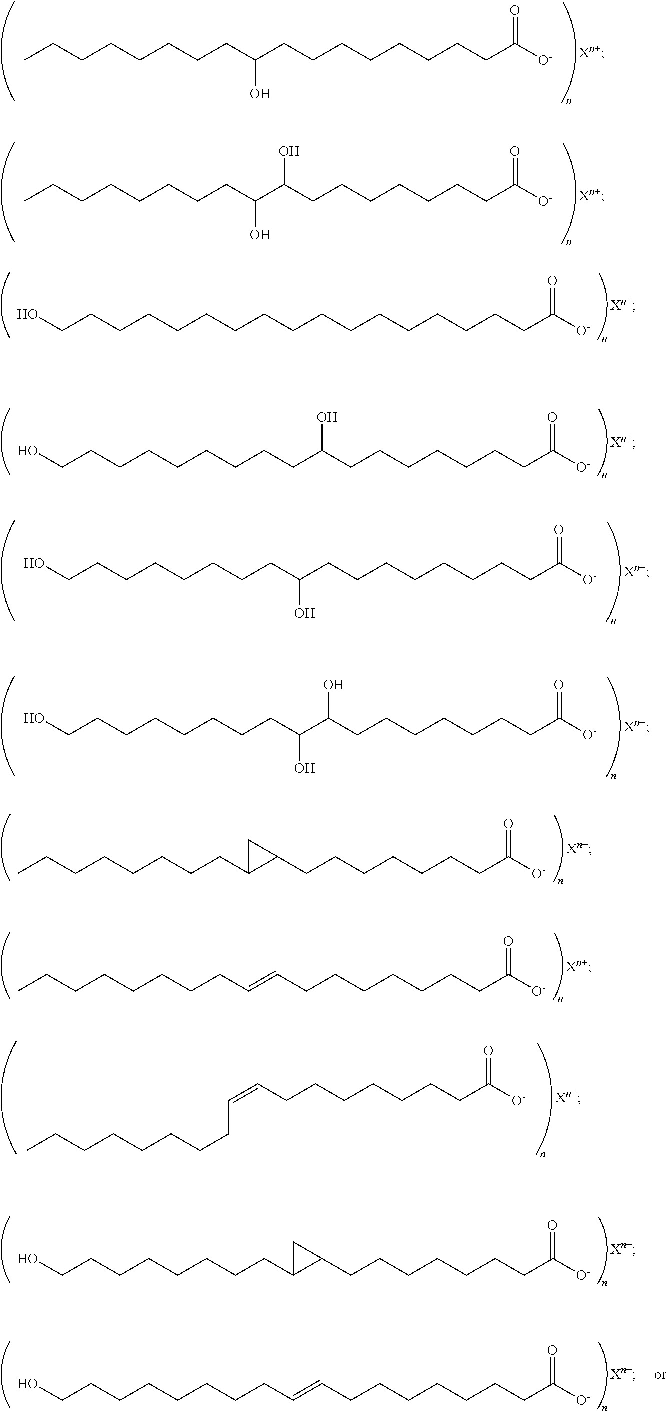

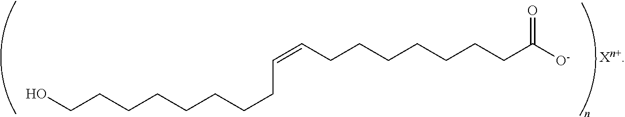

In some embodiments, the composition (e.g., coating or coating agent) comprises one or more (e.g., 1, 2, or 3) compounds of Formula IA. In some embodiments, the composition comprises one or more (e.g., 1, 2, or 3) compounds of Formula IA-A. In some embodiments, the composition comprises one or more (e.g., 1, 2, or 3) compounds of Formula IA-A-i. In some embodiments, the composition comprises one or more (e.g., 1, 2, or 3) compounds of Formula IA-A-ii. In some embodiments, the composition comprises one or more (e.g., 1, 2, or 3) compounds of Formula IA-B. In some embodiments, the composition comprises one or more (e.g., 1, 2, or 3) compounds of Formula IIA.

In some embodiments, each compound of Formula IA is a compound of Formula IA-A. In some embodiments, each compound of Formula IA-A is independently selected from a compound of Formula IA-A-i and a compound of Formula IA-A-ii. In some embodiments, each compound of Formula IA-A is a compound of Formula IA-A-i. In some embodiments, each compound of Formula IA-A is a compound of Formula IA-A-ii. In some embodiments, at least one (e.g., 1 or 2) compounds of Formula IA-A is a compound of Formula IA-A-i and at least one (e.g., 1 or 2) compounds of Formula IA-A is a compound of Formula IA-A-ii.

In some embodiments, the composition (e.g., coating or coating agent) comprises one compound of Formula IA-A and one compound of Formula IA-B. In some embodiments, the composition comprises one compound of Formula IA-A-i and one compound of Formula IA-B. In some embodiments, the composition comprises one compound of Formula IA-A-ii and one compound of Formula IA-B. In some embodiments, the composition comprises one compound of Formula IA-A-i, one compound of Formula IA-A-ii, and one compound of Formula IA-B.

In some embodiments, the composition (e.g., coating or coating agent) comprises one compound of Formula IA-A-i and one compound of Formula IA-A-ii. In some embodiments, the composition comprises two compounds of Formula IA-A-i. In some embodiments, the composition comprises two compounds of Formula IA-A-ii.

In some embodiments, the composition (e.g., coating or coating agent) comprises one or more (e.g., 1, 2, or 3) compounds of Formula IA and one or more (e.g., 1, 2, or 3) compounds of Formula IIA. In some embodiments, the composition comprises one compound of Formula IA and one compound of Formula IIA. In some embodiments, the composition comprises two compounds of Formula IA and one compound of Formula IIA. In some embodiments, the composition comprises one compound of Formula IA and two compounds of Formula IIA. In some embodiments, the composition comprises two compounds of Formula IA and two compounds of Formula IIA.

In some embodiments, the composition (e.g., coating or coating agent) comprises one or more (e.g., 1, 2, or 3) compounds of Formula IA-A and one or more (e.g., 1, 2, or 3) compounds of Formula IIA. In some embodiments, the composition comprises one compound of Formula IA-A and one compound of Formula IIA. In some embodiments, the composition comprises two compounds of Formula IA-A and one compound of Formula IIA. In some embodiments, the composition comprises one compound of Formula IA-A and two compounds of Formula IIA. In some embodiments, the composition comprises two compounds of Formula IA-A and two compounds of Formula IIA.

In some embodiments, the composition (e.g., coating or coating agent) comprises one or more (e.g., 1, 2, or 3) compounds of Formula IA-A-i and one or more (e.g., 1, 2, or 3) compounds of Formula IIA. In some embodiments, the composition comprises one compound of Formula IA-A-i and one compound of Formula IIA. In some embodiments, the composition comprises two compounds of Formula IA-A-i and one compound of Formula IIA. In some embodiments, the composition comprises one compound of Formula IA-A-i and two compounds of Formula IIA. In some embodiments, the composition comprises two compounds of Formula IA-A-i and two compounds of Formula IIA.

In some embodiments, the composition (e.g., coating or coating agent) comprises a first compound of Formula IA-A-i wherein the sum of o and p is from 9 to 17 (e.g., from 11 to 13 (e.g., 13)); a second compound of Formula IA-A-i wherein the sum of o and p is from 0 to 8 (e.g., from 5 to 7 (e.g., 7)); and one compound of Formula IIA. In some embodiments, the composition comprises a first compound of Formula IA-A-i wherein the sum of o and p is from 9 to 17 (e.g., from 11 to 13); a second compound of Formula IA-A-i wherein the sum of o and p is from 0 to 8 (e.g., from 5 to 7); and two compounds of Formula IIA.

In some embodiments, the composition (e.g., coating or coating agent) comprises a first compound of Formula IA-A-i wherein the sum of o and p is from 9 to 17 (e.g., from 11 to 13 (e.g., 13)); a second compound of Formula IA-A-i wherein the sum of o and p is from 9 to 17 (e.g., from 11 to 13 (e.g., 11)); and one compound of Formula IIA. In some embodiments, the composition comprises a first compound of Formula IA-A-i wherein the sum of o and p is from 9 to 17 (e.g., from 11 to 13); a second compound of Formula IA-A-i wherein the sum of o and p is from 9 to 17 (e.g., from 11 to 13); and two compounds of Formula IIA.

In some embodiments, the composition (e.g., coating or coating agent) comprises one or more (e.g., 1, 2, or 3) compounds of Formula IA-A-ii and one or more (e.g., 1, 2, or 3) compounds of Formula IIA. In some embodiments, the composition comprises one compound of Formula IA-A-ii and one compound of Formula IIA. In some embodiments, the composition comprises two compounds of Formula IA-A-ii and one compound of Formula IIA. In some embodiments, the composition comprises one compound of Formula IA-A-ii and two compounds of Formula IIA.

In some embodiments, the composition comprises two compounds of Formula IA-A-ii and two compounds of Formula IIA.

In some embodiments, the composition (e.g., coating or coating agent) comprises one or more (e.g., 1, 2, or 3) compounds of Formula IA-A-i, one or more (e.g., 1, 2, or 3) compounds of Formula IA-A-ii, and one or more (e.g., 1, 2, or 3) compounds of Formula IIA. In some embodiments, the composition comprises one compound of Formula IA-A-i, one compound of Formula IA-A-ii, and one compound of Formula IIA. In some embodiments, the composition comprises two compounds of Formula IA-A-i, one compound of Formula IA-A-ii, and one compound of Formula IIA. In some embodiments, the composition comprises one compound of Formula IA-A-i, two compounds of Formula IA-A-ii, and one compound of Formula IIA. In some embodiments, the composition comprises two compounds of Formula IA-A-i, two compounds of Formula IA-A-ii, and one compound of Formula IIA. In some embodiments, the composition comprises one compound of Formula IA-A-i, one compound of Formula IA-A-ii, and two compounds of Formula IIA. In some embodiments, the composition comprises two compounds of Formula IA-A-i, one compound of Formula IA-A-ii, and two compounds of Formula IIA. In some embodiments, the composition comprises one compound of Formula IA-A-i, two compounds of Formula IA-A-ii, and two compounds of Formula IIA. In some embodiments, the composition comprises two compounds of Formula IA-A-i, two compounds of Formula IA-A-ii, and two compounds of Formula IIA.

In some embodiments, when the composition (e.g., coating or coating agent) comprises two or more compounds of Formula IA, Formula IA-A, Formula IA-A-i, Formula IA-A-ii, Formula IA-B, and/or Formula IIA, the weight ratio of the two compounds is from about 1:1 to about 10:1. For example, from about 1:1 to about 8:1, from about 1:1 to about 6:1, from about 1:1 to about 4:1, from about 1:1 to about 3:1, from about 1:1 to about 2:1, from about 2:1 to about 4:1, from about 4:1 to about 6:1, from about 6:1 to about 8:1, from about 8:1 to about 10:1, about 1:1, about 1:2, about 1:4, about 1:6, about 1:8, or about 1:10.

In some embodiments, when the composition (e.g., coating or coating agent) comprises two or more compounds of Formula IA, Formula IA-A, Formula IA-A-i, Formula IA-A-ii, Formula IA-B, and/or Formula IIA, the sum of o and p of at least two compounds is different. In some embodiments, when the composition comprises two or more compounds of Formula IA, Formula IA-A, Formula IA-A-i, Formula IA-A-ii, Formula IA-B, and/or Formula IIA, the sum of o and p of at least two compounds is the same.

In some embodiments, the composition (e.g., coating or coating agent) comprises from about 40% to about 100% by weight of the one or more compounds of Formula IA, Formula IA-A, Formula IA-A-i, Formula IA-A-ii, and Formula IA-B. For example, the composition comprises from about 40% to about 45%, from about 45% to about 50%, from about 50% to about 55%, from about 55% to about 60%, from about 60% to about 65%, from about 65% to about 70%, from about 65% to about 99%, from about 70% to about 75%, from about 75% to about 80%, from about 80% to about 85%, from about 85% to about 90%, from about 90% to about 95%, from about 95% to about 100%, from about 40% to about 50%, from about 50% to about 60%, from about 60% to about 70%, from about 70% to about 80%, from about 80% to about 90%, from about 90% to about 100%, from about 40% to about 60%, from about 60% to about 80%, from about 80% to about 100%, from about 60% to about 100%, from about 70% to about 100%, from about 40% to about 99%, from about 60% to about 99%, from about 70% to about 99%, from about 80% to about 99%, from about 85% to about 99%, from about 90% to about 99%, from about 92% to about 98%, from about 92% to about 96%, from about 93% to about 95%, from about 62% to about 78%, from about 65% to about 75%, from about 67% to about 73%, from about 69% to about 71%, about 68%, about 69%, about 70%, about 71%, about 72%, about 92%, about 93%, about 94%, about 95%, about 96%, about 97%, about 98%, or about 99% by weight of the one or more compounds of Formula IA, Formula IA-A, Formula IA-A-i, Formula IA-A-ii, and Formula IA-B. For example, the composition comprises from about 60% to about 80%, about 70%, from about 85% to about 99%, about 95%, or about 96% by weight of the one or more compounds of Formula IA, Formula IA-A, Formula IA-A-i, Formula IA-A-ii, and Formula IA-B.

In some embodiments, when the composition (e.g., coating or coating agent) comprises two compounds of Formula IA, Formula IA-A, Formula IA-A-i, Formula IA-A-ii, and/or Formula IA-B (for example, two compounds of Formula IA-A-i, two compounds of Formula IA-A-ii, or one compound of Formula IA-A-i and one compound of Formula IA-A-ii), each compound is independently from about 0.1% to about 99% by weight of the composition. For example, one compound is from about 20% to about 70%, from about 60% to about 99%, from about 70% to about 99%, from about 80% to about 95%, 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, from about 20% to about 30%, from about 30% to about 40%, from about 40% to about 50%, from about 50% to about 60%, from about 60% to about 70%, from about 20% to about 40%, from about 40% to about 60%, from about 20% to about 50%, from about 25% to about 45%, from about 30% to about 40%, from about 32% to about 38%, from about 33% to about 63%, from about 38% to about 58%, from about 43% to about 53%, from about 45% to about 51%, from about 0.1% to about 5%, from about 0.1% to about 3%, from about 0.1 to about 34%, about 35%, about 36%, about 47%, about 48%, or about 49% by weight of the composition; and the other compound is from about 20% to about 70%, from about 60% to about 99%, from about 70% to about 99%, from about 80% to about 95%, 20% to about 25%, from about 25% to about 30%, from about 30% to about 35%, from about 35% to about 40%, from about 40% to about 45%, from about 45% to about 50%, from about 50% to about 55%, from about 55% to about 60%, from about 60% to about 65%, from about 65% to about 70%, from about 20% to about 30%, from about 30% to about 40%, from about 40% to about 50%, from about 50% to about 60%, from about 60% to about 70%, from about 20% to about 40%, from about 40% to about 60%, from about 20% to about 50%, from about 25% to about 45%, from about 30% to about 40%, from about 32% to about 38%, from about 33% to about 63%, from about 38% to about 58%, from about 43% to about 53%, from about 45% to about 51%, from about 0.1% to about 5%, from about 0.1% to about 3%, from about 0.1 to about 34%, about 35%, about 36%, about 47%, about 48%, or about 49% by weight of the composition.

In some embodiments, when the composition comprises two compounds of Formula IA, Formula IA-A, Formula IA-A-i, Formula IA-A-ii, and/or Formula IA-B (for example, two compounds of Formula IA-A-i, two compounds of Formula IA-A-ii, or one compound of Formula IA-A-i and one compound of Formula IA-A-ii), the molar ratio or weight ratio of the two compounds is from about 350:1 to about 1:10. For example, from about 330:1 to about 50:1, from about 50:1 to about 10:1, from about 10:1 to about 1:1, from about 1:1 to about 8:1, from about 1:1 to about 6:1, from about 1:1 to about 4:1, from about 1:1 to about 3:1, from about 1:1 to about 2:1, from about 2:1 to about 4:1, from about 4:1 to about 6:1, from about 6:1 to about 8:1, from about 8:1 to about 10:1, from about 10:1 to about 2:1, from about 3:1 to about 1:3, about 316:1, about 200:1, about 189:1, about 77:1, about 31:1, about 15:1, about 13:1, about 6:1, about 5:1, about 1:2, about 1:4, about 1:6, about 1:8, or about 1:10, or about 1:1. For example, about 1:1.

In some embodiments, the composition (e.g., coating or coating agent) comprises from about 1% to about 50% by weight of the one or more compounds of Formula IIA. For example, the composition comprises from about 1% to about 10%, from about 10% to about 20%, from about 20% to about 30%, from about 30% to about 40%, from about 40% to about 50%, from about 1% to about 40%, from about 1% to about 30%, from about 1% to about 35%, from about 1% to about 20%, from about 10% to about 50%, from about 20% to about 40%, from about 15% to about 45%, from about 25% to about 35%, from about 28% to about 32%, from about 1% to about 10%, from about 2% to about 10%, from about 3% to about 9%, from about 4% to about 8%, from about 4% to about 6%, about 3%, about 4%, about 5%, about 6%, about 7%, about 8%, about 29%, about 30%, or about 31% by weight of the one or more compounds of Formula IIA. In some embodiments, when the composition comprises two compounds of Formula IIA, the molar ratio or weight ratio of the two compounds is from about 1:20 to about 20:1. For example, from about 1:10 to about 10:1, from about 1:10 to about 2:1, from about 1:4 to about 1:2, from about 1:3 to about 3:1, from about 1:2 to about 2:1, or about 1:1. For example, about 1:1.

In some embodiments, when the composition (e.g., coating or coating agent) comprises two compounds of Formula IIA, each compound is independently from about 1% to about 49% by weight of the composition. For example, one compound is from about 1% to about 7%, from about 10% to about 20%, from about 20% to about 30%, from about 30% to about 40%, from about 40% to about 49%, from about 1% to about 15%, from about 1% to about 10%, from about 1% to about 20%, from about 10% to about 49%, from about 20% to about 40%, from about 7% to about 25%, from about 12% to about 18%, from about 13% to about 17%, from about 1% to about 10%, from about 2% to about 5%, from about 3% to about 4%, about 1%, about 2%, about 3%, about 4%, about 5%, about 6%, about 7%, about 8%, about 9%, about 10%, about 11%, about 12%, about 13%, about 14%, about 15%, about 16%, or about 17% by weight of the composition; and the other compound is from about 1% to about 7%, from about 10% to about 20%, from about 20% to about 30%, from about 30% to about 40%, from about 40% to about 49%, from about 1% to about 15%, from about 1% to about 10%, from about 1% to about 20%, from about 10% to about 49%, from about 20% to about 40%, from about 7% to about 25%, from about 12% to about 18%, from about 13% to about 17%, from about 1% to about 10%, from about 2% to about 5%, from about 3% to about 4%, about 1%, about 2%, about 3%, about 4%, about 5%, about 6%, about 7%, about 8%, about 9%, about 10%, about 11%, about 12%, about 13%, about 14%, about 15%, about 16%, or about 17% by weight of the composition.

In some embodiments, when the composition (e.g., coating or coating agent) comprises a compound of Formula IA-A-i and a compound of Formula IA-A-ii, the weight or molar ratio of the compound of Formula IA-A-i to the compound of Formula IA-A-ii is from about 1:10 to about 10:1. For example, from about 1:10 to about 2:1, from about 1:8 to about 2:1, from about 1:4 to about 2:1, from about 1:3 to about 2:1, from about 1:2 to about 2:1, from about 1:10 to about 1:1, from about 1:8 to about 1:1, from about 4:1 to about 1:1, from about 3:1 to about 1:1, from about 2:1 to about 1:1, about 3:1, about 2:1, or about 1:1. In some embodiments, the weight or molar ratio of the compound of Formula IA-A-ii to the compound of Formula IA-A-i is from about 1:10 to about 10:1. For example, from about 1:10 to about 2:1, from about 1:8 to about 2:1, from about 1:4 to about 2:1, from about 1:3 to about 2:1, from about 1:2 to about 2:1, from about 1:10 to about 1:1, from about 1:8 to about 1:1, from about 4:1 to about 1:1, from about 3:1 to about 1:1, from about 2:1 to about 1:1, about 3:1, about 2:1, or about 1:1.

In some embodiments, when the composition (e.g., coating or coating agent) comprises two compounds of Formula IA-A-i, the weight or molar ratio of one of the compounds of Formula IA-A-i to the other of the compounds of Formula IA-A-i is from about 1:10 to about 10:1. For example, from about 1:10 to about 2:1, from about 1:8 to about 2:1, from about 1:4 to about 2:1, from about 1:3 to about 2:1, from about 1:2 to about 2:1, from about 1:10 to about 1:1, from about 1:8 to about 1:1, from about 4:1 to about 1:1, from about 3:1 to about 1:1, from about 2:1 to about 1:1, about 3:1, about 2:1, or about 1:1. For example, about 1:1.

In some embodiments, when the composition (e.g., coating or coating agent) comprises two compounds of Formula IA-A-ii, the weight or molar ratio of one of the compounds of Formula IA-A-ii to the other of the compounds of Formula IA-A-ii is from about 1:10 to about 10:1. For example, from about 1:10 to about 2:1, from about 1:8 to about 2:1, from about 1:4 to about 2:1, from about 1:3 to about 2:1, from about 1:2 to about 2:1, from about 1:10 to about 1:1, from about 1:8 to about 1:1, from about 4:1 to about 1:1, from about 3:1 to about 1:1, from about 2:1 to about 1:1, about 3:1, about 2:1, or about 1:1.

In some embodiments, the composition (e.g., coating or coating agent) comprises a compound of Formula IA-A-i and a compound of Formula IIA. In some embodiments, the weight or molar ratio of the compound of Formula IA-A-i to the compound of Formula IIA is from about 30:1 to about 1:1. For example, from about 25:1 to about 2:1, from about 20:1 to about 2:1, from about 10:1 to about 3:1, from about 7:1 to about 3:1, from about 5:1 to about 2:1, from about 4:1 to about 2:1, from about 25:1 to about 15:1, from about 22:1 to about 18:1, from about 88:12 to about 99:1, from about 90:10 to about 97:3, from about 92:8 to about 96:4, from about 93:7 to about 95:5, about 20:1, about 4:1, about 94:6, or about 70:30. In some embodiments, the composition comprises about 40% to about 100% by weight of the compound of Formula IA-A-i. For example, the composition comprises from about 40% to about 45%, from about 45% to about 50%, from about 50% to about 55%, from about 55% to about 60%, from about 60% to about 65%, from about 65% to about 70%, from about 65% to about 99%, from about 70% to about 75%, from about 75% to about 80%, from about 80% to about 85%, from about 85% to about 90%, from about 90% to about 95%, from about 95% to about 100%, from about 40% to about 50%, from about 50% to about 60%, from about 60% to about 70%, from about 70% to about 80%, from about 80% to about 90%, from about 90% to about 100%, from about 40% to about 60%, from about 60% to about 80%, from about 80% to about 100%, from about 60% to about 100%, from about 70% to about 100%, from about 40% to about 99%, from about 60% to about 99%, from about 70% to about 99%, from about 70% to about 94%, from about 80% to about 99%, from about 85% to about 99%, from about 90% to about 99%, from about 92% to about 98%, from about 92% to about 96%, from about 93% to about 95%, from about 62% to about 78%, from about 65% to about 75%, from about 67% to about 73%, from about 69% to about 71%, about 68%, about 69%, about 70%, about 71%, about 72%, about 75%, about 80%, about 85%, about 90%, about 92%, about 93%, about 94%, about 95%, about 96%, about 97%, about 98%, or about 99% by weight of the compound of Formula IA-A-i. For example, the composition comprises from about 60% to about 80%, about 70%, from about 85% to about 99%, about 95%, or about 96% by weight of the compound of Formula IA-A-i. In some embodiments, the composition comprises about 1% to about 50% by weight of the compound of Formula IIA. For example, the composition comprises from about 1% to about 10%, from about 10% to about 20%, from about 20% to about 30%, from about 30% to about 40%, from about 40% to about 50%, from about 1% to about 40%, from about 1% to about 35%, from about 1% to about 30%, from about 1% to about 20%, from about 10% to about 50%, from about 20% to about 40%, from about 15% to about 45%, from about 10% to about 20%, from about 20% to about 30%, from about 25% to about 35%, from about 28% to about 32%, from about 6% to about 30%, from about 1% to about 10%, from about 2% to about 10%, from about 3% to about 9%, from about 4% to about 8%, from about 4% to about 6%, about 3%, about 4%, about 5%, about 6%, about 7%, about 8%, about 10%, about 15%, about 20%, about 25%, about 29%, about 30%, or about 31% by weight of the compound of Formula IIA.

In some embodiments, in the compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IA-A-i is 2,3-dihydroxypropan-1-yl octadecanoate. In some embodiments, in the compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IIA is sodium stearate.

In some embodiments, the composition comprises about 70% 2,3-dihydroxypropan-1-yl octadecanoate and about 30% sodium stearate. In some embodiments, the composition comprises about 94% 2,3-dihydroxypropan-1-yl octadecanoate and about 6% sodium stearate. In some embodiments, the composition comprises 2,3-dihydroxypropan-1-yl octadecanoate and sodium stearate in a weight ratio of about 70:30 or about 94:6. In some embodiments, the composition further comprises citric acid, sodium bicarbonate, or both. In some embodiments, the composition comprises citric acid and sodium bicarbonate. In some embodiments, the molar ratio of the citric acid to sodium bicarbonate is from about 1:5 to about 1:1, for example, about 1:3 to about 1:1, about 1:3 to about 1:2, about 1:3, about 1:2, or about 1:1. In some embodiments, the weight percentage of citric acid in the composition is from about 0.2% to about 2%, for example, about 0.25% to about 1.5%, about 0.25%, about 0.5%, about 1%, or about 1.5%. In some embodiments, the weight percentage of sodium bicarbonate in the composition is from about 0.2% to about 2%, for example, about 0.25% to about 1.5%, about 0.25%, about 0.5%, about 1%, or about 1.5%. In some embodiments, the collective weight percentage of citric acid and sodium bicarbonate in the composition is from about 0.2% to about 2%, for example, about 0.25% to about 1.5%, about 0.25%, about 0.5%, about 1%, or about 1.5%.

In some embodiments, the composition (e.g., coating or coating agent) comprises a compound of Formula IA-A-i and two compounds of Formula IIA. In some embodiments, the weight or molar ratio of the compound of Formula IA-A-i to both compounds of Formula IIA is from about 30:1 to about 1:1. For example, from about 25:1 to about 2:1, from about 20:1 to about 2:1, from about 10:1 to about 3:1, from about 7:1 to about 3:1, from about 5:1 to about 2:1, from about 4:1 to about 2:1, from about 25:1 to about 15:1, from about 22:1 to about 18:1, from about 88:12 to about 99:1, from about 90:10 to about 97:3, from about 92:8 to about 96:4, from about 93:7 to about 95:5, about 20:1, about 4:1, about 94:6, or about 70:30. In some embodiments, the weight or molar ratio of one compound of Formula IIA to the other compound of Formula IIA is from about 1:20 to about 20:1. For example, from about 1:10 to about 10:1, from about 1:10 to about 2:1, from about 1:4 to about 1:2, from about 1:3 to about 3:1, from about 1:2 to about 2:1, or about 1:1. For example, about 1:1. In some embodiments, the composition comprises about 40% to about 100% by weight of the compound of Formula IA-A-i. For example, the composition comprises from about 40% to about 45%, from about 45% to about 50%, from about 50% to about 55%, from about 55% to about 60%, from about 60% to about 65%, from about 65% to about 70%, from about 65% to about 99%, from about 70% to about 75%, from about 75% to about 80%, from about 80% to about 85%, from about 85% to about 90%, from about 90% to about 95%, from about 95% to about 100%, from about 40% to about 50%, from about 50% to about 60%, from about 60% to about 70%, from about 70% to about 80%, from about 80% to about 90%, from about 90% to about 100%, from about 40% to about 60%, from about 60% to about 80%, from about 80% to about 100%, from about 60% to about 100%, from about 70% to about 100%, from about 40% to about 99%, from about 60% to about 99%, from about 70% to about 99%, from about 70% to about 94%, from about 80% to about 99%, from about 85% to about 99%, from about 90% to about 99%, from about 92% to about 98%, from about 92% to about 96%, from about 93% to about 95%, from about 62% to about 78%, from about 65% to about 75%, from about 67% to about 73%, from about 69% to about 71%, about 68%, about 69%, about 70%, about 71%, about 72%, about 75%, about 80%, about 85%, about 90%, about 92%, about 93%, about 94%, about 95%, about 96%, about 97%, about 98%, or about 99% by weight of the compound of Formula IA-A-i. For example, the composition comprises from about 60% to about 80%, about 70%, from about 85% to about 99%, about 95%, or about 96% by weight of the compound of Formula IA-A-i. In some embodiments, the composition comprises about 1% to about 50% by weight of both compounds of Formula IIA. For example, the composition comprises from about 1% to about 10%, from about 10% to about 20%, from about 20% to about 30%, from about 30% to about 40%, from about 40% to about 50%, from about 1% to about 40%, from about 1% to about 35%, from about 1% to about 30%, from about 1% to about 20%, from about 10% to about 50%, from about 20% to about 40%, from about 15% to about 45%, from about 10% to about 20%, from about 20% to about 30%, from about 25% to about 35%, from about 28% to about 32%, from about 6% to about 30%, from about 1% to about 10%, from about 2% to about 10%, from about 3% to about 9%, from about 4% to about 8%, from about 4% to about 6%, about 3%, about 4%, about 5%, about 6%, about 7%, about 8%, about 10%, about 15%, about 20%, about 25%, about 29%, about 30%, or about 31% by weight of both compounds of Formula IIA.

In some embodiments, in the compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IA-A-i is 2,3-dihydroxypropan-1-yl octadecanoate. In some embodiments, in each compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. In some embodiments, the sum of o and p in one compound of Formula IIA is 13 and the sum of o and p in the other compound of Formula IIA is 11. For example, one compound of Formula IIA is sodium stearate and the other compound of Formula IIA is sodium palmitate. In some embodiments, the composition comprises about 70% 2,3-dihydroxypropan-1-yl octadecanoate and about 30% of sodium stearate and sodium palmitate in a 1:1 weight ratio. In some embodiments, the composition comprises about 94% 2,3-dihydroxypropan-1-yl octadecanoate and about 6% sodium stearate and sodium palmitate in a 1:1 weight ratio. In some embodiments, the composition comprises 2,3-dihydroxypropan-1-yl octadecanoate, sodium stearate, and sodium palmitate in a weight ratio of about 70:15:15 or about 94:3:3. In some embodiments, the composition further comprises citric acid, sodium bicarbonate, or both. In some embodiments, the molar ratio of the citric acid to sodium bicarbonate is from about 1:5 to about 1:1, for example, about 1:3 to about 1:1, about 1:3 to about 1:2, about 1:3, about 1:2, or about 1:1. In some embodiments, the weight percentage of citric acid in the composition is from about 0.2% to about 2%, for example, about 0.25% to about 1.5%, about 0.25%, about 0.5%, about 1%, or about 1.5%. In some embodiments, the weight percentage of sodium bicarbonate in the composition is from about 0.2% to about 2%, for example, about 0.25% to about 1.5%, about 0.25%, about 0.5%, about 1%, or about 1.5%. In some embodiments, the collective weight percentage of citric acid and sodium bicarbonate in the composition is from about 0.2% to about 2%, for example, about 0.25% to about 1.5%, about 0.25%, about 0.5%, about 1%, or about 1.5%.

In some embodiments, the composition (e.g., coating or coating agent) comprises a first compound of Formula IA-A-i, a second compound of Formula IA-A-i, and one compound of Formula IIA. In some embodiments, the weight or molar ratio of the compound of both compounds of Formula IA-A-i to the compound of Formula IIA is from about 30:1 to about 1:1. For example, from about 25:1 to about 2:1, from about 20:1 to about 2:1, from about 10:1 to about 3:1, from about 7:1 to about 3:1, from about 5:1 to about 2:1, from about 4:1 to about 2:1, from about 25:1 to about 15:1, from about 22:1 to about 18:1, from about 88:12 to about 99:1, from about 90:10 to about 97:3, from about 92:8 to about 96:4, from about 93:7 to about 95:5, about 20:1, about 4:1, about 94:6, or about 70:30. In some embodiments, the weight or molar ratio of one compound of Formula IA-A-i to the other compound of Formula IA-A-i is from about 1:20 to about 20:1. For example, from about 1:10 to about 10:1, from about 1:10 to about 2:1, from about 1:1 to about 8:1, from about 1:1 to about 6:1, from about 1:1 to about 4:1, from about 1:1 to about 3:1, from about 1:1 to about 2:1, from about 2:1 to about 4:1, from about 4:1 to about 6:1, from about 6:1 to about 8:1, from about 8:1 to about 10:1, from about 1:4 to about 1:2, from about 1:3 to about 3:1, from about 1:2 to about 2:1, about 1:1, about 1:2, about 1:4, about 1:6, about 1:8, or about 1:10, or about 1:1. For example, about 1:1.

In some embodiments, the composition comprises about 40% to about 100% by weight of both compounds of Formula IA-A-i. For example, the composition comprises from about 40% to about 45%, from about 45% to about 50%, from about 50% to about 55%, from about 55% to about 60%, from about 60% to about 65%, from about 65% to about 70%, from about 65% to about 99%, from about 70% to about 75%, from about 75% to about 80%, from about 80% to about 85%, from about 85% to about 90%, from about 90% to about 95%, from about 95% to about 100%, from about 40% to about 50%, from about 50% to about 60%, from about 60% to about 70%, from about 70% to about 80%, from about 80% to about 90%, from about 90% to about 100%, from about 40% to about 60%, from about 60% to about 80%, from about 80% to about 100%, from about 60% to about 100%, from about 70% to about 100%, from about 40% to about 99%, from about 60% to about 99%, from about 70% to about 99%, from about 70% to about 94%, from about 80% to about 99%, from about 85% to about 99%, from about 90% to about 99%, from about 92% to about 98%, from about 92% to about 96%, from about 93% to about 95%, from about 62% to about 78%, from about 65% to about 75%, from about 67% to about 73%, from about 69% to about 71%, about 68%, about 69%, about 70%, about 71%, about 72%, about 75%, about 80%, about 85%, about 90%, about 92%, about 93%, about 94%, about 95%, about 96%, about 97%, about 98%, or about 99% by weight of both compounds of Formula IA-A-i. For example, the composition comprises from about 60% to about 80%, about 70%, from about 85% to about 99%, about 95%, or about 96% by weight of both compounds of Formula IA-A-i. In some embodiments, the composition comprises about 1% to about 50% by weight of the compound of Formula IIA. For example, the composition comprises from about 1% to about 10%, from about 10% to about 20%, from about 20% to about 30%, from about 30% to about 40%, from about 40% to about 50%, from about 1% to about 40%, from about 1% to about 35%, from about 1% to about 30%, from about 1% to about 20%, from about 10% to about 50%, from about 20% to about 40%, from about 15% to about 45%, from about 10% to about 20%, from about 20% to about 30%, from about 25% to about 35%, from about 28% to about 32%, from about 6% to about 30%, from about 1% to about 10%, from about 2% to about 10%, from about 3% to about 9%, from about 4% to about 8%, from about 4% to about 6%, about 3%, about 4%, about 5%, about 6%, about 7%, about 8%, about 10%, about 15%, about 20%, about 25%, about 29%, about 30%, or about 31% by weight of the compound of Formula IIA.

In some embodiments, the weight or molar ratio of the first compound of Formula IA-A-i to the second compound of Formula IA-A-i to the compound of Formula IIA is about 47:47:6 or about 35:35:30. In some embodiments, the weight or molar ratio of the first compound of Formula IA-A-i to the second compound of Formula IA-A-i to the compound of Formula IIA is about 190:1:10, about 316:1:17, about 20:4:1, about 78:1:5, about 13:1:1, about 31:1:2, about 20:4:1, about 20:3:1, or about 18:1:1. In some embodiments, the composition comprises from about 25% to about 75% (e.g., from about 35% to about 65%, from about 40% to about 60%, from about 25% to about 45%, from about 30% to about 40%, from about 32% to about 38%, from about 42% to about 55%, about 34%, about 35%, about 36%, about 45%, about 46%, about 47%, about 48%, about 49% or about 50%) of the first compound of Formula IA-A-i, from about 25% to about 75% (e.g., from about 35% to about 65%, from about 40% to about 60%, from about 25% to about 45%, from about 30% to about 40%, from about 32% to about 38%, from about 42% to about 55%, about 34%, about 35%, about 36%, about 45%, about 46%, about 47%, about 48%, about 49% or about 50%) of the second compound of Formula IA-A-i, and from about 1% to about 40% (e.g., from about 10% to about 40%, from about 20% to about 40%, from about 25% to about 35%, from about 27% to about 33%, from about 1% to about 10%, from about 3% to about 8%, about 29%, about 30%, about 31%, about 6%, about 5%, or about 4%) of the compound of Formula IIA. In some embodiments, the composition comprises from about 75% to about 99% (e.g., from about 78% to about 96%, from about 85% to about 96%, about 81%, about 87%, about 89%, about 92%, about 93%, about 94%, or about 95%) of the first compound of Formula IA-A-i, from about 0.1% to about 20% (e.g., from about 0.1% to about 5%, from about 0.1% to about 10%, from about 3% to about 20%, from about 5% to about 15%, from about 10% to about 20%, about 0.3%, about 0.5%, about 1%, about 3%, about 6%, about 7%, about 14%, or about 17%) of the second compound of Formula IA-A-i, and about 1% to about 10% (e.g., from about 3% to about 8%, about 4%, about 5%, or about 6%) of the compound of Formula IIA.

In some embodiments, in one compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. In some embodiments, in the other compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 7 to 9. For example, one compound of Formula IA-A-i is 2,3-dihydroxypropan-1-yl octadecanoate and the other compound of Formula IA-A-i is 2,3-dihydroxypropan-1-yl dodecanoate. In some embodiments, in the compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, the compound of Formula IIA is sodium stearate. In some embodiments, the composition comprises about 70% 2,3-dihydroxypropan-1-yl octadecanoate and 2,3-dihydroxypropan-1-yl dodecanoate in a 1:1 weight ratio and about 30% of sodium stearate. In some embodiments, the composition comprises about 94% 2,3-dihydroxypropan-1-yl octadecanoate and 2,3-dihydroxypropan-1-yl dodecanoate in a 1:1 weight ratio and about 6% sodium stearate. In some embodiments, the composition comprises 2,3-dihydroxypropan-1-yl octadecanoate, 2,3-dihydroxypropan-1-yl dodecanoate, and sodium stearate in a weight ratio of about 35:35:30 or about 47:47:6. In some embodiments, the composition further comprises citric acid, sodium bicarbonate, or both. In some embodiments, the molar ratio of the citric acid to sodium bicarbonate is from about 1:5 to about 1:1, for example, about 1:3 to about 1:1, about 1:3 to about 1:2, about 1:3, about 1:2, or about 1:1. In some embodiments, the weight percentage of citric acid in the composition is from about 0.2% to about 2%, for example, about 0.25% to about 1.5%, about 0.25%, about 0.5%, about 1%, or about 1.5%. In some embodiments, the weight percentage of sodium bicarbonate in the composition is from about 0.2% to about 2%, for example, about 0.25% to about 1.5%, about 0.25%, about 0.5%, about 1%, or about 1.5%. In some embodiments, the collective weight percentage of citric acid and sodium bicarbonate in the composition is from about 0.2% to about 2%, for example, about 0.25% to about 1.5%, about 0.25%, about 0.5%, about 1%, or about 1.5%.

In some embodiments, the composition (e.g., coating or coating agent) comprises a first compound of Formula IA-A-i, a second compound of Formula IA-A-i, a first compound of Formula IIA, and a second compound of Formula IIA. In some embodiments, the weight or molar ratio of the compound of both compounds of Formula IA-A-i to both compounds of Formula IIA is from about 30:1 to about 1:1. For example, from about 25:1 to about 2:1, from about 20:1 to about 2:1, from about 10:1 to about 3:1, from about 7:1 to about 3:1, from about 5:1 to about 2:1, from about 4:1 to about 2:1, from about 25:1 to about 15:1, from about 22:1 to about 18:1, from about 88:12 to about 99:1, from about 90:10 to about 97:3, from about 92:8 to about 96:4, from about 93:7 to about 95:5, about 20:1, about 4:1, about 94:6, or about 70:30. In some embodiments, the weight or molar ratio of one compound of Formula IA-A-i to the other compound of Formula IA-A-i is from about 1:20 to about 20:1. For example, from about 1:10 to about 10:1, from about 1:10 to about 2:1, from about 1:1 to about 8:1, from about 1:1 to about 6:1, from about 1:1 to about 4:1, from about 1:1 to about 3:1, from about 1:1 to about 2:1, from about 2:1 to about 4:1, from about 4:1 to about 6:1, from about 6:1 to about 8:1, from about 8:1 to about 10:1, from about 1:4 to about 1:2, from about 1:3 to about 3:1, from about 1:2 to about 2:1, about 1:1, about 1:2, about 1:4, about 1:6, about 1:8, or about 1:10, or about 1:1. For example, about 1:1. In some embodiments, the weight or molar ratio of one compound of Formula IIA to the other compound of Formula IIA is from about 1:20 to about 20:1. For example, from about 1:10 to about 10:1, from about 1:10 to about 2:1, from about 1:4 to about 1:2, from about 1:3 to about 3:1, from about 1:2 to about 2:1, or about 1:1. For example, about 1:1.

In some embodiments, the composition comprises about 40% to about 100% by weight of both compounds of Formula IA-A-i. For example, the composition comprises from about 40% to about 45%, from about 45% to about 50%, from about 50% to about 55%, from about 55% to about 60%, from about 60% to about 65%, from about 65% to about 70%, from about 65% to about 99%, from about 70% to about 75%, from about 75% to about 80%, from about 80% to about 85%, from about 85% to about 90%, from about 90% to about 95%, from about 95% to about 100%, from about 40% to about 50%, from about 50% to about 60%, from about 60% to about 70%, from about 70% to about 80%, from about 80% to about 90%, from about 90% to about 100%, from about 40% to about 60%, from about 60% to about 80%, from about 80% to about 100%, from about 60% to about 100%, from about 70% to about 100%, from about 40% to about 99%, from about 60% to about 99%, from about 70% to about 99%, from about 70% to about 94%, from about 80% to about 99%, from about 85% to about 99%, from about 90% to about 99%, from about 92% to about 98%, from about 92% to about 96%, from about 93% to about 95%, from about 62% to about 78%, from about 65% to about 75%, from about 67% to about 73%, from about 69% to about 71%, about 68%, about 69%, about 70%, about 71%, about 72%, about 75%, about 80%, about 85%, about 90%, about 92%, about 93%, about 94%, about 95%, about 96%, about 97%, about 98%, or about 99% by weight of both compounds of Formula IA-A-i. For example, the composition comprises from about 60% to about 80%, about 70%, from about 85% to about 99%, about 95%, or about 96% by weight of both compounds of Formula IA-A-i. In some embodiments, the composition comprises about 1% to about 50% by weight of both compounds of Formula IIA. For example, the composition comprises from about 1% to about 10%, from about 10% to about 20%, from about 20% to about 30%, from about 30% to about 40%, from about 40% to about 50%, from about 1% to about 40%, from about 1% to about 35%, from about 1% to about 30%, from about 1% to about 20%, from about 10% to about 50%, from about 20% to about 40%, from about 15% to about 45%, from about 10% to about 20%, from about 20% to about 30%, from about 25% to about 35%, from about 28% to about 32%, from about 6% to about 30%, from about 1% to about 10%, from about 2% to about 10%, from about 3% to about 9%, from about 4% to about 8%, from about 4% to about 6%, about 3%, about 4%, about 5%, about 6%, about 7%, about 8%, about 10%, about 15%, about 20%, about 25%, about 29%, about 30%, or about 31% by weight of both compounds of Formula IIA. In some embodiments, the weight or molar ratio of the first compound of Formula IA-A-i to the second compound of Formula IA-A-i to the first compound of Formula IIA to the second compound of Formula IIA is about 47:47:3:3 or about 35:35:15:15. In some embodiments, the composition comprises from about 25% to about 75% (e.g., from about 35% to about 65%, from about 40% to about 60%, from about 25% to about 45%, from about 30% to about 40%, from about 32% to about 38%, from about 42% to about 55%, about 34%, about 35%, about 36%, about 45%, about 46%, about 47%, about 48%, about 49% or about 50%) of the first compound of Formula IA-A-i, from about 25% to about 75% (e.g., from about 35% to about 65%, from about 40% to about 60%, from about 25% to about 45%, from about 30% to about 40%, from about 32% to about 38%, from about 42% to about 55%, about 34%, about 35%, about 36%, about 45%, about 46%, about 47%, about 48%, about 49% or about 50%) of the second compound of Formula IA-A-i, from about 1% to about 30% (e.g., from about 10% to about 30%, from about 20% to about 30%, from about 10% to about 20%, from about 5% to about 20%, from about 12% to about 18%, about 14%, about 15%, or about 16%) of the first compound of Formula IIA, and from about 1% to about 30% (e.g., from about 10% to about 30%, from about 20% to about 30%, from about 10% to about 20%, from about 5% to about 20%, from about 12% to about 18%, about 14%, about 15%, or about 16%) of the second compound of Formula IIA.

In some embodiments, in each compound of Formula IA-A-i, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. For example, one compound of Formula IA-A-i is 2,3-dihydroxypropan-1-yl octadecanoate and the other compound of Formula IA-A-i is 2,3-dihydroxypropan-1-yl palmitate. In some embodiments, in each compound of Formula IIA, R^{A1} and R^{A2} are H; R¹, R², R³, R⁴, R⁵, R⁶, R⁷, R⁸, and R⁹ are independently selected from H and OH; each occurrence of R^{10A}, R^{10B}, R^{11A}, and R^{11B} is H; and the sum of o and p is from 11 to 13. In some embodiments, the sum of o and p in one compound of Formula IIA is 13 and the sum of o and p in the other compound of Formula IIA is 11. For example, one compound of Formula IIA is sodium stearate and the other compound of Formula IIA is sodium palmitate. In some embodiments, the composition comprises about 70% 2,3-dihydroxypropan-1-yl octadecanoate and 2,3-dihydroxypropan-1-yl palmitate in an about 1:1 weight ratio and about 30% of sodium stearate and sodium palmitate in an about 1:1 weight ratio. In some embodiments, the composition comprises about 94% 2,3-dihydroxypropan-1-yl octadecanoate and 2,3-dihydroxypropan-1-yl palmitate in an about 1:1 weight ratio and about 6% of sodium stearate and sodium palmitate in an about 1:1 weight ratio. In some embodiments, the composition comprises 2,3-dihydroxypropan-1-yl octadecanoate, 2,3-dihydroxypropan-1-yl palmitate, sodium stearate, and sodium palmitate in a weight ratio of about 35:35:15:15 or about 47:47:3:3. In some embodiments, the composition further comprises citric acid, sodium bicarbonate, or both. In some embodiments, the molar ratio of the citric acid to sodium bicarbonate is from about 1:5 to about 1:1, for example, about 1:3 to about 1:1, about 1:3 to about 1:2, about 1:3, about 1:2, or about 1:1.

In some embodiments, the weight percentage of citric acid in the composition is from about 0.2% to about 2%, for example, about 0.25% to about 1.5%, about 0.25%, about 0.5%, about 1%, or about 1.5%. In some embodiments, the weight percentage of sodium bicarbonate in the composition is from about 0.2% to about 2%, for example, about 0.25% to about 1.5%, about 0.25%, about 0.5%, about 1%, or about 1.5%. In some embodiments, the collective weight percentage of citric acid and sodium bicarbonate in the composition is from about 0.2% to about 2%, for example, about 0.25% to about 1.5%, about 0.25%, about 0.5%, about 1%, or about 1.5%.

In some embodiments, less than 10% (e.g., less than 5%, less than 2%, less than 1%) by weight of the composition is diglycerides. In some embodiments, less than 10% (e.g., less than 5%, less than 2%, less than 1%) by weight of the composition is triglycerides. In some embodiments, the composition does not comprise an acetylated monoglyceride (e.g., a monoglyceride wherein the hydroxyl groups of the glyceryl moiety are acetylated).

In some embodiments, the composition (e.g., coating agent) can be dissolved, mixed, dispersed, or suspended in a solvent to form a mixture (e.g., solution, suspension, or colloid). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. For example, the solvent is water. For example, the solvent is ethanol.

The concentration of the composition (e.g., coating agent) in the solution or mixture (e.g., solution, suspension, or colloid) is from about 1 mg/mL to about 200 mg/mL. For example, from about 1 to about 150 mg/mL, 1 to 100 mg/mL, from about 1 to about 90 mg/mL, from about 1 to about 80 mg/mL, from about 1 to about 75 mg/mL, from about 1 to about 70 mg/mL, from about 1 to about 65 mg/mL, from about 1 to about 60 mg/mL, from about 1 to about 55 mg/mL, from about 1 to about 50 mg/mL, from about 1 to about 45 mg/mL, from about 1 to about 40 mg/mL, from about 2 to about 200 mg/mL, from about 2 to about 150 mg/mL, from about 2 to about 100 mg/mL, from about 2 to about 90 mg/mL, from about 2 to about 80 mg/mL, from about 2 to about 75 mg/mL, from about 2 to about 70 mg/mL, from about 2 to about 65 mg/mL, from about 2 to about 60 mg/mL, from about 2 to about 55 mg/mL, from about 2 to about 50 mg/mL, from about 2 to about 45 mg/mL, from about 2 to about 40 mg/mL, from about 5 to about 200 mg/mL, from about 5 to about 150 mg/mL, from about 5 to about 100 mg/mL, from about 5 to about 90 mg/mL, from about 5 to about 80 mg/mL, from about 5 to about 75 mg/mL, from about 5 to about 70 mg/mL, from about 5 to about 65 mg/mL, from about 5 to about 60 mg/mL, from about 5 to about 55 mg/mL, from about 5 to about 50 mg/mL, from about 5 to about 45 mg/mL, from about 5 to about 40 mg/mL, from about 10 to about 200 mg/mL, from about 10 to about 150 mg/mL, from about 10 to about 100 mg/mL, from about 10 to about 90 mg/mL, from about 10 to about 80 mg/mL, from about 10 to about 75 mg/mL, from about 10 to about 70 mg/mL, from about 10 to about 65 mg/mL, from about 10 to about 60 mg/mL, from about 10 to about 55 mg/mL, from about 10 to about 50 mg/mL, from about 10 to about 45 mg/mL, from about 10 to about 40 mg/mL, from about 20 to about 50 mg/mL, from about 20 to about 40 mg/mL, from about 25 to about 35 mg/mL, from about 30 to about 50 mg/mL, or from about 35 to about 45 mg/mL. For example, the concentration of the composition (e.g., coating agent) in the mixture (e.g., solution, suspension, or colloid) is about 30 mg/mL or about 40 mg/mL.

In order to improve the solubility of the coating agent in the solvent, or to allow the coating agent to be suspended or dispersed in the solvent, the coating agent can further include an emulsifier, as described below. When the coatings are to be formed over plants or other edible products, it may be preferable that the emulsifier be safe for consumption. Furthermore, it is also preferable that the emulsifier either not be incorporated into the coating or, if the emulsifier is incorporated into the coating, that it does not degrade the performance of the coating.

Further, organic salts, such as the fatty acid salts as described herein, can increase the solubility of the coating agent or allow the coating agent to be suspended or dispersed in solvents having a substantial water content (e.g., solvents that are at least 50% water by volume), provided that the concentration of the salts is not too low relative to the fatty acids and/or esters thereof.

The coating solutions/suspensions/colloids can further include a wetting agent that serves to reduce the contact angle (i.e., an angle of the outer surface of a droplet of the liquid measured where the liquid-vapor interface meets the liquid-solid interface) between the solution/suspension/colloid and the surface of the substrate being coated. The wetting agent can be included as a component of the coating agent and therefore added to the solvent at the same time as other components of the coating agent. Alternatively, the wetting agent can be separate from the coating agent and can be added to the solvent either before, after, or at the same time as the coating agent. Alternatively, the wetting agent can be separate from the coating agent, and can be applied to a surface before the coating agent in order to prime the surface.

The wetting agent can be a fatty acid or salt or ester thereof, e.g., a compound of Formula I, Formula II, and all subformulas described herein. In particular, the wetting agent compounds can each have a carbon chain length of 13 or less. For example, the carbon chain length can be, 7, 8, 9, 10, 11, 12, 13, in a range of 7 to 13, or in a range of 8 to 12. The wetting agent can also or alternatively be one or more of a phospholipid, a lysophospholipid, a glycoglycerolipid (for example, sucrose esters of fatty acids), a glycolipid, an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g., an alkyl sulfate). In some embodiments, the wetting agents included in the mixtures herein are edible and/or safe for consumption. Further examples of wetting agents are described below.

In some embodiments, compounds used as wetting agents can also (or alternatively) be used as emulsifiers. For example, in some embodiments, a medium chain fatty acid (e.g., having a carbon chain length of 7, 8, 9, 10, 11, 12, or 13) or salt or ester thereof is used as an emulsifier (and optionally also functions as a wetting agent) in the composition, thereby enabling the composition to be dissolved or suspended in the solvent. In some embodiments, the emulsifier is cationic. In some embodiments, the emulsifier is anionic. In some embodiments, the emulsifier is zwitterionic. In some embodiments, the emulsifier is uncharged.

In some embodiments, the composition (e.g., coating or coating agent) comprises one or more (e.g., 1, 2, or 3) wetting agents, surfactants, and/or emulsifiers. In some embodiments, the one or more wetting agents, surfactants, and/or emulsifiers comprise sodium bicarbonate, citric acid, cetyl trimethyl ammonium bromide, sodium lauryl sulfate, ammonium lauryl sulfate, sodium laureth sulfate, sodium myreth sulfate, docusate, sodium dodecyl sulfate, sodium stearate, sodium lauroyl sarcosinate, perfluorononanoate, perfluorooctanoate, perfluorooctanesulfonate (PFOS), perfluorobutanesulfonate, alkyl-aryl ether phosphates, alkyl ether phosphates, 2-[4-(2,4,4-trimethylpentan-2-yl)phenoxy]ethanol (Triton X-100), 3-[(3-Cholamidopropyl)dimethylammonio]-1-propanesulfonate (CHAPS), cholic acid, nonyl phenoxypolyethoxylethanol (NP-40), octyl thioglucoside, octyl glucoside, dodecyl maltoside, octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB), cocamidopropyl hydroxysultaine, cocamidopropyl betaine, phosphatidylserine, phosphatidylethanolamine, phosphatidylcholine, phosphatidylinositol, phosphatidic acid, lysophosphatidylserine, lysophosphatidylethanolamine, lysophosphatidylcholine, lysophosphatidylinositol, lysophosphatidic acid, sphingomyelins, lauryldimethylamine oxide, myristamine oxide, octaethylene glycol monododecyl ether, pentaethylene glycol monododecyl ether, polyethoxylated tallow amine, cocamide monoethanolamine, cocamide diethanolamine, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, Tween 20, Tween 40, Tween 60, Tween 80, alkyl polyglucosides, alkyl polyglycoside, decyl glucoside, lauryl glucoside, octyl glucoside, fatty acid esters of sucrose, sucrose monostearate, sucrose di stearate, sucrose tri stearate, sucrose polystearate, sucrose monopalmitate, sucrose dipalmitate, sucrose tripalmitate, sucrose polypalmitate, sucrose monomyri state, sucrose dimyri state, sucrose trimyri state, sucrose polymyristate, sucrose monolaurate, sucrose dilaurate, sucrose trilaurate, or sucrose polylaurate. For example, the one or more wetting agents, surfactants, and/or emulsifiers comprises sodium lauryl sulfate. For example, the one or more wetting agents, surfactants, and/or emulsifiers comprises sodium bicarbonate. For example, the one or more wetting agents, surfactants, and/or emulsifiers comprises citric acid.

In some embodiments, the mixture or composition (e.g., coating or coating agent) comprises from about 0.1% to about 40% by weight of the one or more wetting agents, surfactants, and/or emulsifiers. For example, the mixture or composition (e.g., coating or coating agent) comprises from about 0.1% to about 35%, from about 0.1% to about 30%, from about 0.1% to about 25%, from about 0.1% to about 20%, from about 0.1% to about 15%, from about 0.1% to about 10%, from about 0.1% to about 8%, from about 0.1% to about 6%, from about 0.1% to about 5%, from about 0.1% to about 4%, from about 0.1% to about 3%, from about 0.1% to about 2%, from about 0.1% to about 1%, from about 0.1% to about 0.5%, from about 1% to about 40%, from about 1% to about 30%, from about 1% to about 20%, from about 1% to about 15%, from about 1% to about 10%, from about 1% to about 5%, from about 3% to about 9%, from about 5% to about 10%, from about 10% to about 20%, from about 20% to about 30%, from about 30% to about 40%, from about 20% to about 40%, from about 25% to about 35%, about 0.1%, about 1%, about 2%, about 3%, about 4%, about 5%, about 6%, about 7%, about 8%, about 9%, about 29%, about 30%, or about 31%.

In some embodiments, the mixture or composition (e.g., coating or coating agent) comprises one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylatedhydroxyanisole (BHA), butylatedhydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzoic acid, sorbic acid, methyl paraben, propyl paraben, bronidol, and propylene glycol.

In some embodiments, the mixture or composition (e.g., coating or coating agent) comprises from about 0.1% to about 40% by weight of the one or more preservatives. For example, the mixture or composition (e.g., coating or coating agent) comprises from about 0.1% to about 35%, from about 0.1% to about 30%, from about 0.1% to about 25%, from about 0.1% to about 20%, from about 0.1% to about 15%, from about 0.1% to about 10%, from about 0.1% to about 8%, from about 0.1% to about 6%, from about 0.1% to about 5%, from about 0.1% to about 4%, from about 0.1% to about 3%, from about 0.1% to about 2%, from about 0.1% to about 1%, from about 0.1% to about 0.5%, from about 1% to about 40%, from about 1% to about 30%, from about 1% to about 20%, from about 1% to about 15%, from about 1% to about 10%, from about 1% to about 5%, from about 3% to about 9%, from about 5% to about 10%, from about 10% to about 20%, from about 20% to about 30%, from about 30% to about 40%, about 0.1%, about 1%, about 2%, about 3%, about 4%, about 5%, about 6%, about 7%, about 8%, or about 9%.

Any of the compositions (e.g., coating agents and coatings) described herein can further include additional materials that are also transported to the surface with the coating, or are deposited separately and are subsequently encapsulated by the coating (e.g., the coating is formed at least partially around the additional material), or are deposited separately and are subsequently supported by the coating (e.g., the additional material is anchored to the external surface of the coating). Examples of such additional materials can include cells, biological signaling molecules, vitamins, minerals, pigments, aromas, enzymes, catalysts, antifungals, antimicrobials, and/or time-released drugs. The additional materials can be non-reactive with surface of the coated product and/or coating, or alternatively can be reactive with the surface and/or coating.

In some embodiments, the coating can include an additive configured, for example, to modify the viscosity, vapor pressure, surface tension, or solubility of the coating. The additive can, for example, be configured to increase the chemical stability of the coating. For example, the additive can be an antioxidant configured to inhibit oxidation of the coating. In some embodiments, the additive can reduce or increase the melting temperature or the glass-transition temperature of the coating. In some embodiments, the additive is configured to reduce the diffusivity of water vapor, oxygen, CO2, or ethylene through the coating or enable the coating to absorb more ultra violet (UV) light, for example to protect the agricultural product. In some embodiments, the additive can be configured to provide an intentional odor, for example a fragrance (e.g., smell of flowers, fruits, plants, freshness, scents, etc.). In some embodiments, the coating can include components that are non-toxic and safe for consumption by humans and/or animals. For example, the coating can include components that are U.S. Food and Drug Administration (FDA) approved direct or indirect food additives, FDA approved food contact substances, satisfy FDA regulatory requirements to be used as a food additive or food contact substance, and/or is an FDA Generally Recognized as Safe (GRAS) material. Examples of such materials can be found within the FDA Code of Federal Regulations Title 21, located at “http://www.accessdata.fda.gov/scripts/cdrh/cfdocs/cfcfr/cfrsearch.cfm”, the entire contents of which are hereby incorporated by reference herein. In some embodiments, the components of the coating can include a dietary supplement or ingredient of a dietary supplement. The components of the coating can also include an FDA approved food additive or color additive. In some embodiments, the coating can include components that are naturally derived, as described herein. In some embodiments, the coating can be flavorless or have a high flavor threshold of below 500 ppm, are odorless or have a high odor threshold, and/or are substantially transparent. In some embodiments, the coating can be selected or configured to be washed off an edible agricultural product, for example, with water. In some embodiments, the coating can include an FDA approved drug ingredient, for example, any ingredient included in the FDA's database of approved drugs, which can be found at “http://www.accessdata.fda.gov/scripts/cder/drugsatfda/index.cftn”, the entire contents of which are hereby incorporated herein by reference. In some embodiments, the coating can include materials that satisfy FDA requirements to be used in drugs or are listed within the FDA's National Drug Discovery Code Directory, “www.accessdata.fda.gov/scripts/cder/ndc/default.cfm”, the entire contents of which are hereby incorporated herein by reference. In some embodiments, the materials can include inactive drug ingredients of an approved drug product as listed within the FDA's database, “www.accessdata.fda.gov/scripts/cder/ndc/default.cfm”, the entire contents of which are hereby incorporated herein by reference.

Any of the coating agents or coatings formed thereof that are described herein can be flavorless or have high flavor thresholds, e.g., above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

### Methods of Reducing the Water Requirements and Mitigating the Drought Stress of Plants

In some embodiments, the methods of the disclosure are useful for reducing the water requirements of plants as compared to a control group of untreated plants. Thus, in one aspect, the disclosure is directed to a method of reducing the water requirements of plants comprising contacting the above-ground biomass of a plant with a composition as described herein.

In some embodiments the methods of the disclosure are useful for mitigating the drought stress of plants as compared to a control group of untreated plants. Thus, in one aspect, the disclosure is directed to a method of mitigating the drought stress of plants comprising contacting the above-ground biomass of a plant with a composition as described herein.

Without wishing to be bound by theory, when a composition of the disclosure dries on the surface of the above-ground biomass of the treated plant, a coating forms over the surface of that biomass, limiting the exchange of water and gases from the plant tissues to the atmosphere. This reduction in the exchange of water from the plant tissue to the atmosphere, results in the ability of the plant to retain water for longer periods of time, allowing the amount of water that is provided to the plant, either as the result of natural or unnatural causes, to be reduced without adversely affecting the growth or development of the plant and its productivity.

In some embodiments, the methods of the disclosure result in a water requirement reduction of between about 5% to about 50% as compared to a control group of untreated plants maintained under the same conditions. For example, in some embodiments, the water requirement reduction of the treated plants is about 5%, about 10%, about 15%, about 20%, about 25%, about 30%, about 35%, about 40%, about 45% or about 50%, as compared to a control group of untreated plants.

A given percent reduction of the water requirements of a plant means that the volume of water that is provided to the plant may be reduced by that percent (i.e., about 5%, about 10%, about 15%, about 20%, about 25%, about 30%, about 35%, about 40%, about 45% or about 50%), as compared to an untreated control plant, without resulting in the plant showing significant signs of stress (e.g., fruit drop, flower drop, yellowing and wilting of leaves) due to reduced water intake or availability.

The signs of stress due to reduced water intake may be monitored in a variety of ways. For example, the physical characteristics of the plant may be monitored, e.g., discoloration of the leaves, fruit drop, flower drop or wilting of the leaves. Additionally, analytical methods that are known in the art may be used to assess the water content of the plant. As an example, the relative leaf water content and water potential of the plant may be measured using imaging methods such as near-infrared spectroscopy or hyperspectral imaging. These methods allow the determination of the minimum leaf water content that a plant may maintain without showing significant signs of stress due to a reduced water intake. Subsequent evaluation of treated plants via near-infrared spectroscopy or hyperspectral imaging allow the evaluation of the water content of the leaves and a determination of how close to the minimum leaf water content the plant is. As another example, the degree of stress a plant is under due to its water content can also be evaluated according to the Crop Water Stress Index (CWSI) (see Poblete-Echeverria, Carlos, Espinace, D., Sepúlveda-Reyes, D., and Zuniga, Mauricio & Sanchez, M. (2017). Analysis of crop water stress index (CWSI) for estimating stem water potential in grapevines: Comparison between natural reference and baseline approaches. Acta Horticulturae. 1150. 189-194. 10.17660/ActaHortic.2017.1150.27). For example, the canopy temperature of a plant can be measured to calculate the CWSI. The CWSI corresponds to a value between 0 and 1, wherein 0 represents a plant that is under no stress or mild stress due to reduced water intake, and 1 represents a plant under severe stress due to reduced water intake. Other indices or scales known to those skilled in the art can also be used to determine the amount of stress a plant is under due to reduced water intake, e.g., the Drought Response Index (DRI) (see Bidinger, F. R., Mahalakshmi, V., and Rao, G. D. P. (1987) Assessment of Drought Resistance in Pearl Millet [.Pennisetum americanum (L.) Leeke], II* Estimation of Genotype Response to Stress. Aust. J. Agric. Res. 38 49-59). As another example, genotypic properties, such as gene expression, or the formation of certain metabolites can also be indicators of stress. Particular examples include monitoring the differential regulation of genes and metabolites in the phenylpropanoid pathway, the abscisic acid (ABA) production and signaling pathways, the jasmonic acid signaling pathway, and the ethylene production and signaling pathway.

In some embodiments, the water requirements of a plant are reduced after the above-ground biomass of a plant has been contacted with a composition of the disclosure at least one time. In some embodiments, the water requirements of the plant are reduced after that biomass has been contacted with a composition of the disclosure more than one time, e.g., two times, three times, four times, five times, six times, seven times, eight times, nine times or ten times. In some embodiments, the biomass is contacted with a composition of the disclosure at least once a week, at least twice a week, at least three times a week, at least four times a week, at least 5 times a week, at least 6 times a week, or at least once a day. In some embodiments, the above-ground biomass of the plant is contacted with a composition according to the disclosure at least once a month, at least twice a month, at least three times a month, or at least four times a month.

### Methods of Reducing Damage to Plants Due to Environmental Factors

In some embodiments, the methods of the disclosure are useful for protecting plants from damage due to environmental factors as compared to a control group of untreated plants. Thus, in one aspect, the disclosure is directed to a method of reducing damage to plants due to environmental factors comprising contacting the above-ground biomass of a plant with a composition as described herein.

In some embodiments, the environmental factor is one or more of frost, heat, UV-rays, bacteria, insects, fungi, viruses, pests, pathogens or parasites. Without wishing to be bound by theory, when a composition according to the disclosure is applied to the above-ground biomass of a plant, a coating forms over the surface, resulting in a physical barrier, protecting the plant and its above-ground biomass from environmental factors. The environmental factors contemplated by the disclosure include abiotic and biotic factors. Examples of abiotic factors include, but are not limited to, heat, frost and UV-rays. Without wishing to be bound by theory, the compositions of this disclosure may serve to insulate the plant, and protect it from frost damage. Additionally, the compositions of this disclosure may serve as photoprotection for the plant by absorbing a portion of UV-radiation, reducing the formation of damaging free radicals that may result from excessive sunlight. Examples of biotic environmental factors include, but are not limited to bacteria, insects, fungi, viruses, pests, pathogens, and parasites. Without wishing to be bound by theory, the coating that forms over the surface of the above-ground biomass that has been treated with a composition as described herein, serves as a physical barrier, reducing the ability of bacteria, insects, fungi, viruses, pests, pathogens and parasites, to attack the plant. The coating may also serve to reduce the amount of volatiles released by the plant which otherwise attract insects and/or other pests to the plant. Additionally, application of the compositions of this disclosure to the above-ground biomass of a plant that may already be undergoing attack by pests and or/pathogens may act to suffocate those pest and/or pathogens, thereby preventing, reducing, or slowing the progression of infection or damage to the plant.

In some embodiments, the methods of the disclosure result in a reduction of damage to plants due to environmental factors by between about 5% to about 50% as compared to a control group of untreated plants. For example, in some embodiments, the environmental factor damage reduction of the treated plants is about 5%, about 10%, about 15%, about 20%, about 25%, about 30%, about 35%, about 40%, about 45% or about 50%, as compared to a control group of untreated plants.

A given percent reduction of damage to plants due to environmental factors means that number of incidences of damage to a cohort of treated plants is reduced by that percent (i.e., about 5%, about 10%, about 15%, about 20%, about 25%, about 30%, about 35%, about 40%, about 45% or about 50%) as compared to a cohort of untreated plants that are being grown and/or maintained under the same conditions. For example, if two cohorts of 20 plants each are assessed for damage due to insects, the first cohort whose above-ground biomass is being treated with a composition according to the disclosure, and the second cohort being untreated, the number of plants showing signs of damage due to insects may be compared between both groups. If five plants from the first cohort (treated) receive damage from insects, and ten plants of the second cohort (untreated) receive damage from insects, a 50% reduction in damage due to insects has been achieved. Similar comparisons may be made for damage due to frost, heat, excessive UV-radiation, bacteria, insects, fungi, viruses, pests, pathogens, and parasites.

In some embodiments, the methods of the disclosure result in a reduction of the severity of damage to plants due to environmental factors. The severity of damage to plants due to environmental factors can be determined by methods known to those skilled in the art. The severity of damage can be observed upon visual inspection (e.g., observing fruit drop, flower drop, leaf discoloration and/or leaf wilting), or by obtaining measurements that provide information regarding the response of particular processes within a plant to environmental stressors (e.g., photosynthesis, plant cell signaling, and plant metabolism). A reduction in the severity of damage due to environmental factors means that the extent of damage (e.g., disease, infection, and the like) is lower for plants whose above-ground biomass has been treated with a composition as described herein as compared with an untreated control plant. As an example, the Horsfall-Barratt scale can be used to quantify the severity of disease in a plant. The Horsfall-Barratt scale assigns a numerical value from 1 to 12 based on the percentage of the leaf area showing disease symptoms, with a value of 1 being consistent with little to no signs of disease and a value of 12 being consistent with severe signs of disease. Plants whose above-ground biomass has been treated with a composition as described herein will have lower values on the Horsfall-Barratt scale as compared to a control plant being maintained under similar conditions. Other scales or indices recognizable to those skilled in the art (e.g., Crop Water Stress Index (CWSI) and Drought Resistance Index (DRI)) can also be used to assess the severity of damage to a plant resulting from environmental stressors.

### Methods of Increasing Fruit, Flower or Vegetable Production of Plants

The methods of the disclosure are also useful for increasing the overall flower, fruit, and/or vegetable production (i.e., productivity) of a plant. Therefore, in one aspect, the disclosure is directed to a method for increasing the productivity of a plant comprising contacting the above-ground biomass of a plant with a composition as described herein.

Without wishing to be bound by theory, the formation of a coating on the above-ground biomass of a plant by the compositions described herein reduces the susceptibility of the plant to damage due to environmental stressors, and also increases the water efficiency of the plant. The reduction in damage due to environmental stressors allows for the plant to maintain a consistent productivity level as compared to an untreated plant that may have undergone or is undergoing damage due to environmental stress (e.g., plants that have experienced frost, extreme heat, excessive UV-rays, or attack by bacteria, insects, fungi, viruses, pests, pathogens and/or parasites). Additionally, without wishing to be bound by theory, plants whose above-ground biomass has been coated with a composition described herein experience reduced water loss from the plant to the atmosphere which increases the water efficiency of the plant. The increased water efficiency allows for enhanced productivity as compared to an untreated plant, undergoing a more rapid water loss.

In some embodiments, the methods of the disclosure result in an increase in the number of fruit produced by the plant by from about 5% to about 200% as compared to an untreated control plant, such as from about 50% to 200%, or about 75% to about 200%, or about 100% to about 200%, or about 100% to about 175%. For example, in some embodiments, the number of fruit produced by treated plants is increased by about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 100%, about 105%, about 110%, about 115%, about 120%, about 125%, about 130%, about 135%, about 140%, about 145%, about 150%, about 155%, about 160%, about 165%, about 170%, about 175%, about 180%, about 185%, about 190%, about 195%, or about 200%, as compared to an untreated control plants.

A given increase in the amount of fruit produced by a plant means that the number of fruit produced by that plant is increased by that percent (i.e., about 5%, about 10%, about 15%, about 20%, about 25%, about 30%, about 35%, about 40%, about 45% or about 50%, about 55%, about 60%, about 65%, about 70%, about 75%, about 80%, about 85%, about 90%, about 95%, about 100%, about 105%, about 110%, about 115%, about 120%, about 125%, about 130%, about 135%, about 140%, about 145%, about 150%, about 155%, about 160%, about 165%, about 170%, about 175%, about 180%, about 185%, about 190%, about 195%, or about 200%) as compared to a untreated plant grown and/or maintained under the same conditions. For example, if a treated plant produces 8 pieces of fruit, and an untreated plant produces 5 pieces of fruit, then the fruit yield (i.e., productivity) of the plant has been increased by 60% (i.e., 3 extra pieces of fruit). Similar comparisons may be made for the number of flowers and vegetables produced by a plant.

In some embodiments, the methods of the disclosure result in an increase in the mass of fruit produced by the plant by from about 5% to about 200%, such as from about 50% to 200%, or about 75% to about 200%, or about 100% to about 200%, or about 100% to about 175% as compared to an untreated control plant. For example, in some embodiments, the mass of fruit produced by treated plants is increased by about 5%, about 10%, about 15%, about 20%, about 25%, about 30%, about 35%, about 40%, about 45% or about 50%, about 55%, about 60%, about 65%, about 70%, about 75%, about 80%, about 85%, about 90%, about 95%, about 100%, about 105%, about 110%, about 115%, about 120%, about 125%, about 130%, about 135%, about 140%, about 145%, about 150%, about 155%, about 160%, about 165%, about 170%, about 175%, about 180%, about 185%, about 190%, about 195%, or about 200%, as compared to an untreated control plants.

A given increase in the mass of fruit produced by a plant means that the total mass of fruit produced by that plant is increased by that percent (i.e., about 5%, about 10%, about 15%, about 20%, about 25%, about 30%, about 35%, about 40%, about 45% or about 50%, about 55%, about 60%, about 65%, about 70%, about 75%, about 80%, about 85%, about 90%, about 95%, about 100%, about 105%, about 110%, about 115%, about 120%, about 125%, about 130%, about 135%, about 140%, about 145%, about 150%, about 155%, about 160%, about 165%, about 170%, about 175%, about 180%, about 185%, about 190%, about 195%, or about 200%) as compared to a untreated plant grown and/or maintained under the same conditions.

For example, if a treated plant produces 500 g of fruit, and an untreated plant produces 300 g of fruit, then the fruit yield (i.e., productivity) of the plant has been increased by about 67% (i.e., 200 g more fruit). Similar comparisons may be made for the mass of flowers and vegetables produced by a plant.

### Methods of Extending the Production Term of Plants

In some embodiments, the methods of the disclosure are also useful for increasing the period of time over which a plant produces fruit, flowers and/or vegetables (i.e., production term). Therefore, in one aspect, the disclosure is directed to a method extending the production term of plants comprising contacting the above-ground biomass of a plant with a composition as described herein.

In some embodiments, the production term is extended by from about 5% to about 100% as compared to an untreated control plant. For example, in some embodiments, the period of time over which a plant produces fruit, flowers and/or vegetables is extended by about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95% or about 100% as compared to an untreated control plants.

A given increase in the production term of a plant means that the overall timeframe over which the plant produces new fruit, flowers or vegetables is increased by that percent (i.e., about 5%, about 10%, about 15%, about 20%, about 25%, about 30%, about 35%, about 40%, about 45% or about 50%, about 55%, about 60%, about 65%, about 70%, about 75%, about 80%, about 85%, about 90%, about 95% or about 100%) as compared to a untreated plant grown and/or maintained under the same conditions. For example, if a treated plant produces new fruit over a period of 10 weeks, and an untreated plant produces new fruit over a period of 8 weeks, then the period of time over which the plant produces fruit has been extended by 25% (i.e., 2 additional weeks). Similar comparisons can be made for the timeframe over which a plant produces flowers and vegetables.

In some embodiments, the increase in the production term of a plant whose above-ground biomass has been treated with a composition described herein results in the plant producing fruit, flowers and/or vegetables earlier in the season as compared to a similar untreated plant being maintained under the same conditions (i.e., the fruiting cycle begins earlier). In some embodiments, the increase in the production term of a plant whose above-ground biomass has been treated with a composition as described herein results in the plant continuing to produce fruit, flowers and/or vegetables later in the season as compared to a similar untreated plant being maintained under the same conditions (i.e., the fruiting cycle ends later).

In some embodiments, the increase in the production term of a plant whose above-ground biomass has been treated with a composition as described herein results in the plant producing fruit, flowers and/or vegetables beginning earlier in the season and continuing later in the season (i.e., the overall production term is extended at the beginning and the end of fruiting cycle).

### Methods of Extending the Shelf-Life of Plant Products

In some embodiments, the methods of the disclosure are also useful for increasing the shelf life of harvested plant products. Therefore, in one aspect, the disclosure is directed to a method of extending the shelf-life of plant products post-harvest comprising contacting the above-ground biomass of a pre-harvested plant with a composition as described herein.

Without wishing to be bound by theory, pre-harvest plant products (a part of the above-ground biomass of a plant) that are contacted with a composition as described herein experience reduced water loss, and reduced oxidation as compared to plant products that have been harvested from a plant whose above-ground biomass has not been treated with a composition described herein. Water loss and oxidation are two processes that contribute to the spoilage of plant products. Therefore, this reduction in water loss and oxidation reduces the rate at which the plant products spoil, resulting in extended shelf-life. Additionally, the coating on the surface of plant products may also serve as a protective barrier, shielding the plant product from environmental factors such as bacteria, fungi, viruses, and the like, as well as bruising or other mechanical damage that may occur as a result of the harvesting process. Together, these factors offer the plant products more protection during the harvesting process, and also allow for the plant products to be stored for extended periods of time without spoiling.

In some embodiments, the pre-harvest above-ground biomass of a plant is contacted with a composition as described herein at least one time before the plant product is harvested. In some embodiments, the pre-harvest above-ground biomass of a plant is contacted with a composition as described herein between 1 and 10 times before the plant product is harvested. For example, in some embodiments, the pre-harvest above-ground biomass of a plant is contacted with a composition as described herein 1 time, 2 times, 3 times, 4 times, 5 times, 6 times, 7 times, 8 times, 9 times or 10 times before the plant product is harvested.

In some embodiments, the plant product is harvested from a treated pre-harvest plant 1 day to about 1 month after the pre-harvest plant was treated with a composition as described herein. In some embodiments, the plant product is harvested from a treated pre-harvest plant 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, or 31 days after the pre-harvest plant was treated with a composition as described herein.

In some embodiments, the shelf life of the plant product is extended by 1 day to about 2 weeks as compared to a similar plant product that has been harvested from a plant whose above-ground biomass has not been treated with a composition pre-harvest. In another embodiment, the shelf life of the plant product is extended by 1 day, 2 days, 3 days, 4 days, 5 days, 6 days, 7 days, 8 days, 9 days, 10 days, 11 days, 12 days, 13 days, 14 days, 3 weeks, 4 weeks, 5 weeks, 6 weeks, 7 weeks, 2 months, 3 months, 4 months, 5 months or 6 months as compared to a similar plant product that has been harvested from a plant whose above-ground biomass has not been contacted with a composition pre-harvest.

In some embodiments, the shelf life of the plant product is extended by between 5% and 400%, such as from about 50% to about 350%, or about 100% to about 300%, or about 150% to about 550%, or about 300% to about 400%. For examples, in some embodiments, the shelf life of the plant product is extended by about 5%, about 10%, about 15%, about 20%, about 25%, about 30%, about 35%, about 40%, about 45% or about 50%, about 55%, about 60%, about 65%, about 70%, about 75%, about 80%, about 85%, about 90%, about 95%, about 100%, about 105%, about 110%, about 115%, about 120%, about 125%, about 130%, about 135%, about 140%, about 145%, about 150%, about 155%, about 160%, about 165%, about 170%, about 175%, about 180%, about 185%, about 190%, about 195%, about 200%, 205%, about 210%, about 215%, about 220%, about 225%, about 230%, about 235%, about 240%, about 245% or about 250%, about 255%, about 260%, about 265%, about 270%, about 275%, about 280%, about 285%, about 290%, about 295%, about 300%, about 305%, about 310%, about 315%, about 320%, about 325%, about 330%, about 335%, about 340%, about 345%, about 350%, about 355%, about 360%, about 365%, about 370%, about 375%, about 380%, about 385%, about 390%, about 395%, or about 400%, as compared to plant products that have been harvested from untreated pre-harvest plants.

A given increase in the shelf life of a plant product means that the shelf life of the plant product is increased by that percent (i.e., about 5%, about 10%, about 15%, about 20%, about 25%, about 30%, about 35%, about 40%, about 45% or about 50%, about 55%, about 60%, about 65%, about 70%, about 75%, about 80%, about 85%, about 90%, about 95%, about 100%, about 105%, about 110%, about 115%, about 120%, about 125%, about 130%, about 135%, about 140%, about 145%, about 150%, about 155%, about 160%, about 165%, about 170%, about 175%, about 180%, about 185%, about 190%, about 195%, or about 200%) as compared to a plant product that has been harvested from a plant whose above-ground biomass has not been treated by a composition as described herein. For example, if a strawberry harvested from a plant whose above-ground biomass has been treated with a composition as described herein has a shelf life of 14 days, and a strawberry harvested from a plant whose above-ground biomass has not been treated with a composition as described herein has a shelf life of 10 days, then the shelf life of the strawberry has been increased by about 40% (i.e., 4 extra days).

In some embodiments, the shelf-life of a plant product is assessed by measuring certain characteristics of the plant product. The characteristics that can be measured include, but are not limited to, the mass loss rate, mass loss factor, respiration rate or respiration factor of the harvested plant product. In some embodiments, the mass loss rate of a plant product that has been harvested from a pre-harvest plant whose above-ground biomass has been contacted with a composition as described herein is reduced by at least 10%, 15%, 20%, 25%, 30%, 35%, 40%, 45%, 50%, 55%, 60%, 65%, 70%, 75%, 80%, 85%, 90% or 95% compared to a plant product harvested from a pre-harvest plant whose above-ground biomass has not been contacted with a composition as described herein. In some embodiments, the mass loss factor of a plant product that has been harvested from a pre-harvest plant whose above ground biomass has been contacted with a composition as described herein is at least 1.1, at least 1.2, at least 1.3, at least 1.4, at least 1.5, at least 1.6, at least 1.7, at least 1.8, at least 1.9, at least 2.0, at least 2.2, at least 2.4, at least 2.6, at least 2.8, or at least 3.0. In some embodiments, the respiration rate of the plant product that has been harvested from a pre-harvest plant whose above-ground biomass has been contacted with a composition as described herein is reduced by at least 10%, 15%, 20%, 25%, 30%, 35%, 40%, 45%, 50%, 55%, 60%, 65%, 70%, 75%, 80%, 85%, 90% or 95% as compared to a plant product that has been harvested from a pre-harvest plant whose above-ground biomass has not been contacted with a composition as described herein. In some embodiments, the respiration factor of a plant product that has been harvested from a pre-harvest plant whose above ground biomass has been contacted with a composition as described herein is at least 1.1, at least 1.2, at least 1.3, at least 1.4, at least 1.5, at least 1.6, at least 1.7, at least 1.8, at least 1.9, at least 2.0, at least 2.2, at least 2.4, at least 2.6, at least 2.8, or at least 3.0.

Application of Compositions of this Disclosure

The methods of this disclosure are characterized by the above-ground biomass of a plant to be contacted or treated with a composition described herein. The biomass may be contacted with a composition according to the disclosure in a variety of ways. Methods of contacting plants with a composition according to the disclosure include, but are not limited to, spraying, misting, pouring, dipping, dunking, brushing, electrospraying, and fogging. It will be readily understood that the method by which the biomass is contacted with the composition will influence certain physical properties of the coating that forms on the biomass such as, for example, the thickness of the coating, and the percentage of the above-ground biomass of the plant that the coating covers. Those physical characteristics may influence the plant's response to being treated with a composition of this disclosure. For example, if a large portion of the above-ground biomass is coated with a thick coating, the amount of CO₂ that the plant is able to absorb for photosynthesis will be reduced. This may have a detrimental effect on the overall growth and development of the plant. Those skilled in the art may readily determine the amount of a composition that is applied to the above-ground biomass of a plant through routine experimentation.

In some embodiments, the compositions that are useful in the methods of the disclosure are applied to the surface of the above-ground biomass of a plant such that between 20% and 95% of the surface of the biomass is uniformly coated with the composition. In some embodiments, the compositions that are useful in the methods of the disclosure are applied to the surface of the biomass such that at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95% of the surface of the biomass is uniformly coated with the composition.

The frequency by which the above-ground biomass of a plant is treated with a composition according to the disclosure may also influence the physical characteristics of the coating formed by such composition such as, for example, the thickness of the coating, and the percentage of the above-ground biomass of the plant that the coating covers. The frequency by which the above-ground biomass of a plant is contacted with a composition according to the disclosure will depend on a variety of factors, such as the type of plant, the method by which the composition is being contacted with the biomass, and the thickness of the coating and the percent of the above-ground biomass that has been coated with prior treatments. The frequency by which the above-ground biomass of a plant is treated with a composition may vary over time. For example, plants that have never been treated with a composition according to the disclosure may be treated more frequently to establish a base coating. After a base coating has been established, subsequent applications of the composition to the above-ground biomass of the plant may be reduced to a less frequent schedule. The frequency by which the compositions are applied to the biomass may be determined by those skilled in the art. In some embodiments, the above-ground biomass of the plant is contacted with a composition according to the disclosure at least once a week, at least twice a week, at least three times a week, at least four times a week, at least 5 times a week, at least 6 times a week, or at least once a day. In some embodiments, the above-ground biomass of the plant is contacted with a composition according to the disclosure at least once a month, at least twice a month, at least three times a month, or at least four times a month.

### EQUIVALENTS

The foregoing description and following examples detail certain specific embodiments of the disclosure and describe the best mode that the inventors contemplated. It will be appreciated, however, that no matter how detailed the foregoing may appear in text, the disclosure may be practiced in many ways and the disclosure should be construed in accordance with the appended claims and equivalents thereof.

Although the disclosed teachings have been described with reference to various applications, methods, compounds, and compositions, it will be appreciated that various changes and modifications to them may be made without departing from the teachings herein. The following examples are provided to better illustrate the disclosed teachings and are not intended to limit the scope of the teachings presented herein. While the present teachings have been described in terms of these exemplary embodiments, the skilled artisan will readily understand that numerous variations and modifications of these exemplary embodiments are possible without undue experimentation. All such variations and modifications are within the scope of the teachings of this disclosure.

### EXAMPLES

### Effect of Compositions of the Disclosure on the Growth and Fruit Yield of Tomato Plants

The above-ground biomass of growing tomato plants were treated with a 94:6 mixture of monoglycerides (1:1 ratio of PA-1G to SA-1G) to SA-Na in water. The biomass was treated by spraying the mixture (˜35 mL) on the biomass once a week, beginning after 12 weeks of growth had occurred, for a duration of 9 weeks. At the commencement of the treatment, greater than 50% of the plants were flowering. Regular water levels were maintained during the course of the study. The amount of fruit produced by the plants was monitored, and compared to a cohort of untreated plants, that were maintained under the same conditions.

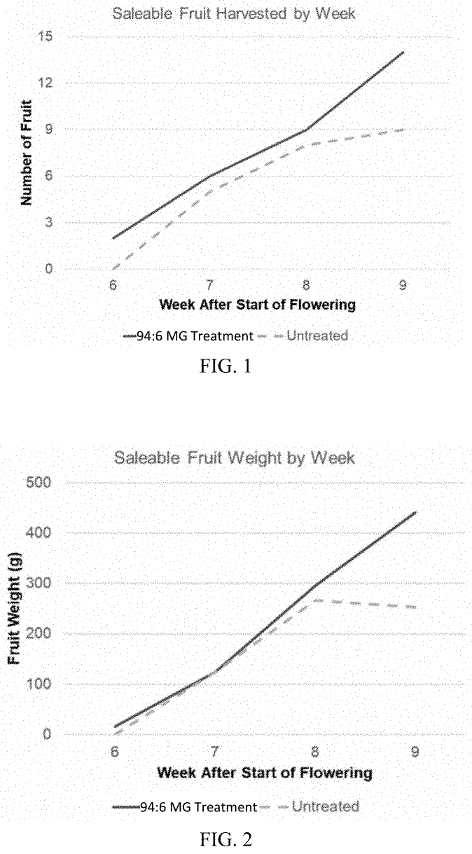

During week 6 of the study, 2 pieces of harvestable fruit were harvested from the treated plants. By contrast, during that same week, no harvestable tomatoes were harvested from the untreated plants. Both cohorts of plants showed a consistent increase in the production of tomatoes from week 2 to week 8. During week 8, the treated plant produced 9 pieces of harvestable fruit, and the untreated plant produced 8 pieces of harvestable fruit. After week 8, the fruit yield for the untreated plant began to plateau, only producing 9 pieces of harvestable fruit. By contrast, the increase of fruit yield from the treated plants remained consistent after week 8, producing 14 harvestable tomatoes during week 9 of the study (see FIG. 1). The results demonstrate that the tomato plants whose above-ground biomass has been treated with compositions of this disclosure produce fruit over a longer period of time as compared to untreated tomato plants maintained under the same conditions.

The weight of the harvested fruit from the two cohorts of tomato plants was also monitored. It demonstrates similar trends to those described for the comparison of the number of tomatoes harvested from the treated and untreated plants. In particular, the mass of the tomatoes harvested weekly from the treated and untreated tomato plants increased consistently between week 6 and week 8 of the study. After week 8, the mass of tomatoes yielded by the untreated plants plateaued. By contrast, the mass of tomatoes yielded by the treated plants increased consistently between week 8 and week 9 of treatment (FIG. 2). These results demonstrate that treating the above-ground biomass of the tomato plants with a 94:6 mixture of monoglycerides (1:1 ratio of PA-1G to SA-1G) to SA-Na in water results in an extended period of time over which the plants produce fruit.

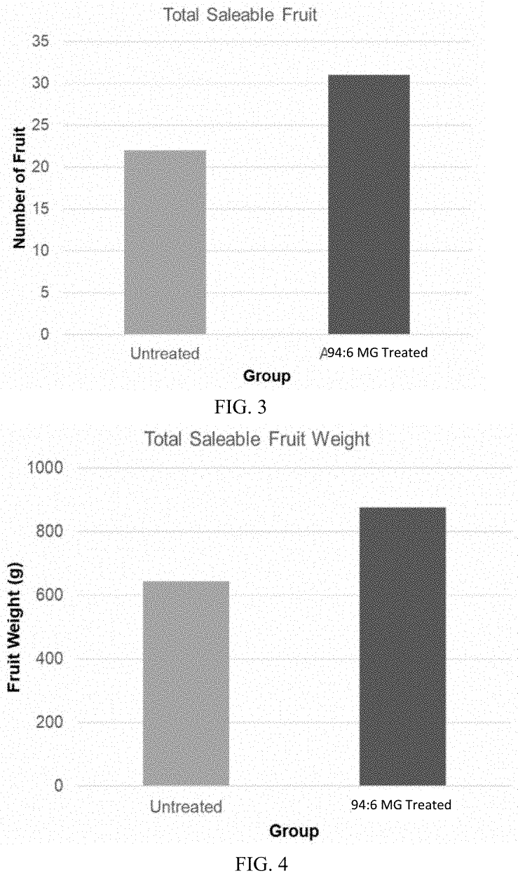

The total number of tomatoes harvested, as well as the total mass of tomatoes harvested, from the treated and untreated plants during the duration of the study were also monitored (FIG. 3 and FIG. 4). By the completion of the study, the treated plants produced 31 tomatoes (900 g) and the untreated plants produced 22 tomatoes (650 g). These results demonstrate a 40.9% increase in the total number of tomatoes, and a 38.5% increase in the total mass of tomatoes harvested from the treated plants as compared to the untreated plants during the duration of the study.

### Example 2: Effect of the Compositions of this Disclosure on the Growth of Tomato Plants During Drought Conditions

The above-ground biomass of growing tomato plants was treated with a 94:6 mixture of monoglycerides (1:1 ratio of PA-1G to SA-1G) to SA-Na in water. The biomass was treated by spraying the mixture (˜35 mL) on the biomass once a week, beginning after 12 weeks of growth had occurred, for a duration of 20 weeks. At the commencement of the treatment, greater than 50% of the plants were flowering. The plants were subjected to 5 moderate drought events over the course of 6 weeks during the study, totaling a reduction of 1.25 L of irrigation over that timeframe (i.e., a reduction of 1250 mL by 250 mL once during week 9, 11, 13, 14, and 15). Symptoms of drought stress, including wilting, flower drop, and fruit drop, as well as the plant height and fruit yield, were monitored and compared with a cohort of untreated plants that were maintained under the same conditions.

It was observed that over the course of the study, the cohort of treated plants showed less signs of drought stress, i.e., wilting, fruit count and flower drop, as compared to the untreated cohort of plants. Phenotypic and genotype responses (e.g., differential regulation of genes and/or metabolites in the phenylpropanoid pathway, the abscisic acid (ABA) production and signaling pathways, the jasmonic acid signaling pathway, and the ethylene production and signaling pathway) may also be used to demonstrate a reduction of drought stress.

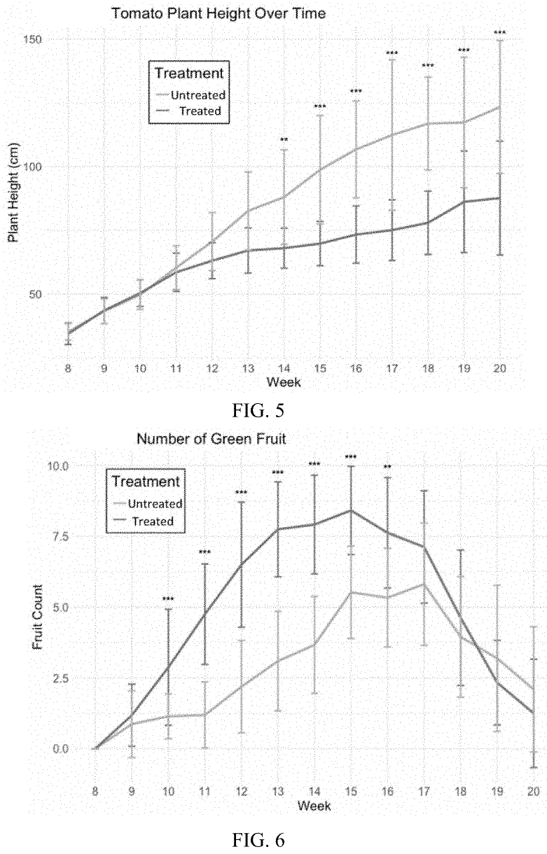

The height of the plants between the treated and untreated cohort of plants remained relatively consistent for the first 11 weeks of the study. After week 11, the height of the untreated plants surpassed that of the treated plants and continued to increase at a faster rate than the treated plants (FIG. 5). Without wishing to be bound by theory, treatment with a composition of this disclosure results in a reduced rate of growth of the plants, thereby reducing the water requirements of the plants. Because the plants require less water, less wilting, fruit drop and flower drop was observed from the treated plants as compared to the untreated plants.

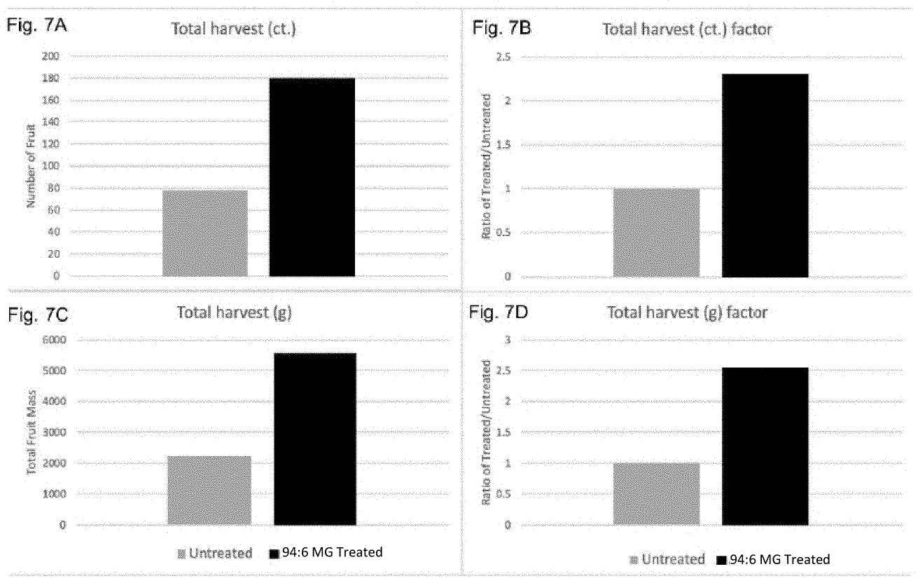

During the course of the study, the cohort of treated plants produced a greater number of green fruits each week as compared to the cohort of untreated plants (FIG. 6). In particular, the number of tomatoes produced by the treated plants was consistently greater during weeks 9 through week 18 of the study. Additionally, after 20 weeks, the total number of tomatoes produced by the treated plants was 180 (corresponding to 5500 g), whereas the untreated plants produced 79 tomatoes (corresponding to 2100 g) (FIG. 7A-7D). These results demonstrate a 127% increase in the number of tomatoes produced, and a 162% increase in the total mass of tomatoes produced in a comparison of treated and untreated plants.

The estimated 35 mL of the water solution of monoglyceride/fatty acid salt mixture applied to the plants once weekly would add approximately half of the total withheld irrigation after about 14 weeks of treatment. However, the tomato yield was approximately 2.5 times greater for the treated plants as compared to the untreated plants, supporting the hypothesis that the treatment provided more than just additional water to the cohort of treated plants.

### Example 3: Effects of Compositions of this Disclosure on Water Content of Fescue Sod

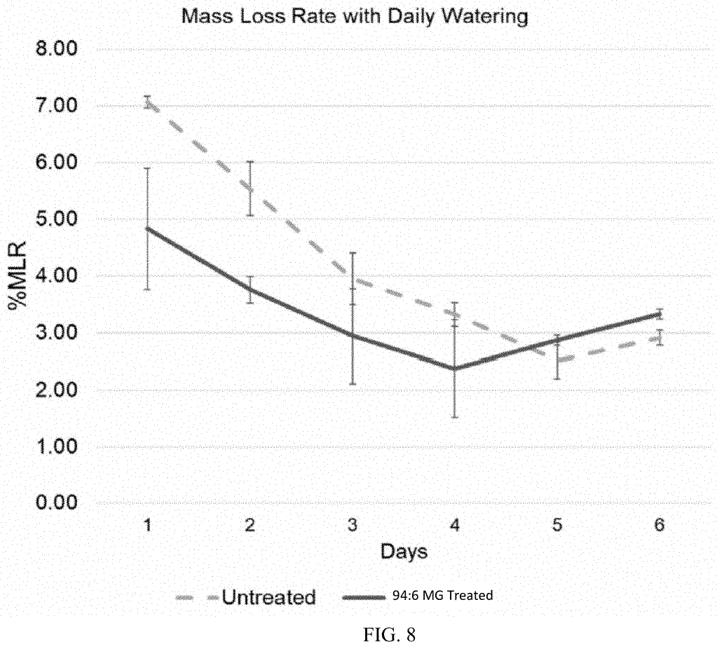

Fescue sod was cut into 11″×16″ slices and its above-ground biomass was treated with a 94:6 mixture of monoglycerides (1:1 ratio of PA-1G to SA-1G) to SA-Na in water. The sod portions were stored at ambient temperature and were watered with a pump sprayer on all surfaces daily with 125 mL of water. The mass of the sod was monitored daily and compared to a control group of untreated fescue sod that was maintained under the same conditions (FIG. 8).

During the first 4 days of treatment, the mass loss rate of the untreated sod was greater than the mass loss rate of the treated sod, indicating that compositions of this disclosure allow the sod to maintain its water content to a greater extent as compared to untreated sod. During day 5 and 6 of the study, the mass loss rate between both groups was relatively similar (day 5: ˜3% MLR for treated, ˜2.5% MLR for untreated; day 6: ˜3.25% MLR for treated, ˜3% MLR for untreated).

### Example 4: Effects of the Compositions of this Disclosure on the Shelf-Life of Subsequently Harvested Strawberries

The above-ground biomass of growing, actively fruiting strawberry plants was treated with a 94:6 mixture of monoglycerides (1:1 ratio of PA-1G to SA-1G) to SA-Na in water. The plants were treated 1 day prior to harvest. The strawberries were divided into three groups, and stored at 2° C., 12° C. and 20° C., respectively. The strawberries were monitored for mass loss rate, and compared to control groups of strawberries harvested from untreated plants prior to harvest that were being stored under the same conditions.

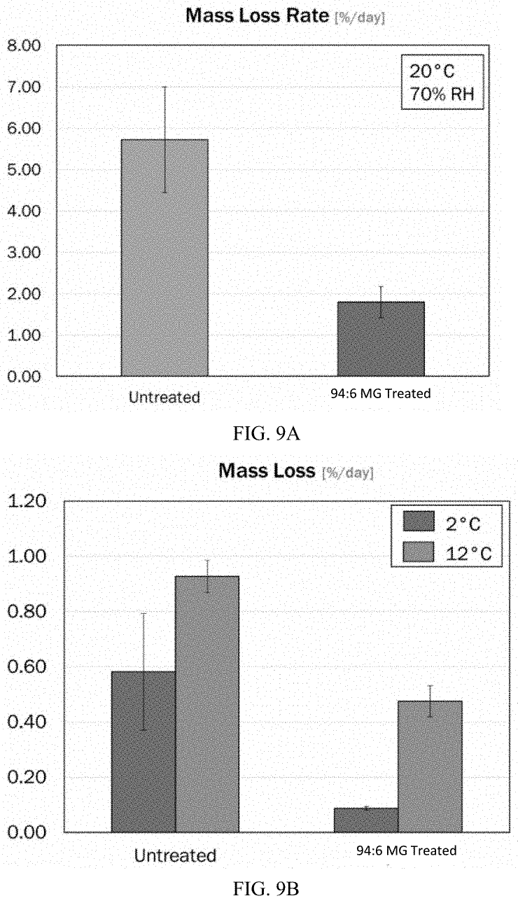

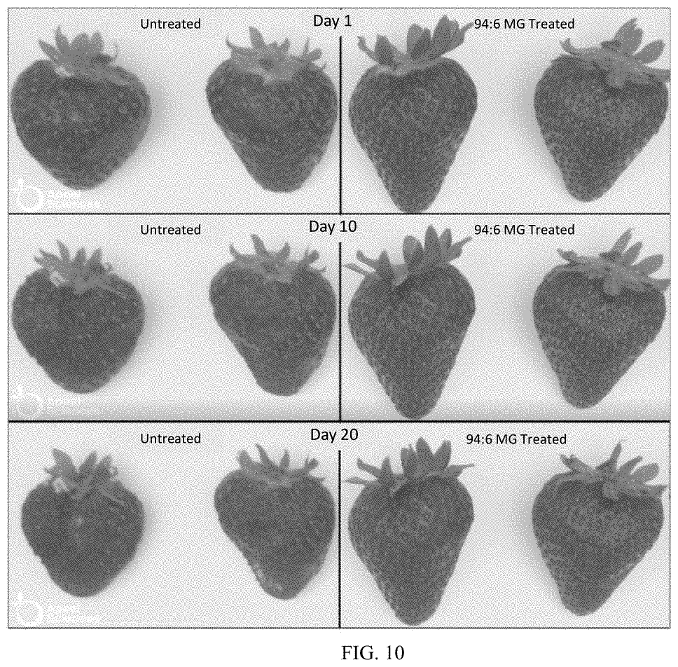

The mass loss rate for the strawberries harvested from the treated plants was less as compared to the strawberries harvested from untreated plants for all three groups (FIG. 9A and FIG. 9B). Additionally, storing the strawberries at low temperature resulted in a reduced mass loss rate, i.e., the strawberries stored at 2° C. had a lower mass loss rate than those stored at 12° C., and the strawberries stored at 12° C. had a lower mass loss rate than those stored at 20° C. Notably, the treated strawberries that were stored at 12° C. had a similar mass loss rate to the untreated strawberries stored at 2° C. (0.5% MLR for treated, 0.59% MLR for untreated). Additionally, a visible inspection of the strawberries stored at 2° C. for a period of 20 days revealed that the treated strawberries were protected from bruising during the harvesting process as compared to the untreated strawberries (FIG. 10).

The above-ground biomass of three additional groups of growing, actively fruiting strawberry plants was treated with a 94:6 mixture of monoglycerides (1:1 ratio of PA-1G to SA-1G) to SA-Na in water. The plants were treated 1 day prior to harvest. The strawberries were divided into three groups, and stored at 1° C., 12° C. and 22° C., respectively. The strawberries were monitored to determine their mold rates and compared to control groups of strawberries harvested from untreated plants prior to harvest that were being stored under the same conditions.

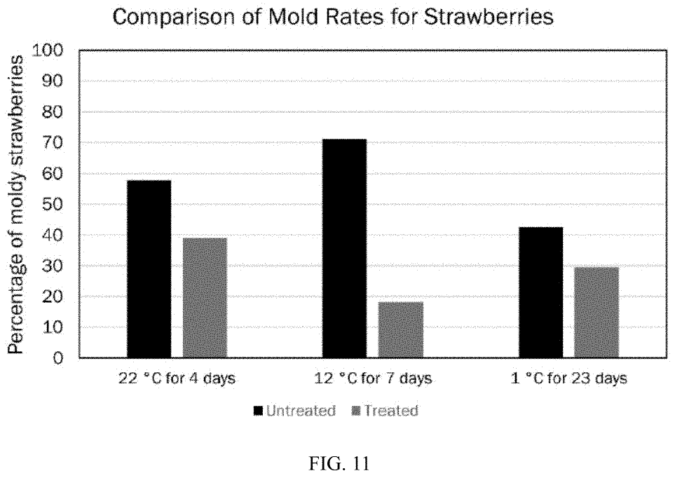

The results demonstrated that the strawberries harvested from the plants whose above-ground biomass was treated with the 94:6 mixture of monoglycerides (1:1 ratio of PA-1G to SA-1G) to SA-Na in water were less susceptible to mold. After 4 days of storage at 22° C., the treated strawberries had an ˜39% incidence of mold, and the untreated strawberries had a ˜58% incidence of mold (FIG. 11). After 23 days of storage at 1° C., the treated strawberries had an ˜29% incidence of mold, and the untreated strawberries had a ˜42% incidence of mold. Following a similar trend, the treated strawberries stored at 12° C. for a period of 7 days had a lower incidence of mold (˜18%) as compared to untreated strawberries stored under the same conditions (˜71%).

### Example 5: Effects of Time Between Coating Application and Harvest on Shelf Life

The above-ground biomass of growing, actively fruiting strawberry plants was treated with a 10 g/L solution of a 94:6 mixture of monoglycerides (1:1 ratio of PA-1G to SA-1G) to SA-Na in water. The above-ground biomass of a second group of growing, actively fruiting strawberry plants was treated with a 30 g/L solution of a 94:6 mixture of monoglycerides (1:1 ratio of PA-1G to SA-1G) to SA-Na in water. These groups were compared to a control group of strawberry plants that remained untreated.

From those three groups of strawberry plants, one batch of strawberries was harvested one day after treatment with the 94:6 mixture of monoglycerides to SA-Na in water. A second batch of strawberries was harvested one week after treatment with the 94:6 mixture of monoglycerides to SA-Na in water.

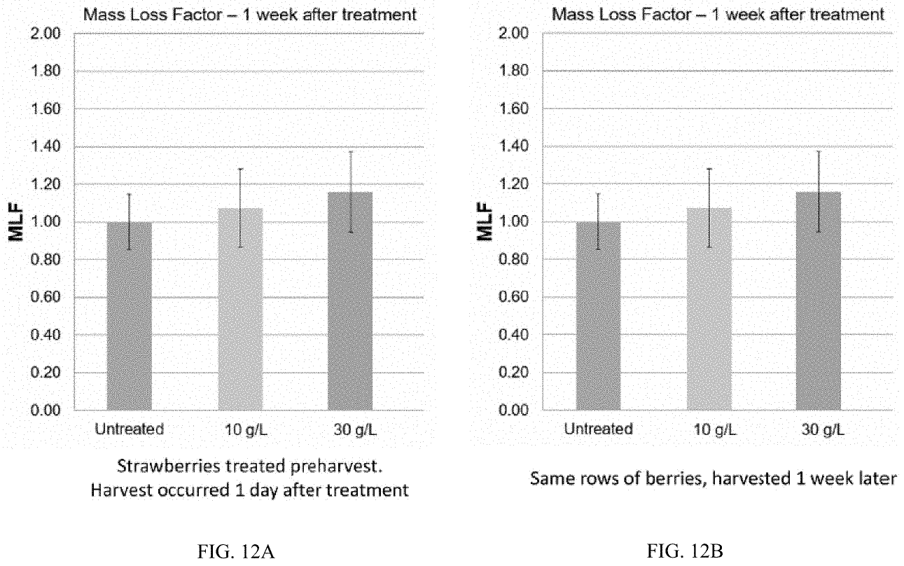

The first batch of strawberries that were harvested one day after application of the compositions demonstrated an increased mass loss factor (i.e., reduced water loss) as compared to the batch of untreated strawberries (MLF_{30 g/mL}=1.50; MLF_{10 g/mL}=1.39; FIG. 12A).

In the second batch of strawberries that were harvested one week after application of the compositions, it was observed that the coatings covered less of the surface of the above-ground biomass of the plants, including the strawberries, as compared to the batch of strawberries that were harvested one day after application of the compositions. This observation is attributed to the continued growth of the plant between the time the compositions were applied to the plants and the time the strawberries were harvested. Even with a reduced coverage of the above-ground biomass with the coating, the harvested strawberries, surprisingly, demonstrated an increased mass loss factor (i.e., reduced water loss) as compared to the untreated control group of strawberries (FIG. 12B).

### Example 6: Yellow Squash Gene Expression Analysis

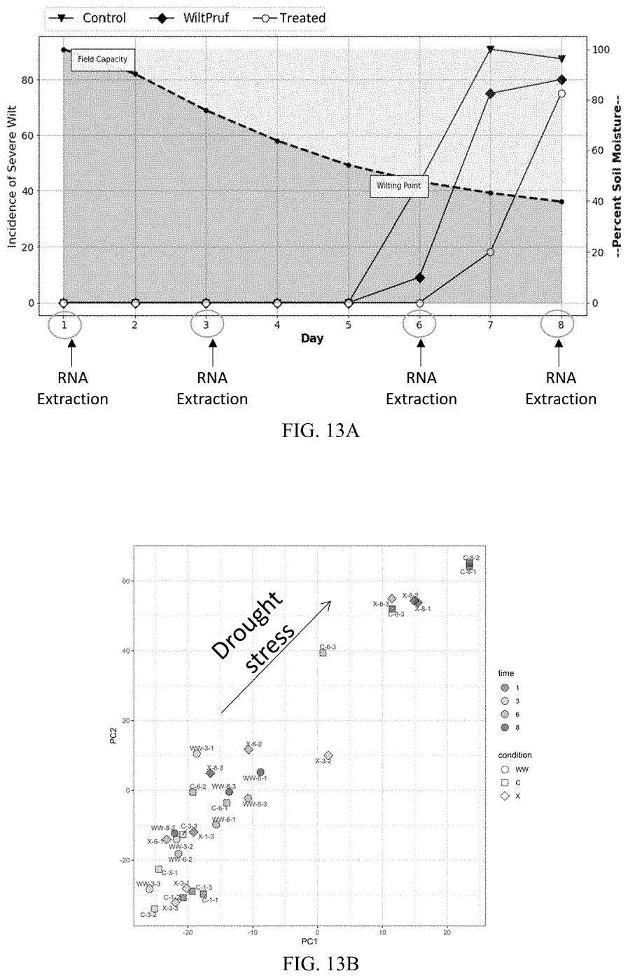

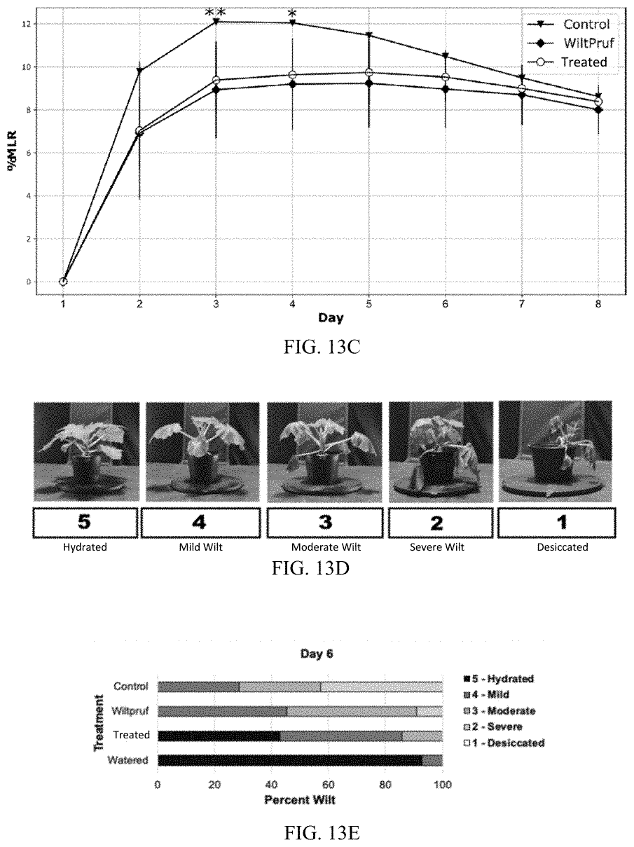

Yellow squash plants were planted and the incidence of severe wilt and the percent soil moisture were measured regularly. Plants were assigned to one of four treatment groups, including a watered control (no stress), water stressed control (drought conditions lacking the composition coating), water stressed squash treated with WiltPruf® (a commercially available anti-transpirant), and water stressed squash treated with the composition coating comprising 94% 1-glyceryl monostearate and 6% potassium stearate. RNA was extracted from indicated time points (days 1, 3, 6, and 8) and genome wide transcriptomic analysis (RNA-seq) was carried out for all treatments (FIG. 13A). The watered control was used as a reference to identify differentially expressed genes at corresponding time points. Composition treated plants, and WiltPruf® treatment delay onset of severe wilt at <45% soil moisture capacity (dotted black line) and are significantly different from one another on days 6 and 7 relative to the untreated control (FIG. 13A).

Principle component analysis was performed with watered control samples, water stressed control samples, and composition-treated samples. Degree of drought stress was captured by both Principle Component 1 (PC1) and Principle Component 2 (PC2), with severity of water stress indicated by movement towards upper right quadrant. Watered control samples (WW) remain in lower left quadrant, while water stressed control samples (C) show movement toward the upper right quadrant over time, indicated by the arrow labeled “Drought stress”. This trend is less significant for composition treated (X) samples (FIG. 13B).

Squash plant percent mass loss rate over time was measured. Pot weights were collected daily and percent mass loss rate was calculated for each treatment. Pairwise analysis compared the differences between untreated, composition treated, and WiltPruf® at each time point. Mass loss rate of composition treated and WiltPruf® treated plants were significantly smaller than control on days 3 and 4 (FIG. 13C). Significance was determined with Tukey post-hoc analysis.

On day eight, the end of the experiment, the hydration state was measured for each plant using as 1-5 scale where 5=hydrated shown by fully turgid leaves, 4=mild with shown by leaves that are soft to the touch, 3=moderate wilt in which leaves are beginning to visibly wilt, 2=severe wilt, and 1=desiccation in which leaves are wilted to the point of drying out (FIG. 13D). Treated plants showed more plants in the hydrated category than either WiltPruf® or control plants (FIG. 13E).

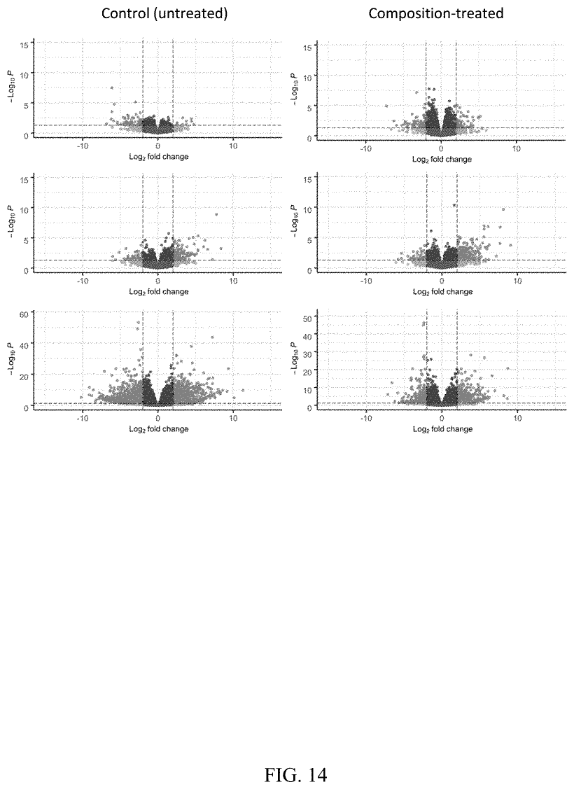

Volcano plots show lots of large and significant changes in gene expression increasingly occurring across the experimental time course for drought stress control (untreated) and composition-treated squash (FIG. 14).

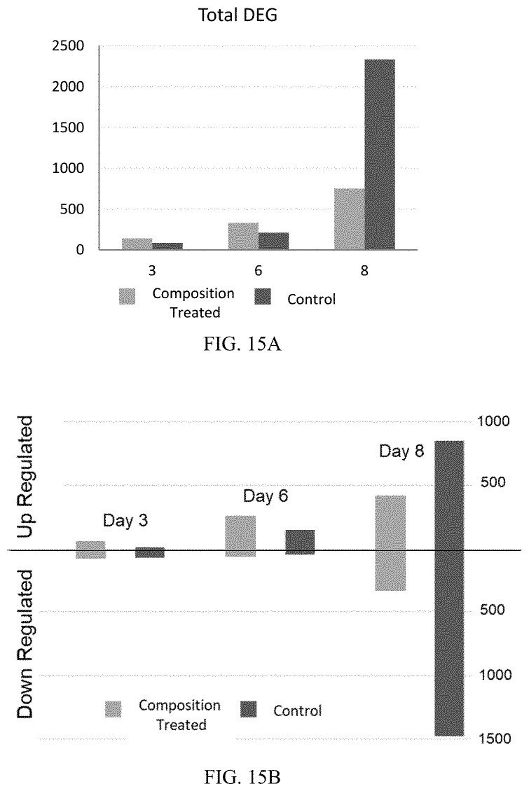

The number of differentially expressed genes was analyzed in the control (untreated) and composition-treated squash. The total number of differentially expressed genes (DEG) was compared to the watered control at equivalent time points. A cut off of Log 2 fold change is greater than or less than 2 with p-value <0.05 was used. The total number of differentially expressed genes (Total DEG) increased more for the watered control than the composition (FIG. 15A). The number of up regulated and down regulated genes was greatest at day 8 for both the composition treated and control squash leaves. There were more genes up and down regulated on day 8 in the control squash leaves than in the composition treated squash leaves (FIG. 15B).

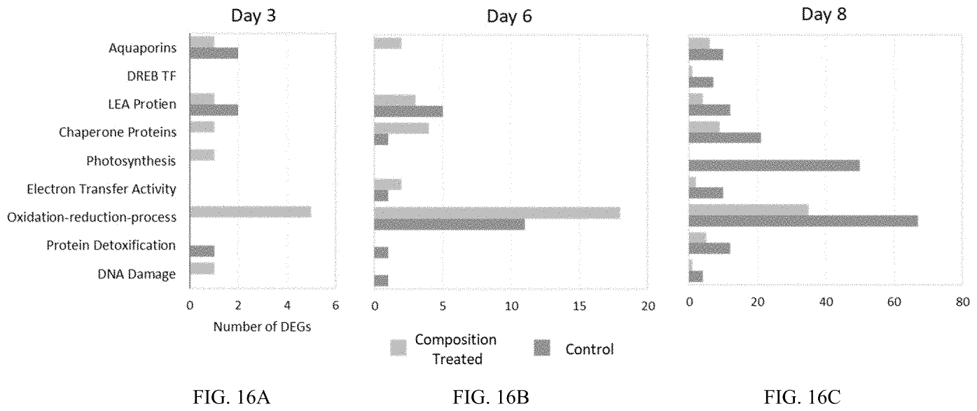

A gene classification analysis was then performed. The number of differentially expressed genes was counted for selected gene classes based on a combination of gene ontology enrichment analysis and expectation of differential expression associated with drought response. Selected gene classes included aquaporins, drought response element binding transcription factor (DREB TF), late embryogenesis abundant (LEA) proteins, chaperone proteins, photosynthesis, electron transfer activity, oxidation-reduction process, protein detoxification, and DNA damage. The number of differentially expressed genes changed over time, although the oxidation reduction process gene class included the largest number of differentially expressed genes at all of the time points (FIG. 16A-C). There are early signs of mild oxidative stress during treatment with the composition; however, the treatment protects against the large induction observed on day 8 in the control group.

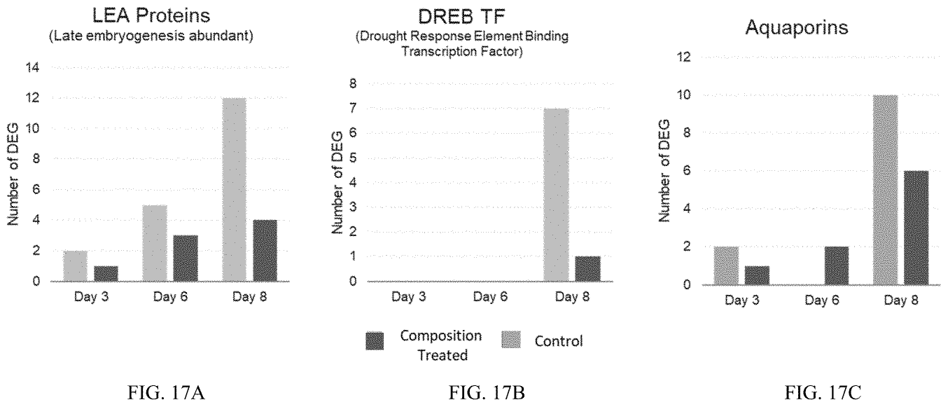

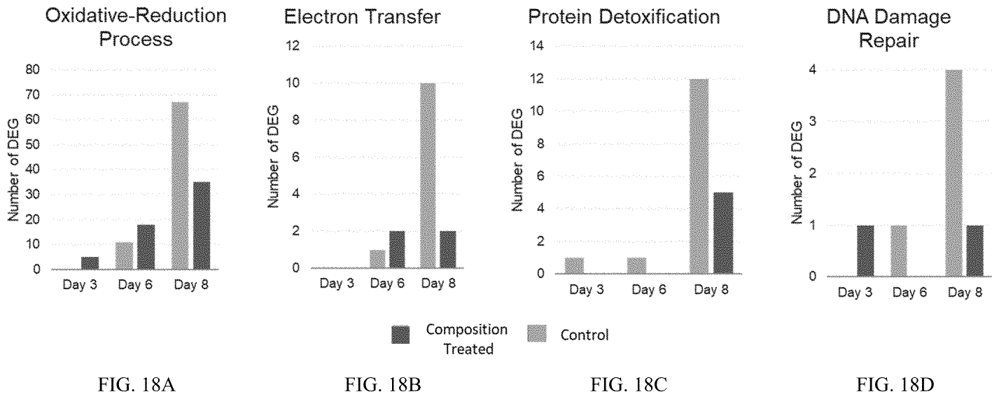

A subsections of differentially regulated gene classes were analyzed more closely including late embryogenesis abundant (LEA) proteins (FIG. 17A), drought response element binding transcription factor (DREB TF) (FIG. 17B), aquaporins (FIG. 17C), and oxidative stress related proteins (FIG. 18A-D). These gene classes showed a lower number of differentially expressed genes at day 8 of the composition-treated group compared to the control treatment (FIGS. 17A-C, 18A-D). LEA proteins protect against protein aggregation induced by desiccation and osmotic stress and it is a well-established response to drought/water stress. DREB TF are transcription factors that bind to drought response elements and regulate the transcription of stress response genes. Aquaporins are membrane proteins that regulate water movement by controlling flux of water molecules across membranes. Genes involved in the oxidative-reduction process and electron transfer are enriched in peroxidases, oxidative stress proteins, thioredoxin proteins, and ferredoxin proteins. Genes involved in protein detoxification and DNA damage repair are activated under oxidative stress.

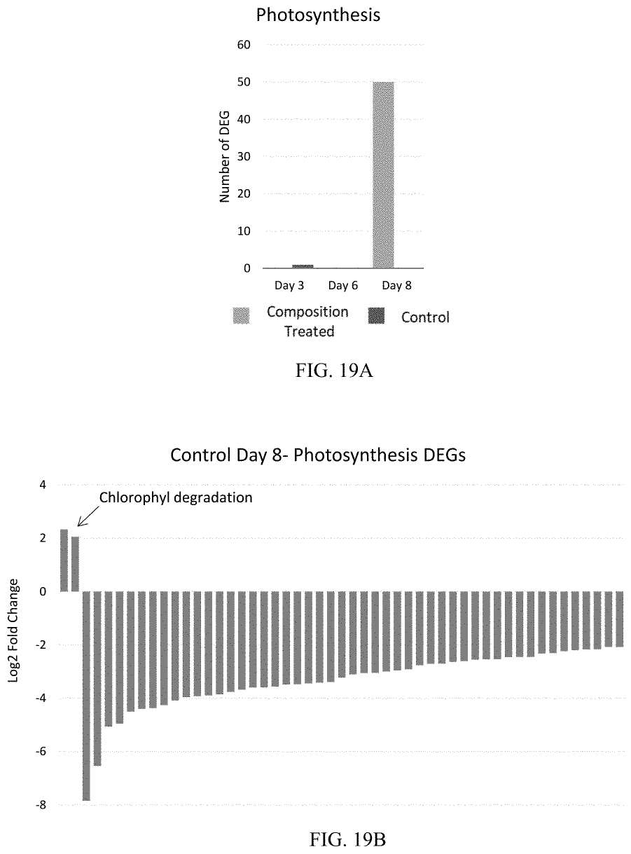

Without being bound by theory, it is hypothesized that under drought stress, stomatal closure occurs to conserve water, but this also restricts uptake of CO₂. During the light cycle, this results in a significant drop in internal CO₂ levels. This slows down the Calvin cycle, which utilizes the chemical energy from photosynthesis and CO₂ to generate sugar. Since the light harvesting complexes are still active, this results in oxidative stress that includes damage to the photosynthetic machinery, and buildup of NADPH and hydrogen peroxide. In fact, photosynthesis genes were down regulated at day 8, but only for the control (untreated) samples (FIGS. 19A-B). In addition, chlorophyll degradation was up-regulated (FIG. 19B). This may results from the onset of senescence.

Gene expression data supports the claim that treatment with the composition improves plant health under water related stress conditions. Under drought conditions, treatment with the composition delays the onset of the molecular markers for drought induced osmotic and oxidative stress. In particular, treatment with the composition delays drought induced expression changes in the osmotic protective LEA proteins, water transport proteins, and drought response transcription factors. The composition (e.g., a 94:6 mixture of monoglycerides) helped protect against oxidative damage occurring during drought as a result of restricted CO₂ uptake resulting from stomata closure to prevent water loss. This is inferred from gene expression changes in proteins related to oxidative stress, electron transport, protein detoxification, and DNA damage. Lastly, treatment with the composition protects from and/or delays massive down regulation of photosynthesis resulting from drought stress.

### Example 7: Performance of Composition when Followed by Dunk or Brushbed Application of Water to Agricultural Products

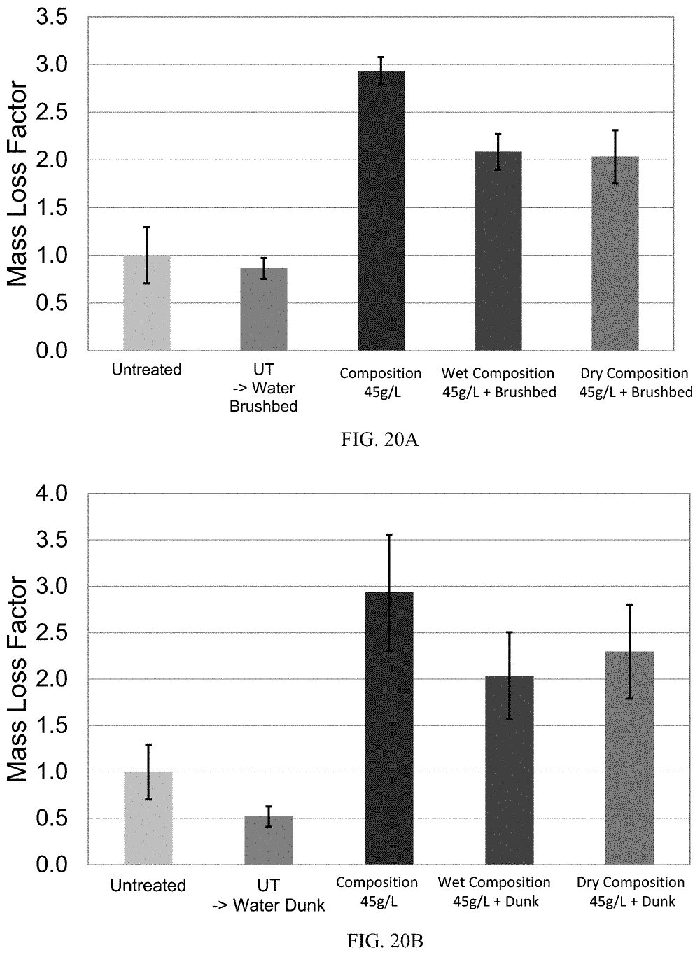

To determine if the performance of the composition is reduced on satsuma mandarin oranges when followed by exposure to water, fruit were treated with a composition and then exposed to water either by dunking the whole fruit in water or by using a brushbed application of water. Satsuma mandarin oranges were in one of seven categories. First, fruit were exposed to 45 g/L of a composition of 94% 1-glyceryl monostearate and 6% sodium stearate or were left untreated. Both treated and untreated fruit were either quickly treated with water following the application of the composition (wet composition treatment), were dried overnight (dry composition treatment). Water was applied by either briefly submerging the fruit in a bucket of water (dunk treatment), or by passing the fruit along a water saturated brush with active controlled droplet applicators (brushbed treatment). A total of 72 satsuma mandarin oranges were used per treatment group. Following treatment, the oranges were stored in ambient temperatures. Untreated control groups received neither the application of the composition nor treatment with water. Mass loss factor is the mass loss rate of untreated mandarins over the mass loss rate of treated. Measurements are taken after initial treatment (once fruit is dry) and then again 24 hours later in ambient conditions. Treatment with the composition of 94% glycerol monostearate and a 6% fatty acid salt increased the mass loss factor, indicating better retention of water during storage. Both water application treatments, dunk and brushbed treatments, decreased the mass loss factor compared to the composition-treated group that did not receive water application, but were larger than the mass loss factor of untreated and untreated+water application controls (FIGS. 20A-B).

### Example 8: Antifungal Treatment of Rose Petals

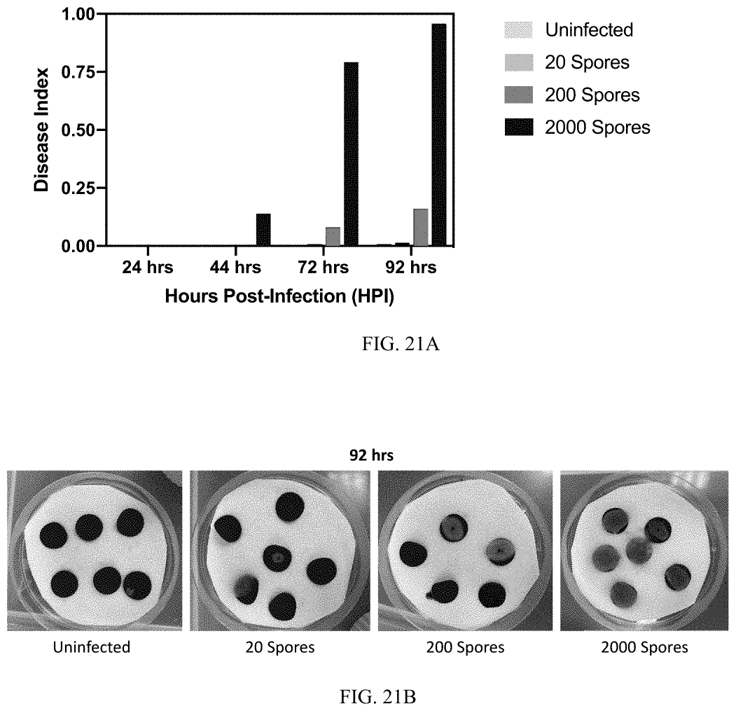

To determine antifungal capacity of the composition on rose petals, rose petal discs were infected with the Botrytis fungal pathogen and disease was followed for 64 hours. First, Botrytis infection was optimized. Briefly, 15 mm discs were cut out of rose petals and placed on wet filter paper in Petri dishes. The wet filter paper provided the high humidity required for rose petal infection. Each petal disc was infected with a liquid suspension of Botrytis spores of 20, 200, or 2000 spores, or remained uninfected. Each infected petal disc was placed in closed bins with water for 4 days, at which time the disease was scored with a disease index, or rate of incidence. The treatment with 2000 Botrytis spores per disc provided reliable infection rates shown by a high disease index (FIG. 21A-B).

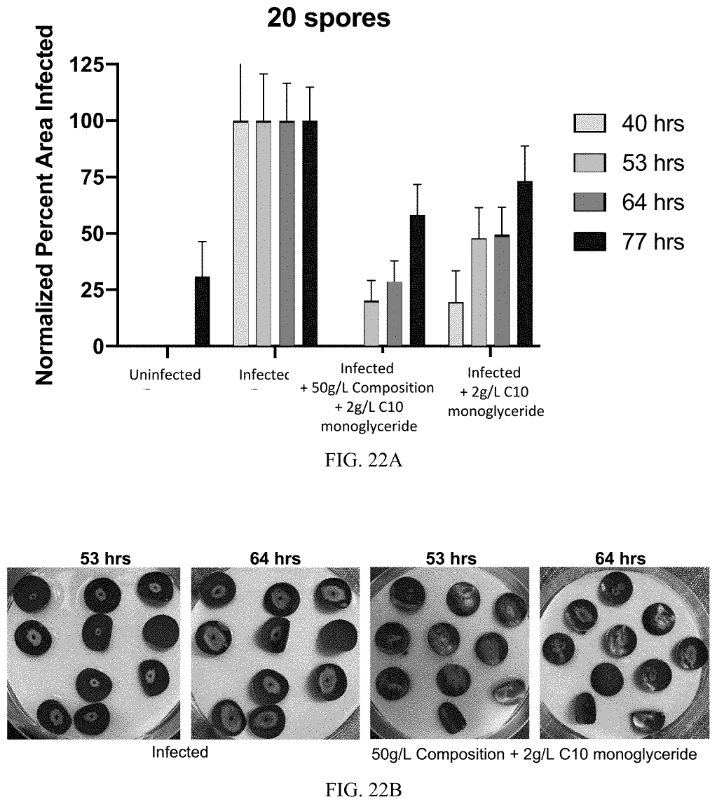

After infection optimization, the impact of treatment with 50 g/L of the composition of 94% glycerol monostearate and a 6% fatty acid salt, and 2 g/L of a CIO monoglyceride or the CIO monoglyceride alone. Briefly, rose petal discs were cut as described above, placed on wet filter paper in Petri dishes, spot infected with Botrytis, and incubated for approximately 4 days at ambient conditions. Disease was scored using the percent area of the petal disc infected with Botrytis normalized to the uninfected control for each time point. Both treatments (the composition of 94% glycerol monostearate and a 6% fatty acid salt, and 2 g/L of a CIO monoglyceride or the CIO monoglyceride alone) resulted in a decrease in the normalized percent of area infected. The CIO monoglyceride reduced infection by 50-75% depending on the time point (FIG. 22A-B).

### Example 9: Preharvest Treatment of Agricultural Products for Reduction of Water Requirements, Plant Productivity, and Postharvest Benefit

A variety of agricultural products and whole plants were treated with the composition of 94% glycerol monostearate and a 6% fatty acid salt or with a composition of 94% glycerol monostearate and a 6% fatty acid salt mixed with 2 g/L of a CIO monoglyceride. A combination of water requirements, plant productivity, and postharvest benefit were measured for yellow squash, Arabidopsis, replanted sod, tomatoes, strawberries, cherries, table grapes, and avocados. Studies were completed in a grow room and composition were applied to the whole plant with a sprayer, unless otherwise noted.

Compared to drought controls, treatments of the compositions and variations thereof reduced water requirements. Yellow squash plants were treated with the composition of 94% glycerol monostearate and a 6% fatty acid salt and compared to an untreated plant. The treated plants experienced >2 days saving for incidence of wilt, 10% water savings in leaf water content and soil moisture capacity, a 15% higher value of Phi2 (light energy directed towards photosynthesis), and the treatment was 45% more effective at delaying moderate wilt compared to treatment with the anti-transpirant WiltPruf®. Replanted sod was treated with a composition of 94% glycerol monostearate and a 6% fatty acid salt mixed with a CIO monoglyceride. The percent mass loss rate of the treated replanted sod was 15% lower than untreated sod. Tomato plants were repeatedly treated with the composition of 94% glycerol monostearate and a 6% fatty acid salt and experienced 1.5× slower rates of water loss through open stomata on a detached leaf.

Preharvest application of the composition and variations did not change plant productivity under non-stress conditions. In strawberry plants, preharvest application of the composition of 94% glycerol monostearate and a 6% fatty acid salt did not change the yield in a field setting or the plant physiology as measured by a MultiSpeq tool.

Preharvest application of the composition and variations thereof showed post-harvest benefits in a variety of agricultural plants, including strawberries, tomatoes, cherries, table grapples, and avocados. Preharvest application of the composition to strawberry plants reduced percent mass loss rate by 60% (tractor application), reduced respiration by 20% (tractor application), reduced mold on strawberry fruit by 60% in certain supply chain conditions including harvesting and transporting from the field to storage in 22° C. for 2 hours then storage at 1° C. for 13 days, and maintained higher fruit firmness after 1 day in ambient storage. Mold count of strawberry fruit was collected after 13 days of storage and the number of infected clamshell packages was compared where at least one strawberry with mold in a clamshell package was considered an infected clamshell package. Cherries treated with the composition of 94% glycerol monostearate and a 6% fatty acid salt or the composition of 94% glycerol monostearate and a 6% fatty acid salt mixed with a CIO monoglyceride reduced postharvest mass loss rate of cherries (var. Lapin) by 42% and 68% respectively, compared to untreated controls. Preharvest application of the composition also reduced stem degreening by 45% (var. Rainier). Compared to untreated table grapes, preharvest application of the composition of 94% glycerol monostearate and a 6% fatty acid salt reduced post-harvest percent mass loss rate of table grapes (var. Champagne) by 24%, reduced shattering rate (when the grape berries fall from the pedicel) in table grapes by 40%. Compared to untreated avocados, preharvest application of the composition of 94% glycerol monostearate and a 6% fatty acid salt reduced post-harvest percent mass loss rate of avocados (var. Hass) by 36%, and reduced post-harvest cumulative respiration rate by 30%.

### Example 10: Drought Studies in Arabidopsis thaliana Plants

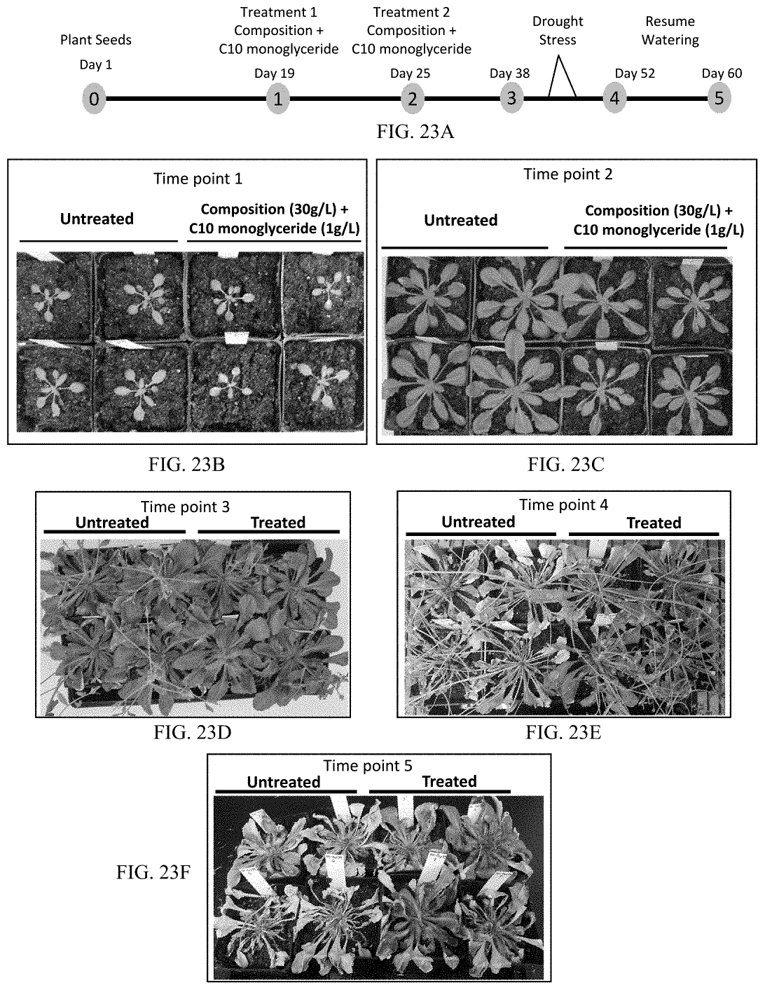

To determine how multiple treatments of the composition of 94% glycerol monostearate and a 6% fatty acid salt mixed with a CIO monoglyceride affected wilting, Arabidopsis thaliana plants were treated preharvest on day 19 and day 25 after planting seeds. Wilting was measured on day 38 and drought stress was performed on the plants. Following drought stress, wilting was measured on days 52 and 60 (FIGS. 23 A-F). Treated plants showed less wilting than untreated plants following drought stress (FIGS. 23E-F).

### Example 11: Treatment of Preharvest Tomatoes to Improve Yield

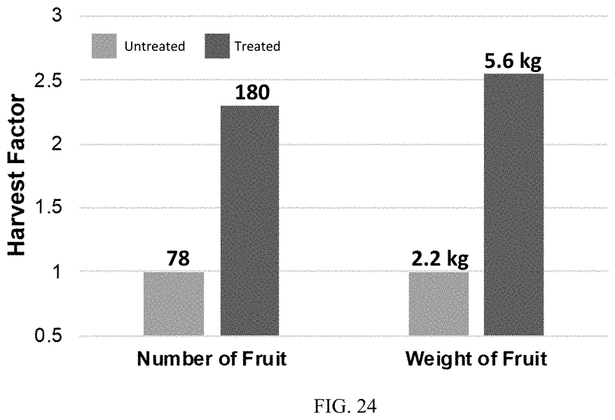

A series of experiments were performed to determine whether preharvest treatment of tomato plants affected the yield and growth of the fruit. In one experiment, 21 total Lycopersicon, lycopersicum cv. ‘Money Maker’ tomato plants were started. After greater than 50% of plants were flowering, the plants were treated once weekly with a composition of 94% glycerol monostearate and 6% of a fatty acid salt. Yield components were determined weekly. Treated tomato plants yielded 2.3× more individual pieces of fruit and 2.5× more total weight of fruit compared to the untreated control (FIG. 24).

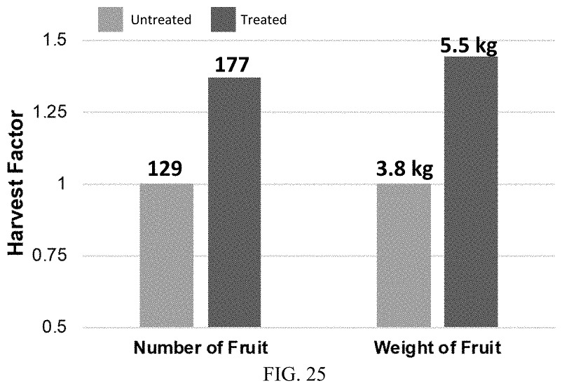

In another experiment, 25 total Lycopersicon, lycopersicum cv. “Money Maker’ tomato plants were started and were treated after greater than 50% of plants were flowering as described above. The plants were treated once weekly with a composition of 94% glycerol monostearate and 6% of a fatty acid salt. Plants were grown in 3 gallon pots in a 10 hour day/14 hour night photoperiod and were watered with 250 mL of water 5-7 times a week. Tomato plants were fertilized every 2 weeks with a fertilizer mix such as Miracle Grow. Treated tomato plants produced 1.4× more numerous fruit and 1.4× more total weight of fruit compared to the untreated control (FIG. 25).

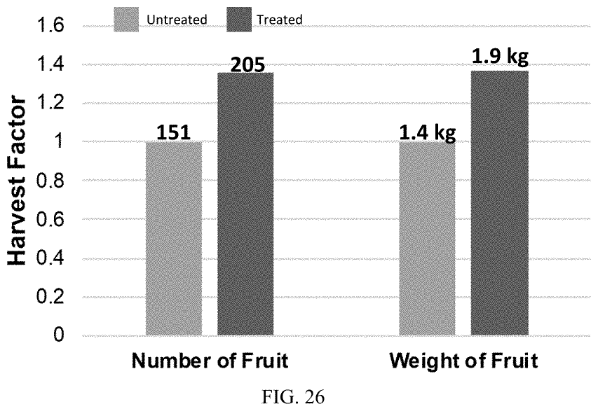

In another experiment, 50 total Lycopersicon, lycopersicum cv. ‘Galilea’ tomato plants were started and were treated after greater than 50% of plants were flowering as described above, 10 weeks after planting. The plants were treated with once weekly with a composition of 94% glycerol monostearate and 6% of a fatty acid salt. Plants underwent image analysis with Octagon every other week to quantify growth attributes of plants. MultiSpeq readings were also taken every other week. Yield components were measured weekly. Treated plants produced 1.4× more numerous fruit and 1.4× more total weight of fruit compared to the untreated control (FIG. 26).

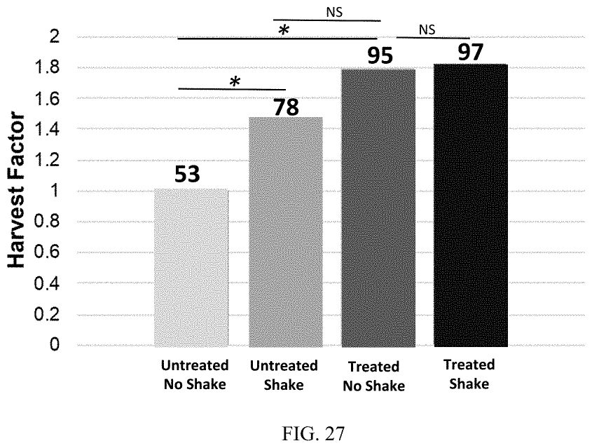

In another, 36 total Lycopersicon, lycopersicum cv. ‘Money Maker’ tomato plants were started and grown in a grow room and were treated after greater than 50% of plants were flowering as described above. To increase pollen set, plants in certain treatment groups were subjected to mechanical shaking. The plants were treated with once weekly with a composition 94% 1-glyceryl monostearate and 6% potassium stearate. Plants were split into 4 treatment groups: 1) shake, untreated, 2) no shake, untreated, 3) shake, treated, 4) no shake, treated. Untreated received no spray treatment of the composition, while treated received ˜150 mL of the composition per plant. Each bench on which the plants were grown was equipped with a BESTVA LED lamp that used a 10 hour day/14 hour night photoperiod. Plants received a steady-state watering regime of 200 mL of water per day and were fertilized once weekly starting 2 weeks after flowering. Fertilizer consisted of 100 mL calcium and 200 mL of a general fertilizer such as Miracle Grow. Shaking significantly improved yields up to 1.5×, and treatment with the composition improved yield 1.8×. There was no significant difference in yield between treated non-shaken plants and untreated shaken plants, nor was there a significant difference in yield between treated non-shaken and treated-shaken plants (FIG. 27). It is known that tomatoes need diurnal fluctuation in temperature for normal pollen set to occur (nighttime temperatures >70° F. or <55° F.), otherwise pollen can become tacky and non-viable causing blossom drop. In this experiment, the grow room day and night temperatures remained a constant 72° F.

Another experiment was performed in a field setting to test whether treatment affect physiology of plants and/or fruit yield. 40 total Lycopersicon, lycopersicum cv. ‘Galilea’ tomato plants were started and grown in 3 gallon pots and were treated after greater than 50% of plants were flowering as described above, 8 weeks after planting. Plants were split into two treatment groups: 1) untreated+water control, and 2) treated. Plants received 5 hours of direct sun per day, with additional hours of partial sun, and were manually watered every other day. A fertilizer of 100 mL calcium and 200 mL general fertilizer was applied once weekly, beginning 2 weeks after flowering. Plants were treated once weekly with the composition. Image analysis was performed ˜3× weekly including thermal imaging in addition to measurements with a MultiSpeq tool. Yield components were determined twice weekly. Treated tomato plants produces similar amounts of fruit and total weight of fruit compared to untreated plants.

In summary, treatment with the composition increased yield in an indoor setting by increasing pollen set through mechanical shaking and caused plants to produce the same amount of yield in a well-watered outdoor setting.

### Example 12. Transpiration Rates Following Preharvest Treatment of Tomatoes

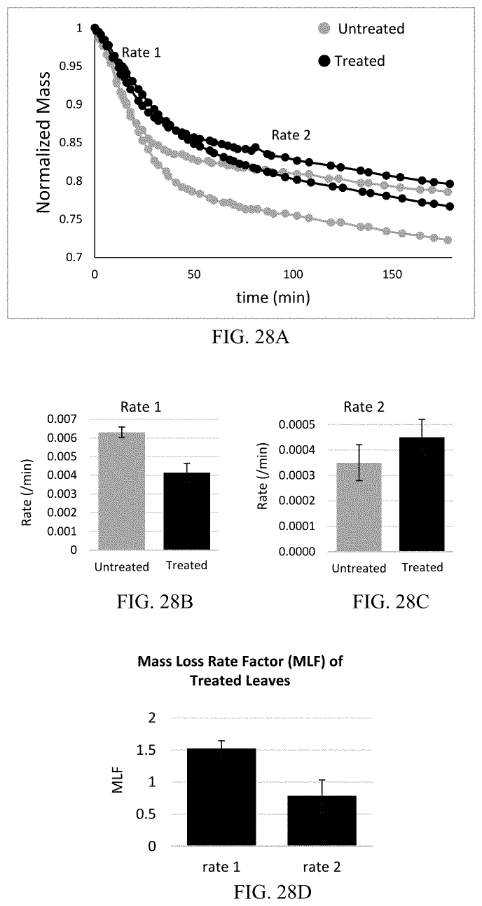

In one experiment, the effect of preharvest treatment on the rate of transpiration of tomato plant leaves was tested. Tomato plants were treated weekly with 30 g/L of a composition containing 94% 1-glyceryl monostearate and 6% potassium stearate starting at the onset of flowering. Leaf samples were collected at the end of the treatment cycle and water loss was measured by calculating leaf weight loss. Leaf mass was measured over ˜160 minute period and the weight measurements were normalized to the leaf starting weight (FIG. 28A). The rate of mass loss was calculated. Two rates were observed. The first rate was observed within the first ˜30 minutes of transpiration, the slower second rate was observed between ˜30-˜160 minutes. Untreated leaves has faster initial rates (rate 1) of weight loss (FIG. 28B), whereas treated leaves had final rates (rate 2) of weight loss (FIG. 28C). The mass loss rate factor (MLF) was then calculated as follows:

$$M L F = \frac{R a t {e}_{untreated}}{R a t {e}_{treated}}$$

In treated leaves the mass loss rate factor was faster for the initial rate (rate 1) compared to the final rate (rate 2) (FIG. 28D). The different rates correspond to open (fast rate) and closed (slow rate) stomata (See, for example, Waisel et al (1969)).

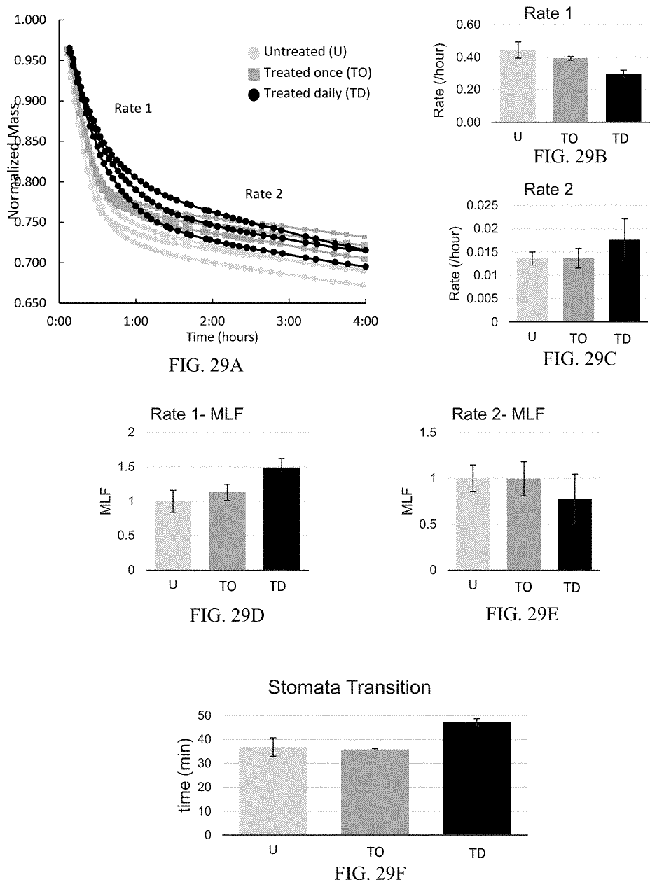

In another experiment, the effect of preharvest treatment on the rate of transpiration of tomato plant leaves was tested with additional treatment conditions. Tomato plants were in one of three treatment categories: 1) treated daily with 30-50 g/L of the composition 94% 1-glyceryl monostearate and 6% potassium stearate for one week before transpiration measurements were made (Treated daily—TD), 2) treated once with 50 g/L of the composition one day before transpiration measurements were made (Treated once—TO), or 3) untreated (U). Following the treatment period, tomato plant leaves were removed from the plant and transpiration was measured by measuring the leaf weight over a 4 hour time period. Mass was normalized to the starting leaf weight. Two rates were observed, a faster initial rate (rate 1) and a slower final rate (rate 2) (FIG. 29A). Initial transpiration rates were slowest in leaves treated daily for a week (FIG. 29B) and final rates were highest in leaves treated daily for a week (FIG. 29C). MLF was calculated as above. In leaves treated daily, the initial mass loss rate factor was highest in the leaves treated daily for a week (FIG. 29D) and the final mass loss rate factor was lowest in the leaves treated daily for a week (FIG. 29E). Additionally, leaves that were treated daily for a week before measuring transpiration had stomata that closed ˜10 minutes slower than stomata of untreated leaves or leaves treated once (FIG. 29F).

In conclusion, foliar coating with the composition slowed the rate of water loss through the open stomata. Slower rate of water loss resulted in delayed closure of stomata under water stress and up to 1.5× mass loss rate factor for tomato leaves.

### Exemplary Embodiments of the Disclosure

1. A method of reducing the water requirements of plants comprising contacting the above-ground biomass of a plant with a composition comprising one or more fatty acid derivatives (e.g., one or more monoglycerides).
2. The method according to embodiment 1, wherein the composition further comprises one or more fatty acids or salts thereof.
3. The method according to embodiment 2, wherein the composition comprises:
   (i) from 50% to 99% by mass of one or more fatty acid derivatives (e.g., one or more monoglycerides) having a structure according to Formula I; and
   (ii) from 1% to 50% by mass of one or more fatty acid salts having a structure according to Formula III, wherein Formula I and Formula III are:

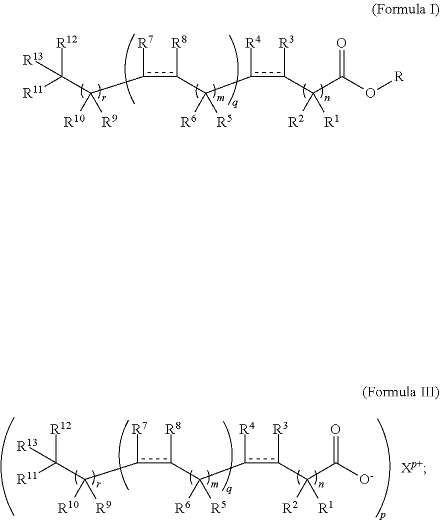

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the [symbol] symbol represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
   X^{p+} is a cationic counter ion having a charge state p, and p is 1, 2, or 3.
4. The method according to embodiment 3, wherein the composition comprises from 70% to 99% by mass of the one or more fatty acid derivatives (e.g., one or more monoglycerides) having a structure according to Formula I, and from about 1% to about 30% by mass of the one or more fatty acid salts having a structure according to Formula III.
5. The method according to any one of embodiments 1-4, wherein the one or more fatty acid derivatives (e.g., one or more monoglycerides) are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.
6. The method according to any one of embodiments 2-5, wherein the one or more fatty acid salts are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.
7. The method according to embodiment 6, wherein the composition comprises 1-glyceryl palmitate, 1-glyceryl stearate and SA-Na.
8. The method according to embodiment 7, wherein the composition comprises a 1:1 by mass ratio of 1-glyceryl palmitate and 1-glyceryl stearate that has been combined with SA-Na in a mass ratio of 94:6.
9. The method according to any one of embodiments 1-8, further comprising suspending the composition in a solvent
10. The method according to embodiment 9, wherein the solvent is water, an alcohol, or a mixture thereof.
11. The method according to embodiment 10, wherein the concentration of the composition is between 0.5 to 200 mg/mL.
12. The method according to any one of embodiments 1-11, wherein the above-ground biomass of the plant is contacted with the composition at least once a month.
13. The method according to embodiment 12, wherein the above-ground biomass is contacted with the composition once a day.
14. The method according to any one of embodiments 1-11, wherein the above-ground biomass is contacted with the composition before the plant begins producing flowers, fruit, vegetables or a combination thereof.
15. The method according to any one of embodiments 1-11, wherein the above-ground biomass is contacted with the composition after the plant begins producing flowers, fruit, vegetables or a combination thereof.
16. The method according to any one of embodiments 1-15, wherein the composition is contacted with the above-ground biomass by spraying, misting, pouring, dipping, brushing, electrospraying, or fogging.
17. The method according to any one of embodiments 1-16, wherein the water requirements of the plant are reduced by between about 5% to about 50% as compared to a control group of untreated plants.
18. A method of reducing the damage to plants due to environmental factors comprising contacting the above-ground biomass of a plant with a composition comprising one or more fatty acid derivatives (e.g., one or more monoglycerides).
19. The method according to embodiment 18, wherein the composition further comprises one or more fatty acids or salts thereof.
20. The method according to embodiment 19, wherein the composition comprises:
   (i) from 50% to 99% by mass of one or more fatty acid derivatives (e.g., one or more monoglycerides) having a structure according to Formula I; and
   (ii) from 1% to 50% by mass of one or more fatty acid salts having a structure according to Formula III, wherein Formula I and Formula III are:

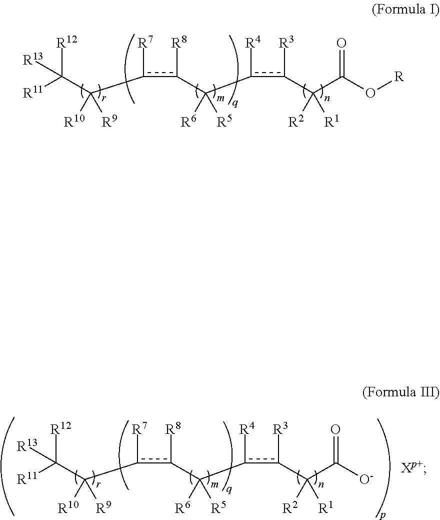

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the symbol [symbol] represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆, alkyl, —C₂-C₆ alkenyl, or —C₂-C₆ alkynyl; and
   X^{p+} is a cationic counter ion having a charge state p, and p is 1, 2, or 3.
21. The method according to embodiment 20, wherein the composition comprises from 70% to 99% by mass of the one or more fatty acid derivatives (e.g., one or more monoglycerides) having a structure according to Formula I, and from about 1% to about 30% by mass of the one or more fatty acid salts having a structure according to Formula III.
22. The method according to embodiment any one of embodiments 18-21, wherein the one or more fatty acid derivatives (e.g., one or more monoglycerides) are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.
23. The method according to any one of embodiments 19-22, wherein the one or more fatty acid salts are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.
24. The method according to embodiment 23, wherein the composition comprises 1-glyceryl palmitate, 1-glyceryl stearate and SA-Na.
25. The method according to embodiment 24, wherein the composition comprises a 1:1 by mass ratio of 1-glyceryl palmitate to 1-glyceryl stearate that has been combined in a 96:4 by mass ratio with SA-Na.
26. The method according to any one of embodiments 18-25, further comprising suspending the composition in a solvent
27. The method according to embodiment 26, wherein the solvent is water, an alcohol, or a mixture thereof.
28. The method according to embodiment 27, wherein the concentration of the composition is between 0.5 to 200 mg/mL.
29. The method according to any one of embodiments 1-11, wherein the above-ground biomass of the plant is contacted with the composition at least once a month.
30. The method according to embodiment 12, wherein the above-ground biomass is contacted with the composition once a day.
31. The method according to any one of embodiments 18-30, wherein the above-ground biomass is contacted with the composition before the plant begins producing flowers, fruit, vegetables or a combination thereof.
32. The method according to any one of embodiments 18-30, wherein the above-ground biomass is contacted with the composition after the plant begins producing flowers, fruit, vegetables or a combination thereof.
33. The method according to any one of embodiments 18-32, wherein the composition is contacted with the above-ground biomass by spraying, misting, pouring, dipping, brushing, electrospraying, or fogging.
34. The method according to any one of embodiments 18-33, wherein the damage to the treated plants due to environmental factors is reduced by about 5% to about 50% as compared to a control group of untreated plants.
35. The method according to any one of embodiments 18-34, wherein the environmental factors are abiotic factors, biotic factors, or a combination thereof.
36. The method according to embodiment 35, wherein:
   a. the abiotic factors are on or more of frost or UV-rays; and
   b. the biotic factors are one or more of bacteria, insects, fungi, viruses, pests, pathogens or parasites.
37. A method of increasing the productivity of plants comprising contacting the above-ground biomass of a plant with a composition comprising one or more fatty acid derivatives (e.g., one or more monoglycerides).
38. The method according to embodiment 37, wherein the composition further comprises one or more fatty acids or salts thereof.
39. The method according to embodiment 38, wherein the composition comprises:
   (i) from 50% to 99% by mass of a first group of compounds, wherein each compound of the first group is a compound of Formula I; and
   (ii) from 1% to 50% by mass of a second group of compounds, wherein each compound of the second group is a compound of Formula III, wherein Formula I and Formula III are:

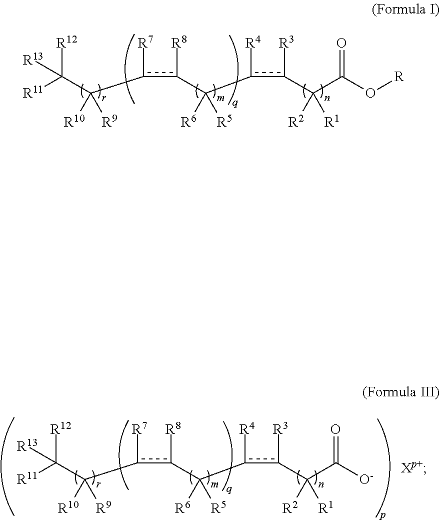

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the symbol [symbol] represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆, alkyl, —C₂-C₆ alkenyl, or —C₂-C₆ alkynyl; and
   X^{p+} is a cationic counter ion having a charge state p, and p is 1, 2, or 3.
40. The method according to embodiment 39, wherein the composition comprises from 70% to 99% by mass of the one or more fatty acid derivatives (e.g., one or more monoglycerides) having a structure according to Formula I, and from about 1% to about 30% by mass of the one or more fatty acid salts having a structure according to Formula III.
41. The method according to embodiment any one of embodiments 37-40, wherein the one or more fatty acid derivatives (e.g., one or more monoglycerides) are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.
42. The method according to any one of embodiments 37-41, wherein the one or more fatty acid salts are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.
43. The method according to embodiment 42, wherein the composition comprises 1-glyceryl palmitate, 1-glyceryl stearate and SA-Na.
44. The method according to embodiment 43, wherein the composition comprises a 1:1 by mass ratio of 1-glyceryl palmitate to 1-glyceryl stearate that has been combined in a 94:6 by mass ratio with SA-Na.
45. The method according to any one of embodiments 37-44, further comprising suspending the composition in a solvent
46. The method according to embodiment 45, wherein the solvent is water, an alcohol, or a mixture thereof.
47. The method according to embodiment 46, wherein the concentration of the composition is between 0.5 to 200 mg/mL.
48. The method according to any one of embodiments 37-47, wherein the above-ground biomass of the plant is contacted with the composition at least once a month.
49. The method according to embodiment 48, wherein the above-ground biomass is contacted with the composition once a day.
50. The method according to any one of embodiments 37-49, wherein the above-ground biomass is contacted with the composition before the plant begins producing flowers, fruit, vegetables or a combination thereof.
51. The method according to any one of embodiments 37-49, wherein the above-ground biomass is contacted with the composition after the plant begins producing flowers, fruit, vegetables or a combination thereof.
52. The method according to any one of embodiments 37-51, wherein the composition is contacted with the above-ground biomass by spraying, misting, pouring, dipping, brushing, electrospraying, or fogging.
53. The method according to any one of embodiments 37-51, wherein productivity of the plant is increased by about 5% to about 100% as compared to an untreated plant.
54. The method according to embodiment 53, wherein the number of fruit, flowers, vegetables or a combination thereof produced by the plant is increased.
55. The method according to embodiment 53, wherein the mass of the fruit, flowers, vegetables or a combination thereof produced by the plant is increased.
56. A method of extending the production term of plants comprising contacting the above-ground biomass of a plant with a composition comprising one or more fatty acid derivatives (e.g., one or more monoglycerides).
57. The method according to embodiment 56, wherein the composition further comprises one or more fatty acids or a salts thereof.
58. The method according to embodiment 57, wherein the composition comprises:
   (i) from 50% to 99% by mass of a first group of compounds, wherein each compound of the first group is a compound of Formula I; and
   (ii) from 1% to 50% by mass of a second group of compounds, wherein each compound of the second group is a compound of Formula III, wherein Formula I and Formula III are:

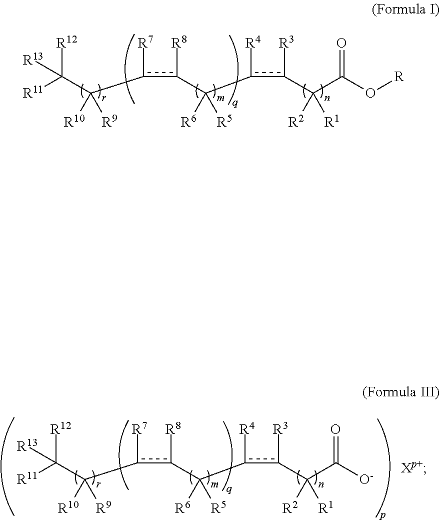

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the symbol [symbol] represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆, alkyl, —C₂-C₆ alkenyl, or —C₂-C₆ alkynyl; and
   X^{p+} is a cationic counter ion having a charge state p, and p is 1, 2, or 3.
59. The method according to embodiment 58, wherein the composition comprises from 70% to 99% by mass of the one or more fatty acid derivatives (e.g., one or more monoglycerides) having a structure according to Formula I, and from about 1% to about 30% by mass of the one or more fatty acid salts having a structure according to Formula III.
60. The method according to embodiment any one of embodiments 56-59, wherein the one or more fatty acid derivatives (e.g., one or more monoglycerides) are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.
61. The method according to any one of embodiments 57-60, wherein the one or more fatty acid salts are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.
62. The method according to embodiment 61, wherein the composition comprises 1-glyceryl palmitate, 1-glyceryl stearate and SA-Na.
63. The method according to embodiment 62, wherein the composition comprises a 1:1 by mass ratio of 1-glyceryl palmitate to 1-glyceryl stearate that has been combined in a 94:6 by mass ratio with SA-Na.
64. The method according to any one of embodiments 56-63, further comprising suspending the composition in a solvent
65. The method according to embodiment 64, wherein the solvent is water, an alcohol, or a mixture thereof.
66. The method according to embodiment 65, wherein the concentration of the composition is between 0.5 to 200 mg/mL.
67. The method according to any one of embodiments 56-66, wherein the above-ground biomass of the plant is contacted with the composition at least once a month.
68. The method according to embodiment 67, wherein the above-ground biomass is contacted with the composition once a day.
69. The method according to any one of embodiments 56-68, wherein the above-ground biomass is contacted with the composition before the plant begins producing flowers, fruit, vegetables or a combination thereof.
70. The method according to any one of embodiments 56-68, wherein the above-ground biomass is contacted with the composition after the plant begins producing flowers, fruit, vegetables or a combination thereof.
71. The method according to any one of embodiments 56-70, wherein the composition is contacted with the above-ground biomass by spraying, misting, pouring, dipping, brushing, electrospraying, or fogging.
72. The method according to any one of embodiments 56-71, wherein the production term is extended by about 5% to about 100%.
73. A method of extending the shelf-life of plant products post-harvest comprising contacting the above-ground biomass of a pre-harvested plant with a composition comprising one or more fatty acid derivatives (e.g., one or more monoglycerides).
74. The method according to embodiment 73, wherein the composition further comprises one or more fatty acids or salts thereof.
75. The method according to embodiment 74, wherein the composition comprises:
   (i) from 50% to 99% by mass of a first group of compounds, wherein each compound of the first group is a compound of Formula I; and
   (ii) from 1% to 50% by mass of a second group of compounds, wherein each compound of the second group is a compound of Formula III, wherein Formula I and Formula III are:

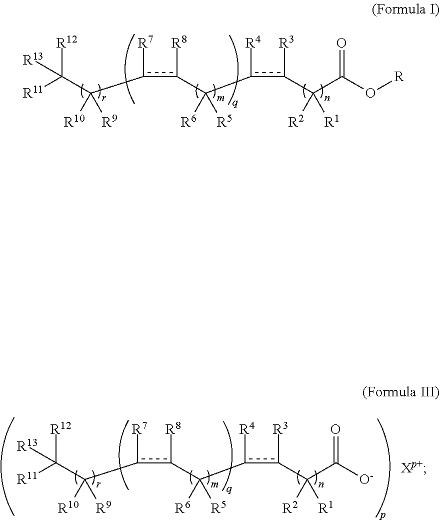

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the symbol [symbol] represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆, alkyl, —C₂-C₆ alkenyl, or —C₂-C₆ alkynyl; and
   X^{p+} is a cationic counter ion having a charge state p, and p is 1, 2, or 3.
76. The method according to embodiment 75, wherein the composition comprises from 70% to 99% by mass of the one or more fatty acid derivatives (e.g., one or more monoglycerides) having a structure according to Formula I, and from about 1% to about 30% by mass of the one or more fatty acid salts having a structure according to Formula III.
77. The method according to embodiment any one of embodiments 73-76, wherein the one or more fatty acid derivatives (e.g., one or more monoglycerides) are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.
78. The method according to any one of embodiments 74-77, wherein the one or more fatty acid salts are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.
79. The method according to embodiment 78, wherein the composition comprises 1-glyceryl palmitate, 1-glyceryl stearate and SA-Na.
80. The method according to embodiment 79, wherein the composition comprises a 1:1 by mass ratio of 1-glyceryl palmitate to 1-glyceryl stearate that has been combined in a 94:6 by mass ratio with SA-Na.
81. The method according to any one of embodiments 73-80, further comprising suspending the composition in a solvent
82. The method according to embodiment 81, wherein the solvent is water, an alcohol, or a mixture thereof.
83. The method according to embodiment 82, wherein the concentration of the composition is between 0.5 to 200 mg/mL.
84. The method according to any one of embodiments 73-83, wherein the above-ground biomass of the plant is contacted with the composition at least once a month.
85. The method according to embodiment 84, wherein the above-ground biomass is contacted with the composition once a day.
86. The method according to any one of embodiments 73-85, wherein the above-ground biomass is contacted with the composition before the plant begins producing flowers, fruit, vegetables or a combination thereof.
87. The method according to any one of embodiments 73-85, wherein the above-ground biomass is contacted with the composition after the plant begins producing flowers, fruit, vegetables or a combination thereof.
88. The method according to any one of embodiments 73-87, wherein the composition is contacted with the above-ground biomass by spraying, misting, pouring, dipping, brushing, electrospraying, or fogging.
89. The method according to any one of embodiments 73-88, wherein the plant product is harvested from the pre-harvested plant on the same day that the pre-harvested plant is contacted with the composition.
90. The method according to any one of embodiments 73-88, wherein the plant product is harvested from the pre-harvested plant at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 31 days, or 31 days after the pre-harvested plant is contacted with the composition.
91. The method according to any one of embodiments 73-99, wherein the shelf life of the plant product is extended by 1 day, 2 days, 3 days, 4 days, 5 days, 6 days, 7 days, 8 days, 9 days, 10 days, 11 days, 12 days, 13 days, 14 days 3 weeks, 4 weeks, 5 weeks, 6 weeks, 7 weeks, 2 months, 3 months, 4 months, 5 months or 6 months as compared to a similar plant product that has been harvested from a plant whose above-ground biomass has not been contacted with a composition pre-harvest.
92. A method of mitigating drought stress of plants, comprising contacting the above-ground biomass of a plant with a composition comprising one or more fatty acid derivatives (e.g., one or more monoglycerides).
93. The method according to embodiment 92, wherein the composition further comprises one or more fatty acids or salts thereof.
94. The method according to embodiment 93, wherein the composition comprises:
   (i) from 50% to 99% by mass of a first group of compounds, wherein each compound of the first group is a compound of Formula I; and
   (ii) from 1% to 50% by mass of a second group of compounds, wherein each compound of the second group is a compound of Formula III, wherein Formula I and Formula III are:

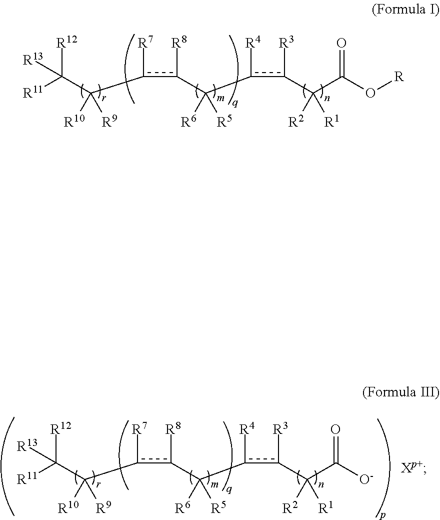

wherein for each of the formulas:
   R¹, R², R⁵, R⁶, R⁹, R¹⁰, R¹¹, R¹² and R¹³ are each independently, at each occurrence, —H, —(C═O)R¹⁴, —(C═O)H, —(C═O)OH, —(C═O)OR¹⁴, —(C═O)—O—(C═O)R¹⁴, —O(C═O)R¹⁴, —OR¹⁴, —NR¹⁴R¹⁵, —SR¹⁴, halogen, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl, or heteroaryl is optionally substituted with one or more —OR¹⁴, —NR¹⁴R¹⁵, —SR¹⁴, or halogen;
   R³, R⁴, R⁷ and R⁸ are each independently, at each occurrence, —H, —OR¹⁴, —NR¹⁴R¹⁵, —SR¹⁴, halogen, —C₁-C₆ alkyl, —C₂-C₆ alkenyl, —C₂-C₆ alkynyl, —C₃-C₁ cycloalkyl, aryl, or heteroaryl, wherein each alkyl, alkenyl, alkynyl, cycloalkyl, aryl, or heteroaryl is optionally substituted with —OR¹⁴, —NR¹⁴R¹⁵, —SR¹⁴, or halogen; or
   R³ and R⁴ can combine with the carbon atoms to which they are attached to form a C₃-C₆ cycloalkyl, a C₄-C₆ cycloalkenyl, or 3- to 6-membered ring heterocycle; and/or
   R⁷ and R⁸ can combine with the carbon atoms to which they are attached to form a C₃-C₆ cycloalkyl, a C₄-C₆ cycloalkenyl, or 3- to 6-membered ring;
   R¹⁴ and R¹⁵ are each independently, at each occurrence, —H, aryl, heteroaryl, —C₁-C₆ alkyl, —C₂-C₆ alkenyl, or —C₂-C₆ alkynyl;
   the symbol [symbol] represents an optionally single or cis or trans double bond;
   n is 0, 1, 2, 3, 4, 5, 6, 7, or 8;
   m is 0, 1, 2, or 3;
   q is 0, 1, 2, 3, 4, or 5;
r is 0, 1, 2, 3, 4, 5, 6, 7, or 8;
   R is selected from —H, -glyceryl, —C₁-C₆ alkyl, —C₂-C₆ alkenyl, —C₂-C₆ alkynyl, —C₃-C₇ cycloalkyl, aryl, or heteroaryl, wherein each alkyl, alkenyl, alkynyl, cycloalkyl, aryl or heteroaryl is optionally substituted with one or more groups selected from halogen, hydroxyl, nitro, —CN, —NH₂, —SH, —SR¹⁵, —OR¹⁴, —NR¹⁴R¹⁵, —C₁-C₆ alkyl, —C₂-C₆ alkenyl, or —C₂-C₆ alkynyl; and
   X^{p+} is a cationic counter ion having a charge state p, and p is 1, 2, or 3.
95. The method according to embodiment 94, wherein the composition comprises from 70% to 99% by mass of the one or more fatty acid derivatives (e.g., one or more monoglycerides) having a structure according to Formula I, and from about 1% to about 30% by mass of the one or more fatty acid salts having a structure according to Formula III.
96. The method according to embodiment any one of embodiments 93-95, wherein the one or more fatty acid derivatives (e.g., one or more monoglycerides) are selected from the group consisting of 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate.
97. The method according to any one of embodiments 94-96, wherein the one or more fatty acid salts are selected from the group consisting of SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.
98. The method according to embodiment 97, wherein the composition comprises 1-glyceryl palmitate, 1-glyceryl stearate and SA-Na.
99. The method according to embodiment 98, wherein the composition comprises a 1:1 by mass ratio of 1-glyceryl palmitate to 1-glyceryl stearate that has been combined in a 94:6 by mass ratio with SA-Na.
100. The method according to any one of embodiments 93-99, further comprising suspending the composition in a solvent
101. The method according to embodiment 100, wherein the solvent is water, an alcohol, or a mixture thereof.
102. The method according to embodiment 101, wherein the concentration of the composition is between 0.5 to 200 mg/mL.
103. The method according to any one of embodiments 93-102, wherein the above-ground biomass of the plant is contacted with the composition at least once a month.
104. The method according to embodiment 103, wherein the above-ground biomass is contacted with the composition once a day.
105. The method according to any one of embodiments 93-104, wherein the above-ground biomass is contacted with the composition before the plant begins producing flowers, fruit, vegetables or a combination thereof.
106. The method according to any one of embodiments 93-104, wherein the above-ground biomass is contacted with the composition after the plant begins producing flowers, fruit, vegetables or a combination thereof.
107. The method according to any one of embodiments 93-106, wherein the composition is contacted with the above-ground biomass by spraying, misting, pouring, dipping, brushing, electrospraying, or fogging.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of reducing the water requirements of a plant comprising contacting the above-ground biomass of the plant with a composition comprising one or more fatty acid derivatives.

2. The method of claim 1, wherein the one or more fatty acid derivatives comprise one or more fatty acids, fatty acid esters, or a combination thereof and one or more fatty acid salts.

3. The method of claim 2, wherein the one or more fatty acid esters comprise one or more monoglycerides.

4. The method of claim 2, wherein the composition comprises from about 70% to about 99% by weight of the one or more fatty acids, fatty acid esters, or a combination thereof.

5. The method of claim 2, wherein the composition comprises from about 1% to about 30% by weight of the one or more fatty acid salts.

6. The method of claim 2, wherein the composition comprises from about 70% to about 99% by weight of one fatty acid or fatty acid ester; and from about 1% to about 30% by weight of one fatty acid salt.

7-11. (canceled)

12. The method of claim 2, wherein each of the one or more fatty acids and fatty acid esters is an independently selected compound of Formula IA-A-i: 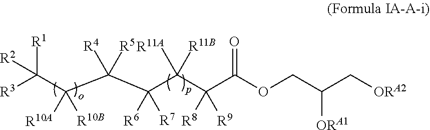
or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

13. (canceled)

14. The method of claim 3, wherein the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate,
and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.

15. The method of claim 14, wherein the composition comprises 1-glyceryl palmitate, 1-glyceryl stearate and SA-Na.

16. The method of claim 1, wherein the water requirements of the plant are reduced by between about 5% to about 50% as compared to a control group of untreated plants.

17. A method of reducing damage to a plant due to an environmental factor comprising contacting the above-ground biomass of the plant with a composition comprising one or more fatty acid derivatives.

18. The method of claim 17, wherein the one or more fatty acid derivatives comprise one or more fatty acids, fatty acid esters, or a combination thereof and one or more fatty acid salts.

19. The method of claim 18, wherein the one or more fatty acid esters comprise one or more monoglycerides.

20. The method of claim 18, wherein the composition comprises from about 70% to about 99% by weight of the one or more fatty acids, fatty acid esters, or a combination thereof.

21. The method of claim 18, wherein the composition comprises from about 1% to about 30% by weight of the one or more fatty acid salts.

22. The method of claim 18, wherein the composition comprises from about 70% to about 99% by weight of one fatty acid or fatty acid ester; and from about 1% to about 30% by weight of one fatty acid salt.

23-27. (canceled)

28. The method of claim 18, wherein each of the one or more fatty acids and fatty acid esters is an independently selected compound of Formula IA-A-i: 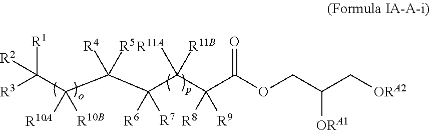
or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

29. (canceled)

30. The method of claim 19, wherein the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate,
and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.

31. The method of claim 30, wherein the composition comprises 1-glyceryl palmitate, 1-glyceryl stearate and SA-Na.

32. The method of claim 17, wherein the damage to the treated plant due to the environmental factor is reduced by about 5% to about 50% as compared to a control group of untreated plants.

33. The method of claim 17, wherein the environmental factor is an abiotic factor, a biotic factor, or a combination thereof.

34. (canceled)

35. A method of extending the shelf-life of a plant product post-harvest, the method comprising contacting the above-ground biomass of a plant pre-harvest with a composition comprising one or more fatty acid derivatives.

36. The method of claim 35, wherein the one or more fatty acid derivatives comprise one or more fatty acids, fatty acid esters, or a combination thereof and one or more fatty acid salts.

37. The method of claim 36, wherein the one or more fatty acid esters comprise one or more monoglycerides.

38. The method of claim 36, wherein the composition comprises from about 70% to about 99% by weight of the one or more fatty acids, fatty acid esters, or a combination thereof.

39. The method of claim 36, wherein the composition comprises from about 1% to about 30% by weight of the one or more fatty acid salts.

40. The method of claim 36, wherein the composition comprises from about 70% to about 99% by weight of one fatty acid or fatty acid ester; and from about 1% to about 30% by weight of one fatty acid salt.

41.-45. (canceled)

46. The method of claim 36, wherein each of the one or more fatty acids, fatty acid esters, or a combination thereof is an independently selected compound of Formula IA-A-i: 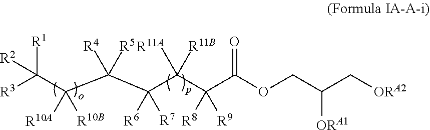
or a salt thereof,
wherein:
R^{A1} and R^{A2} are independently selected from H and C₁-C₆ alkyl;
R¹, R², R³, R⁴, R⁵, R⁶, R⁷, R⁸, and R⁹ are independently selected from the group consisting of: H, OH, C₁-C₆ alkyl, C₂-C₆ alkenyl, and C₁-C₆ alkoxy;
each occurrence of R^{10A}, R^{10B}, R^{11A}, and R^{11B} is independently selected from the group consisting of: H, OH, C₁-C₆ alkyl, C₂-C₆ alkenyl, and C₁-C₆ alkoxy;
or any two R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form a double bond, a 3- to 6-membered ring heterocycle, or a C₃-C₆ cycloalkyl;
o is an integer from 0 to 17;
p is an integer from 0 to 17; and
wherein the sum of o and p is from 0 to 17.

47. (canceled)

48. The method of claim 37, wherein the composition comprises a 1:1 by mass ratio of one or more monoglycerides selected from the group consisting of: 1-glyceryl palmitate, 1-glyceryl stearate, 1-glyceryl myristate, 1-glyceryl oleate, 1-glyceryl laurate, 1-glyceryl undecanoate, 1-glyceryl caprate, 2-glyceryl palmitate, 2-glyceryl stearate, 2-glyceryl myristate, 2-glyceryl oleate, 2-glyceryl laurate, 2-glyceryl undecanoate, and 2-glyceryl caprate,
and one or more fatty acid salts are selected from the group consisting of: SA-Na, PA-Na, MA-Na, SA-K, PA-K, or MA-K, (SA)₂-Mg, (PA)₂-Mg, (MA)₂-Mg, (SA)₂-Ca, (PA)₂-Ca, and (MA)₂-Ca.

49. The method of claim 48, wherein the composition comprises 1-glyceryl palmitate, 1-glyceryl stearate and SA-Na.

50. The method of claim 35, wherein the plant product is harvested from the pre-harvested plant on the same day that the pre-harvested plant is contacted with the composition.

51.-73. (canceled)
